(19) United States
(12) Patent Application Publication
(10) Pub. No.: US 2026/0048497 A1
(43) Pub. Date: Feb. 19, 2026

(54) Walk-About Human Augmentation System Having Sloped Vertical Degree of Freedom

(71) Applicant: Sarcos Corp., Salt Lake City, UT (US)

(72) Inventors: Fraser M. Smith, Salt Lake City, UT (US); Marc X. Olivier, Salt Lake City, UT (US); Matthew Torok, Cary, NC (US)

(21) Appl. No.: 19/367,734

(22) Filed: Oct. 23, 2025

Related U.S. Application Data
(63) Continuation-in-part of application No. 18/408,466, filed on Jan. 9, 2024.
(60) Provisional application No. 63/437,993, filed on Jan. 9, 2023.

(51) Int. Cl. B25J 9/00; B25J 5/00; B25J 9/12; B25J 18/02

(52) U.S. Cl. CPC B25J 9/0006; B25J 5/007; B25J 9/0009; B25J 9/12; B25J 18/02

(57) ABSTRACT

A walk-about human augmentation system, comprising an upper-body robotic human augmentation system having a first robotic arm, a walk-about platform in support of the upper-body robotic human augmentation system, the walk-about platform comprising a walk-about base, and a mast in the form of a carrier support assembly supported by the walk-about base, the carrier support assembly comprising a framework and an actuator assembly having an actuator and a guide member, the first robotic arm being moveably supported by the carrier support assembly, and the first robotic arm undergoing inclined displacement in a sloped vertical degree of freedom within a given range of motion along the guide member, and relative to the ground surface.

### RELATED APPLICATIONS

This is a continuation-in-part application of U.S. application Ser. No. 18/408,466, filed Jan. 9, 2024, entitled “Convertible Ride-On and Walk-About Platform for A Robotic Upper Exoskeleton” which claims the benefit of U.S. Provisional Application Ser. No. 63/437,993, filed Jan. 9, 2023, and entitled, “Convertible Ride-On and Walk-About Platform for A Robotic Upper Exoskeleton”, each of which is incorporated by reference in its entirety herein.

### BACKGROUND

A wide variety of exoskeleton, humanoid, robotic arms, and other robots or robotic systems exist which perform tasks in a variety of situations and applications. Robotic exoskeletons in particular are wearable electromechanical devices that have been developed as augmentative devices to assist, enhance, or amplify the physical performance of the wearer or as orthotic devices for gait rehabilitation or locomotion assistance. Robotic exoskeletons have potential applications in multiple different fields and may be used by a variety of different operators. While many exoskeleton systems comprise an upper body exoskeleton portion supported by a lower body exoskeleton portion (e.g., one comprising two legs) that interfaces with the lower body of a human operator upon the operator donning the exoskeleton, lower body exoskeletons are often complex in their configuration by comprising multiple actuatable joints to facilitate movement in multiple degrees of freedom that resemble as closely as possible the kinematics of the human operator due to these being physically coupled to the human operator, namely to the legs of the human operator. This level of complexity within a lower body exoskeleton portion in many instances is not necessary. Indeed, there are many instances where the types of amplified or assisted movements and/or maneuvers that a human operator may need to perform with the lower body exoskeleton portion in order to complete one or more tasks with the upper body exoskeleton are simple, thus rendering a complex lower body exoskeleton portion unnecessary in that it possesses a much greater capability than what is needed. Another way of stating this is that a complex exoskeleton may possess actuatable joints, degrees of freedom and various components, elements and systems needed to operate the lower body exoskeleton portion as it is interfaced with a human operator that are only there due to the complex configuration of the lower body exoskeleton to enable the human interface. However, in reality, such complexities may be overkill for many tasks that need to be carried out using the upper body exoskeleton portion. While a complex lower body exoskeleton portion can certainly perform simple amplified or movements and/or maneuvers, such as serving as a support for the upper exoskeleton portion as interfaced with an upper body of the operator, facilitating amplified lifting, squatting, bending over, walking from one location to another, etc. by the operator, it likely does these utilizing all available systems, components, degrees of freedom, etc. within the lower body exoskeleton portion. In addition, it is recognized that in some instances a lower body exoskeleton portion may merely serve as a support for the upper exoskeleton portion, such as for a task that can be undertaken and accomplished using only the upper body exoskeleton portion. A complex lower body exoskeleton can be costly and can also be cumbersome, particularly when performing lower body movements and/or maneuvers, such as walking, squatting, and even standing for an extended period of time due to the direct interfacing of the lower body exoskeleton with the human operator.

### SUMMARY

An initial overview of the inventive concepts is provided below and then specific examples are described in further detail later. This initial summary is intended to aid readers in understanding the examples of the present technology more quickly, but is not intended to identify key features or essential features of the examples, nor is it intended to limit the scope of the present technology or the claimed subject matter.

In one example, the present technology sets forth a walk-about platform comprising: a walk-about base moveable about a ground surface, the walk-about base defining, at least in part, a bi-pedal zone of operation for an operator; a mast extending upward from the walk-about base, the mast being in support of at least one robotic arm; and an actuator assembly supported by the mast, and comprising an actuator operable with a supported first robotic arm, wherein the first robotic arm undergoes inclined displacement in a sloped vertical degree of freedom within a given range of motion, and relative to the ground surface.

In one example, an inclined path of the first robotic arm, when undergoing the inclined displacement, is configured to approximate an inclined path of travel of a shoulder of the operator when moving between a standing position and a squatting position.

The present technology further sets forth a walk-about human augmentation system, comprising: an upper-body robotic human augmentation system comprising: a first robotic arm having at least one joint facilitating movement in at least one degree of freedom; a user input device associated with the first robotic arm; a walk-about platform in support of the upper-body robotic human augmentation system, and operable about a ground surface, the walk-about platform comprising: a walk-about base; and a mast in the form of a carrier support assembly supported by the walk-about base, the carrier support assembly comprising a framework and an actuator assembly having an actuator and a guide member, wherein the first robotic arm is moveably supported by the carrier support assembly, and wherein the first robotic arm undergoes inclined displacement in a sloped vertical degree of freedom within a given range of motion along the guide member, and relative to the ground surface.

In one example, an inclined path of the first robotic arm, when undergoing the inclined displacement, is configured to approximate an inclined path of travel of a shoulder of the operator when moving between a standing position and a squatting position while operating the walk-about system.

In one example, the sloped vertical degree of freedom comprises a single actuated degree of freedom, such that the inclined displacement of the first robotic arm in the sloped vertical degree of freedom results in movement of the first robotic arm in two spatial degrees of freedom.

In one example, the upper-body robotic human augmentation system comprises a second robotic arm having at least one joint facilitating movement in at least one degree of freedom. In this example, the framework of the carrier support assembly can further comprise: a second structural support column, the second robotic arm being moveably supported by the second support column; and a second actuator assembly having an actuator and a guide member, wherein the second robotic arm undergoes inclined displacement in a sloped vertical degree of freedom within a given range of motion along the guide member of the second actuator assembly, and relative to the ground surface.

In one example, an inclined path of the second robotic arm, when undergoing the inclined displacement, is configured to approximate an inclined path of travel of a shoulder of the operator when moving between a standing position and a squatting position while operating the walk-about system.

In one example, the framework of the carrier support assembly defines an operator pass-through channel that facilitates ingress of the operator into, and egress of the operator out of, a bi-pedal locomotion zone from multiple directions.

The present technology still further sets forth a walk-about robotic human augmentation system, comprising: a first robotic arm comprising at least one joint facilitating movement of a jointed member in at least one degree of freedom; a second robotic arm comprising at least one joint facilitating movement of a jointed member in at least one degree of freedom; a walk-about platform operable about a ground surface, and comprising: a walk-about base; a mast in the form of a carrier support assembly supported by the walk-about base, and comprising: a first support column in support of the first robotic arm; a second support column in support of the second robotic arm; a first actuator assembly operable with the first robotic arm; a second actuator assembly operable with the second robotic arm; and a control unit comprising one or more processors, and one or more memory devices comprising instructions that, when executed by the one or more processors, cause the system to: control inclined displacement of the first robotic arm in a sloped vertical degree of freedom within a given range of motion relative to the ground surface; and control inclined displacement of the second robotic arm in a sloped vertical degree of freedom within a given range of motion relative to the ground surface.

The present technology still further sets forth a method for facilitating operation of a walk-about robotic human augmentation system, comprising: configuring an upper-body robotic human augmentation system to comprise a first robotic arm having at least one joint facilitating movement in at least one degree of freedom; configuring a walk-about platform to be in support of the upper-body robotic human augmentation system; and facilitating inclined displacement of the first robotic arm in a sloped vertical degree of freedom within a given range of motion along the guide member, and relative to the ground surface.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a front isometric view of a walk-about exoskeleton system according to one example of the present disclosure;

FIG. 2 is a side view of the walk-about exoskeleton system shown in FIG. 1;

FIG. 3 is a rear isometric view of the walk-about exoskeleton system shown in FIG. 1;

FIG. 4 is a front isometric view of the walk-about exoskeleton system shown in FIG. 1 with an operator in a crouched position;

FIG. 5 shows a schematic of an interface between a mast and an exoskeleton of the walk-about exoskeleton system according to one example of the present disclosure;

FIG. 6A is a side view of a walk-about exoskeleton system having an extendible counterweight according to one example of the present disclosure, and FIG. 6B is a schematic view of an extendible arm of the extendible counterweight of FIG. 6A;

FIG. 7 is a schematic view of operator input interface in association with a conveyance system of the walk-about exoskeleton system shown in FIG. 1;

FIG. 8A and FIG. 8B show side views of a walk-about exoskeleton system having deployable forks according to one example of the present disclosure, and FIG. 8C shows an enlarged view of a front of a lateral member of the walk-about exoskeleton system shown in FIGS. 8A and 8B;

FIG. 9A and FIG. 9B show side views of a walk-about exoskeleton system having deployable forks according to one example of the present disclosure, and FIG. 9C shows an enlarged view of a front of a lateral member of the walk-about exoskeleton system shown in FIGS. 9A and 9B;

FIG. 10 is an isometric view of a walk-about exoskeleton system having retractable extensions according to one example of the present disclosure;

FIG. 11 is an isometric view of a walk-about exoskeleton system having track rollers according to one example of the present disclosure;

FIG. 12 is an isometric view of a walk-about exoskeleton system having a deployable riding surface according to one example of the present disclosure;

FIG. 13 is a front view of the walk-about exoskeleton system shown in FIG. 12;

FIG. 14 is a front view of the walk-about exoskeleton system shown in FIG. 12 with the riding surface in a deployed position;

FIG. 15 is an isometric view of the walk-about exoskeleton system shown in FIG. 12 with retractable extensions;

FIG. 16 is a side view of a walk-about exoskeleton system having a torso-forebend;

FIG. 17 is a side view of the walk-about exoskeleton system shown in FIG. 16 with the operator in a crouched position;

FIG. 18 is a side view of a walk-about exoskeleton system with a torso-forebend supported by a winch system;

FIGS. 19A and 19B show the walk-about exoskeleton with a torso-forebend and a riding surface or platform.

FIG. 20 illustrates an isometric view of a walk-about system carrying an operator according to another example of the present disclosure.

FIG. 21 illustrates a front isometric view of the walk-about system of FIG. 20 without an operator.

FIG. 22 illustrates a rear isometric view of the walk-about system of FIG. 20.

FIG. 23 illustrates a top view of the walk-about system of FIG. 20.

FIG. 24 illustrates a front view of the walk-about system of FIG. 20.

FIG. 25 illustrates a rear view of the walk-about system of FIG. 20.

FIG. 26 illustrates a first side view of the walk-about system of FIG. 20, with the outer shear plate hidden to reveal more of the framework of the carrier support assembly and the first actuator assembly.

FIG. 27 illustrates a side view of the walk-about system of FIG. 20, showing an operator in a standing position within the bi-pedal locomotion zone.

FIG. 28 illustrates a side view of the walk-about system of FIG. 20, showing an operator in a squatting position within the bi-pedal locomotion zone.

FIG. 29 illustrates a second side view of the walk-about system of FIG. 20, with the outer shear plate hidden to reveal more of the framework of the carrier support assembly and the first actuator assembly, as well as various electronics components.

FIG. 30 illustrates a partial front isometric view of the walk-about system of FIG. 20, with portions of the first and second actuator assemblies hidden to reveal their respective components.

FIG. 31 illustrates a partial side isometric view of the walk-about system of FIG. 20, with the outer shear plate and portions of the framework of the carrier support assembly hidden to reveal components of the gravity compensation system.

FIG. 32 illustrates a detailed partial isometric view of the walk-about system of FIG. 20, with the outer shear plate and portions of the framework of the carrier support assembly hidden to reveal components of the gravity compensation system.

FIG. 33 illustrates a detailed partial isometric view of the walk-about system of FIG. 20, with the outer shear plate and portions of the framework of the carrier support assembly hidden to reveal components of the gravity compensation system.

FIG. 34 illustrates a detailed partial first side view of the walk-about system of FIG. 20, with the outer shear plate and portions of the framework of the carrier support assembly hidden to reveal components of the gravity compensation system, and various electronics components.

FIG. 35 illustrates a rear view of the walk-about system of FIG. 20, showing components of the gravity compensation system.

FIG. 36 illustrates a rear view of the walk-about system of FIG. 20, showing components of an alternatively configured gravity compensation system.

FIG. 37 illustrates an isometric view of an operator end effector for use within the walk-about system of FIG. 20.

FIG. 38 illustrates a partial front isometric view walk-about system of FIG. 20, shown without a riding platform.

FIG. 39 illustrates a first side view of the walk-about system of FIG. 20, shown with various adjustable interfaces to vary an angle of incline of a sloped vertical degree of freedom of the upper-body robotic human augmentation system.

FIG. 40 illustrates a schematic diagram of the systems of the walk-about system of FIG. 20.

Reference will now be made to the examples illustrated, and specific language will be used herein to describe the same. It will nevertheless be understood that no limitation of scope is thereby intended.

### DETAILED DESCRIPTION

The following detailed description of exemplary embodiments of the present technology refers to the accompanying drawings, which form a part hereof and in which are shown, by way of illustration, examples in which the present technology may be practiced. While these exemplary embodiments are described in sufficient detail to enable those skilled in the art to practice the present technology, it should be understood that other embodiments may be realized and that various changes to the present technology may be made without departing from the spirit and scope of the present technology. Thus, the following more detailed description of the embodiments of the present technology is not intended to limit the scope of the invention, as claimed, but is presented for purposes of illustration only to describe the features and characteristics of the present technology, and to sufficiently enable one skilled in the art to practice the invention.

### Description of Terms

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “walk-about” refers to a type and characteristic of a system (e.g., a walk-about system) comprising a lower support system (e.g., a walk-about platform), for human augmentation system (e.g., an upper-body robotic human augmentation system comprising one or more robotic arms or limbs, a wearable upper body exoskeleton comprising one or more robotic arms) in which the walk-about platform is capable of locomotion and movements about a ground or other surface that correspond to or that accommodate operator locomotion and movements while the operator is present in a bi-pedal locomotion zone defined by the walk-about system. While the operator operating the walk-about system, the legs of the operator are not coupled to the walk-about platform. In other words, the operator can achieve locomotion and other movements about a ground or other surface under the operator's own power and with the operator's legs decoupled from the walk-about platform with the walk-about platform accommodating such movements as the operator operates the walk-about system. The operator locomotion and movements can be performed within a bi-pedal locomotion zone defined at least in part by one or more structural elements of the walk-about platform.

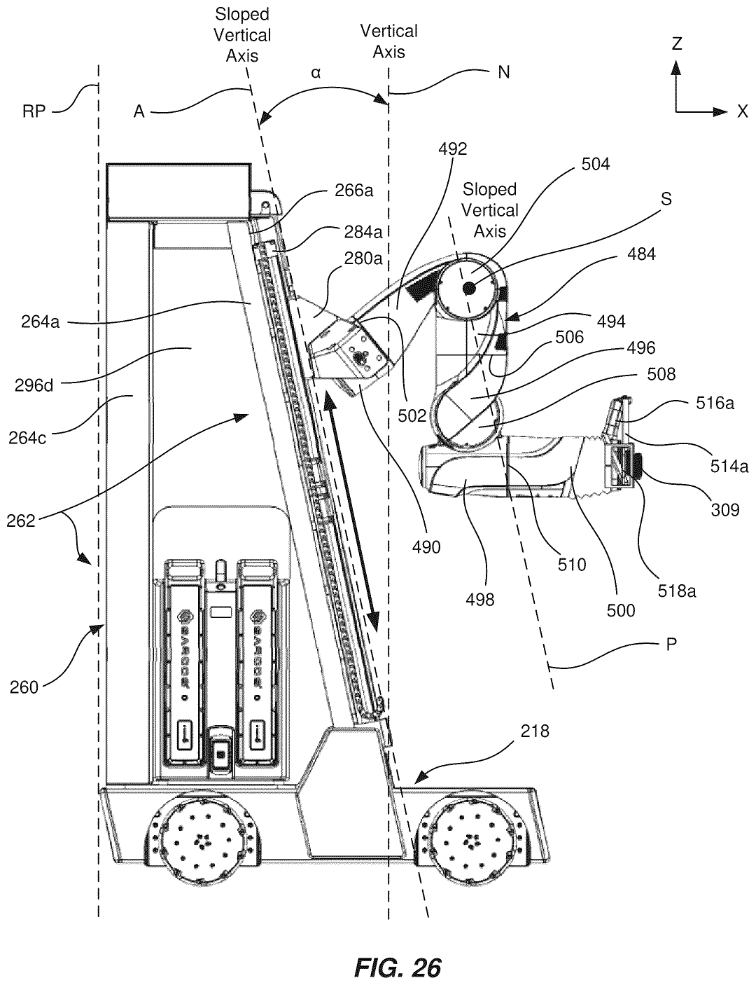

The term “sloped vertical degree of freedom” refers to a degree of freedom along a sloped vertical axis (e.g., see axis A in FIG. 26). A “sloped vertical axis” can mean a linear slope, or a curved slope, or a combination of these. A sloped vertical degree of freedom will comprise or define movement primarily along a vertical axis (i.e., an axis normal to ground) component, with a lesser amount of movement, but some, along a horizontal axis component.

The term “inclined displacement” refers to the inclined motion or movement of the upper-body robotic human augmentation system (namely the robotic arm(s) of the system) along the sloped vertical axis within its/their available range of motion in the sloped vertical degree of freedom, which allows the operator to execute a torso-forebend motion (a bending of the torso at the hips, and relative to the lower body or legs) while crouching, such as during a squat. More specifically, the inclined displacement of the upper-body robotic human augmentation system allows a path of the upper-body robotic human augmentation system (e.g., the path of a point (e.g., shoulder joint) on the upper-body robotic human augmentation system corresponding to a shoulder joint of the operator) to approximate the inclined path of movement or travel of a shoulder or shoulder joint of the operator when in the bi-pedal locomotion zone and operating the walk-about system, and particularly when the operator executes a torso-forebend when moving between a standing position and a squatting position while operating the robotic arm(s) of the upper-body robotic human augmentation system. Furthermore, the inclined displacement refers to the ratioed change in horizontal position of the upper-body robotic human augmentation system, and particularly the robotic arm(s), with the change in vertical elevation of the robotic arm(s), relative to ground (or another contacting surface in support of the walk-about robotic human augmentation system). It is noted that the inclined displacement in the sloped degree of freedom and along the sloped vertical axis can occur along a linear path (i.e., movement occurs along a constant angle of ascent and descent) or a curved path (i.e., where movement occurs along a changing angle of ascent and descent), or a combination of these. Indeed, in one example, the inclined displacement can be linear, or in other words, can comprise a planar or linear angle of inclination. In this example, the inclined displacement of the robotic arm(s) can be more succinctly described as inclined plane motion. In another example, the inclined displacement can be curved, or in other words, can comprise a curved inclination. In this example, the inclined displacement can be more succinctly described as inclined curve motion. In still another example, the inclined displacement can be a combination of linear and curved segments or portions.

### Examples of the Technology

To further describe the present technology, example embodiments are now set forth and described with reference to the figures. These example embodiments are not intended to be limiting in any way. Generally speaking, the present technology sets forth a walk-about human augmentation system operable to augment a motion of an operator. In one example, the walk-about human augmentation system can comprise a walk-about exoskeleton system, wherein an upper body exoskeleton that couples to at least one of the arms or torso of the operator is supported about a walk-about platform. In another example, the walk-about human augmentation system can comprise one or more robotic limbs or arms supported about a walk-about platform, wherein an operator interfaces with the one or more robotic arms to control the robotic arms, but with the torso of the operator (and in some examples also the arms of the operator) being decoupled from any structural component of the walk-about human augmentation system. In each of these examples, the upper-body exoskeleton and the robotic arms can be configured to be kinematically equivalent to the upper body of the operator.

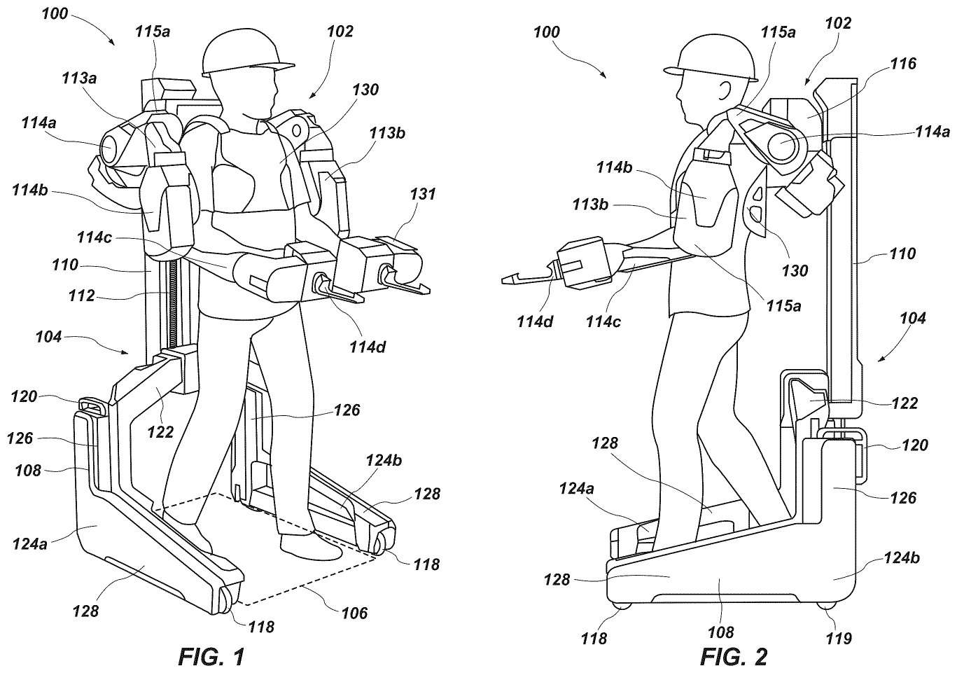

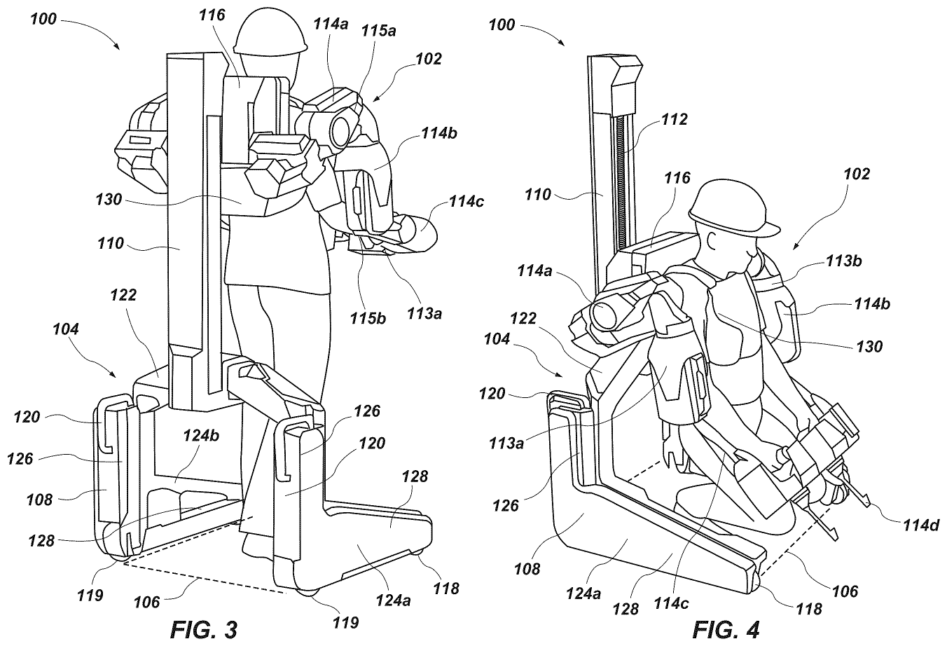

With reference to FIGS. 1-4, illustrated is a walk-about human augmentation system in the form of a walk-about exoskeleton system 100. This system 100 can comprise an exoskeleton 102 (e.g., an upper-body exoskeleton that couples to the operator, such as an exoskeleton that can be donned by the operator about at least a portion of an upper body of the operator (e.g., couples to the torso and/or the arms)). The walk-about exoskeleton system 100 can further comprise a walk-about platform 104 in support of the exoskeleton 102 about a ground surface or ground-like surface. The walk-about platform 104 can provide, as one advantage, a lower support system for an upper body exoskeleton portion that does not directly interface with and couple to the legs of a human operator, and thus does not need to match or even closely conform to the kinematics of the legs of the human operator, thus reducing the complexity of the walk-about platform 104 as compared with other lower body exoskeleton portions that do interface with the legs of a human operator and that comprise various actuated joints and associated degrees of freedom that resemble or match the kinematics of the lower body of the human operator.

The exoskeleton 102 can be any suitable robotic exoskeleton operable to amplify the movement and/or work of an operator donning the exoskeleton 102. Therefore, the exoskeleton 102 shown is not intended to be limiting in any way except as otherwise described herein. As in the example shown, the exoskeleton 102 can comprise a plurality of robotic limbs or arms such as a right robotic limb 113a that can correspond to a right arm of the operator and a left robotic limb 113b that can correspond to a left arm of the operator. The right robotic limb 113a can amplify the movement performed by the right arm of the operator and the left robotic limb 133b can amplify the movement performed by the left arm of the operator.

Each of the right and left robotic limbs 113a, 113b can comprise structural support members in the form of limb members 114a, 114b, 114c that can move in one or more degrees of freedom relative to one another, respectively, via joints 115a, 115b, respectively, at which the limb members 114, 114b, 114c connect. The degrees of freedom of movement of the exoskeleton 102 can correspond to respective degrees of freedom of movement of a human. The exoskeleton 102 can comprise various joint actuation systems (e.g., comprising one or more actuators, transmissions, clutches, or other components) to power the relative rotation between two or more of the limb members 114a, 114g, 114c based on input from the operator (such as movement of an arm of the operator) to amplify the movements of the operator. Each of the right and left robotic limbs 113a, 113b can comprise and end effector 114d. The end effector shown in the figures is exemplary and any suitable end effector can be utilized based on a desired task to be performed by the walk-about exoskeleton system 100. Such end effectors can include robotic hands, grippers, tools, magnets, cameras, or the like, or any combination of these.

The exoskeleton 102 can comprise a support bridge 116, and the right and left robotic limbs 113a, 113b can each be attached to and extend from the exoskeleton support bridge 116. For example, the right and left robotic limbs 113a, 113b can be attached to the support bridge at respective joints. A joint assembly can be provided at the joint between the robotic limbs 113a, 113b and the support bridge 116 that can facilitate relative movement between the robotic limbs 113a, 113b and the support bridge 116. The joint assembly can comprise, for example, one or more actuators, transmissions, or connectors that facilitate the relative movement between the robotic limbs 113a, 113b and the support bridge 116. The support bridge 116 can be designed and configured to be supported in a position behind an operator operating the walk-about exoskeleton system 100, such as about the shoulders and upper back of the operator. The exoskeleton support bridge 116 can be operable to connect to and be supported from the walk-about platform 104 as will be describe in more detail below.

The walk-about platform 104 can comprise a walk-about base 108 supporting a mast 110. The walk-about base 108 and the mast can be formed integrally as a single piece, or the mast 110 can be attached to the walk-about base through any suitable joining mechanism such as via welding, adhesives, fasteners, etc. The mast 110 can extend upwards from the walk-about base 108 and can be supported about the walk-about base 108 so as to be positioned behind the operator operating the walk-about exoskeleton system 100. The mast 110 can be operable to support the exoskeleton 102. In one example, the exoskeleton 102 can be mounted to or attached to the mast 110, such as via the support bridge 116, so as to position an operator donning the exoskeleton 102 within a bi-pedal locomotion zone 106 defined at least in part by the walk-about base 108.

In some examples, the exoskeleton 102 can be mounted or attached to the mast 110 such that the exoskeleton 102 is able to move in one or more degrees of freedom relative to the mast 110. In one example, the exoskeleton 102 can be moveably mounted to the mast 110 so as to be able to move vertically or up and down (as shown in FIGS. 1-4) with respect to the mast 110. To this end, and in one example, the mast 110 can comprise a linear actuator 112 that facilitates the vertical movement of the exoskeleton 102 relative to the mast 110. The linear actuator 112 can be any suitable actuator such as a mechanical linear actuator (e.g., a screw or chain drive), a pneumatic linear actuator, or a hydraulic linear actuator. The movement of the exoskeleton 102 relative to the mast 110 can facilitate operators of different heights who use the walk-about exoskeleton system 100. Further, the movement of the exoskeleton 102 relative to the mast 110 can also allow an operator to move into different positions, such as a lower position (e.g., a squatting position (such as the position shown in FIG. 4)) so that the operator can perform a needed or desired work or a task. For example, moveably coupling the exoskeleton 102 to the mast 110 allows an operator to lower his/her body from a standing position to a lower position to perform a task that cannot be done from a standing position, such as to lift an item off of a ground surface, place an object on a lower shelf, and countless other tasks with the aid of the exoskeleton 102.

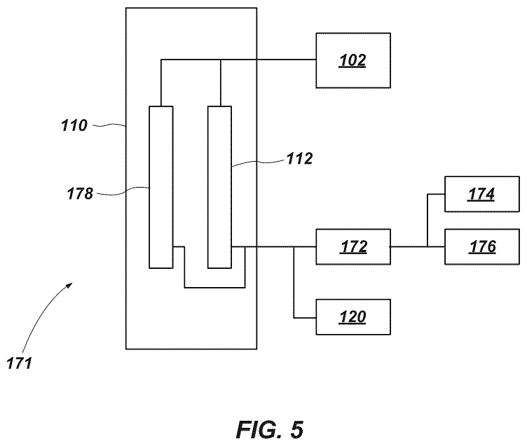

FIG. 5 shows a schematic of a mast exoskeleton interface system 171 that provides an interface between the mast 110 and the exoskeleton 102 according to one example of the present disclosure. Referring now to FIGS. 1-5, in some examples, the exoskeleton 102 is attached to the mast 110 such that it is able to move in one or more degrees of freedom as mentioned above. As shown in FIGS. 1-5, the exoskeleton 102 can be configured to move vertically up or down relative to the mast 110. The interface system 171 can facilitate the relative movement between the mast 110 and the exoskeleton 102. For example, the mast exoskeleton interface system 171 can comprise the linear actuator 112 discussed above. The exoskeleton 102 can connect to the mast 110 via the linear actuator 112. As mentioned above, the linear actuator 112 can be any suitable linear actuator now known or later developed. The linear actuator 112 can be configured based on an expected load resulting from both the weight of the exoskeleton 102 and a weight of a load carried by the exoskeleton 102. That is, the type and size of the linear actuator 102 can be selected to be suitable to accommodate an expected maximum load (e.g., the combined weight of the exoskeleton 102 and the maximum expected load to be carried by the exoskeleton 102).

In some examples, the linear actuator 112 can comprise a backdrivable actuator (i.e., an actuator that will operate in reverse when acted upon by an external force, and thus requires continual power to maintain position in the presence of an external force). In some examples, the linear actuator 112 can comprise a nonbackdrivable actuator (i.e., an actuator that maintains its position unpowered in the presence of an external force). In some applications, a backdrivable actuator can provide increased responsiveness as compared to a nonbackdrivable actuator. In some applications, a nonbackdrivable actuator can decrease power requirements for the actuator by its ability to maintain its position in an unpowered state.

In one example, the mast exoskeleton interface system 171 can include passive gravity compensation that can aid in supporting the weight of the exoskeleton 102 and any load carried by the exoskeleton 102. For example, the mast exoskeleton interface system 171 can comprise a passive actuator 178. A passive actuator as used herein can comprise an actuator that is unpowered and that provides a reactive force in response to a load exerted on the passive actuator. For example, the passive actuator can comprise a mechanical spring, a pneumatic passive actuator (i.e., an air spring) or the like. The passive actuator 178 can be configured to provide gravity compensation to support the weight of the exoskeleton 102, and optionally the load carried by the exoskeleton 102. The passive actuator can be attached to the exoskeleton 102 in parallel with the linear actuator 112 as shown in FIG. 5.

For example, the passive actuator 178 can be configured to compensate for the weight of the exoskeleton 102. In other words, the passive actuator 178 can be configured such that the passive actuator 178 can provide a reaction force equal to the weight of the exoskeleton 102. Accordingly, the passive actuator 178 can be configured to maintain a vertical position of the exoskeleton 102 relative to the mast 110 without aid from the linear actuator 112. Because the passive actuator 178 provides the necessary force to support the weight of the exoskeleton, the linear actuator 112 need only be sized and configured to move the exoskeleton 102 vertically and to support the weight of a load carried by the exoskeleton 102. In this manner, the power required from the linear actuator 112 can be less than compared to when no passive actuator 178 is incorporated into the mast exoskeleton interface system 171. This can provide energy savings and can allow for the option to incorporate a smaller, less powerful linear actuator into the mast exoskeleton interface system 171 as compared to when no passive actuator 178 is used.

In another example, the passive actuator 178 can be configured to compensate for the weight of the exoskeleton 102 and at least part of the weight of an expected maximum load that will be carried by the exoskeleton 102. In other words, the passive actuator 178 can be configured such that the passive actuator can provide a reaction force equal to the weight of the exoskeleton 102 and at least a portion of a load carried by the exoskeleton 102. In this example, additional energy savings can be attained when the exoskeleton 102 carries a load because the passive actuator 178 can bear both the weight of the exoskeleton 102 and a portion of the load.

In the instance where no load is carried by the exoskeleton 102, the linear actuator 112 can be required to work against the passive actuator 178 in order to maintain the unladen exoskeleton 102 in a given position relative to the mast 110. Thus, the determination of the strength of the passive actuator 178 can be based on an expected percentage of time of operation during which the exoskeleton 102 will bear a given load. It is noted that while in the above examples the passive actuator 178 is configured to bear the weight of the exoskeleton 102 or the weight of the exoskeleton 102 and a load, this is not intended to be limiting. The passive actuator 178 can be configured to provide any desired reaction force based on a given application, such as a reaction force that is less than a weight of the exoskeleton.

While only a single passive actuator 178 is shown in FIG. 5, it is noted that multiple passive actuators could be used. For example, a first passive actuator could be provided that is configured to compensate for the weight of the exoskeleton. A second passive actuator could also be provided that is configured to compensate for at least a portion of the weight of an expected load. In some examples, one or more of the passive actuators can be activated or inactivated. For instance, the second passive actuator that is configured to compensate for at least a portion of the weight of an expected load can be configured to be activated or inactivated depending on whether a load is carried by the exoskeleton 102. When a load is carried by the exoskeleton 102, the second passive actuator can be activated to provide gravity compensation for the load. When the exoskeleton 102 is unladen, the second passive actuator can be deactivated so that is does not provide extra reaction force greater than the weight of the exoskeleton 102. One or more of the actuators can be activated and deactivated via any suitable mechanism such a clutch, a control valve (in the case of a pneumatic actuator), or the like.

Control of the linear actuator 112 and optionally control of activating and deactivating the passive actuator 178 can be provided by a control unit 172 of the mast exoskeleton interface system 171. The control unit 172 can comprise a processor and one or more non-transitory storage media that can store control instructions which are executable by the processor. The control unit 172 can send control instructions to the linear actuator 112 to power the linear actuator 112 such that the linear actuator 112 is actuated to move the exoskeleton vertically relative to the mast 110. The control unit 172 can also send control instructions to the passive actuator 178 to activate or deactivate the passive actuator 178 if desired.

The control instructions generated by the control unit 172 to actuate the linear actuator 112 can be based on one or more inputs received at the control unit 172. For example, the mast exoskeleton interface system 171 can comprise a sensor 174 that can be strategically supported and located to be able to sense the operator donning the exoskeleton 102. For example, the sensor 174 can be deployed to measure or determine a vertical movement of the operator, such as when an operator crouches down into a squatting position or stands up from a squatting position. In some examples, the sensor 174 can be attached to, integrated with, or otherwise operable with a harness 130 that is coupled to the exoskeleton 102 and that is sized and configured to interface with the operator. In the example shown, the harness 130 can be sized and configured to be worn about the shoulders and torso of the operator.

The sensor 174 can comprise any suitable variety or type of sensor. In one example, the sensor 174 can comprise a force sensor such as a six-degree of freedom force moment sensor strategically located on and supported by the harness 130, wherein the six degree of freedom force moment sensor can be utilized to sense the movement of the operator via the harness 130. In another example, the sensor 174 can comprise a position sensor. The position sensor can be a displacement sensor that detects a position of the operator as the operator stands up or squats down. Of course, while a single sensor 174 is shown in FIG. 5, it should be understood that a combination of multiple sensors could also be used to provide input to the control unit 172.

In another example, the mast exoskeleton interface system 171 can comprise an operator input device 176 that the operator can manually interact with to initiate and control movement of the exoskeleton 102 relative to the mast 110. The operator input device 176 can provide input to the control unit 172 to facilitate the movement of the exoskeleton 102 relative to the mast 110. The operator input device 176 can be configured to provide the operator with the ability to manually provide control instructions to the control unit 172 to facilitate the movement of the exoskeleton 102 relative to the mast 110 (i.e., the operator can directly control the movement of the exoskeleton 102 relative to the mast 110 by manipulating the input device 176).

For example, the input device 176 can comprise a wireless transceiver that is operable to wirelessly send and receive information from a remote device, such as a mobile phone 131 or the like. The transceiver can be operable to wirelessly receive and transmit information via any suitable wireless protocol such as Bluetooth, Wi-Fi, NFC, or the like. The exoskeleton 102 can, for example, have a mounting receiver for a mobile phone 131. The operator can operate the mobile phone 131 which can run an application that is operable to wirelessly transmit information to the wireless transceiver. The information can comprise control instructions for moving the exoskeleton to a desired height relative to the mast 110. In another example, the input device 176 can comprise a wired transceiver that can connect to a remote device via a wired connection. For example, the exoskeleton 102 can comprise a mobile device dock to which the mobile phone 131 can connect via a wired connection. The input device 176 can also comprise other devices to provide input such as a joystick, a keyboard, or other known input devices. While one input device 176 is shown in FIG. 5, it should of course be understood that a combination of multiple input devices could also be used.

Each of the above-mentioned features of the mast exoskeleton interface system 171 can be connected to a power source 120 such as a battery that powers the walk-about exoskeleton system 100. The power source 120 can be advantageously stowed on the walk-about exoskeleton system 100 to provide balance to the system as will be discussed in more detail below.

When an operator moves vertically relative to the mast 110 while wearing the exoskeleton 102 of the walk-about exoskeleton system 100, the operator can cause the mast exoskeleton interface system 171 to move the exoskeleton 102 in a desired up-or-down direction and at a desired speed. For example, the operator can wear the harness 130 in conjunction with donning the exoskeleton 102. When the operator begins move vertically, such as to stand up or squat down, the sensor 174 can detect the operator's movement and transmit information regarding the operator's movement to the control unit 172 of the mast exoskeleton interface system 171. The control unit 172 can cause the linear actuator 112 to move the exoskeleton 102 based on the information received.

In one example, the sensor 174 can comprise a six degree of freedom force moment sensor as mentioned above. The sensor 174 can be operable to detect a force caused by the movement of the operator as the operator begins to stand up or squat down. The sensor 174 can detect a magnitude and a direction of the force which can correspond with an acceleration of the operator. The control unit 172 can receive information regarding the force sensed by the sensor 174. Based on the information received, the control unit 172 can send instructions to the linear actuator 112 such that the exoskeleton 102 moves in the same direction and speed as the operator. In one example, the control unit 172 can direct the linear actuator 112 to move the exoskeleton relative to the mast in such a manner as to continually attempt to zero out the force sensed by the sensor 174.

In another example where the sensor 174 comprises a position sensor such as displacement sensor, the sensor 174 can detect a direction and a magnitude of displacement caused the by operator beginning to stand up or squat down. The control unit 172 can receive information regarding the displacement of the sensor 174. Based on this information, the control unit 172 can send instructions to the linear actuator 112 such that the exoskeleton 102 moves in the same direction and speed as the operator. For example, the control unit 172 can direct the linear actuator 112 to move the exoskeleton 102 relative to the mast 110 in such a manner as to continually attempt to zero out the displacement sensed by the sensor 174.

In another example, the operator can control the movement of the walk-about platform 104 directly via the operator input 176. For example, the operator can use a mobile device 131 to send control instructions to the control unit 172 via a wired or wireless input device 176. Based on the input received at the control unit 172, the control unit 172 can send control instructions to the actuator 112 to move the walk-about exoskeleton vertically in accordance with the input provided by the operator. The operator can similarly manually control the movement of the walk-about exoskeleton 102 relative to the mast 110 via another input device such as via a joystick, keyboard, or the like.

Referring again to FIGS. 1-4. The walk-about base can comprise a first lateral member 124a and a second lateral member 124b. The first and second lateral members 124a, 124b can be joined by a support bridge 122. The support bridge 122 can space apart the first and second lateral members 124a, 124b and can also provide the supporting structure for the mast 110. In one example shown in FIGS. 1-4, each of the first and second lateral members 124a, 124b can comprise a vertical portion 126 connected to the support bridge 122 and a horizontal portion 128. The support bridge 122 can be located at any position relative to the ground surface. In one example, the vertical portions 126 can be configured so as to locate the support bridge 122 at a position and height so as to be behind the knees of the operator, thus reducing the likelihood that the support bridge 122 will interfere with the operator's movements while operating the walk-about exoskeleton system 100, such as during a gait cycle of the operator.

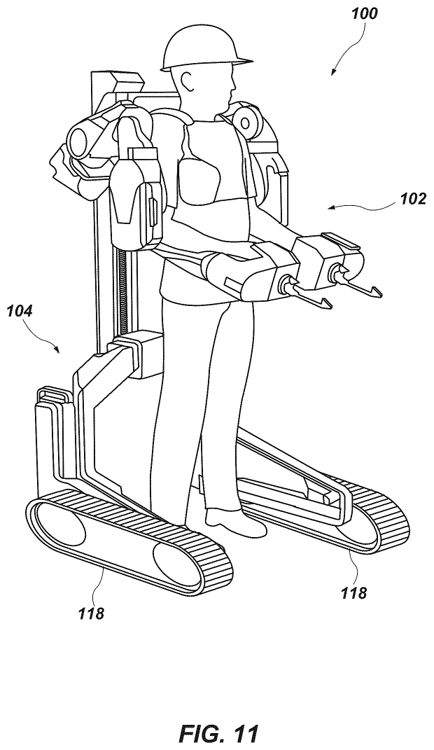

The horizontal portions 128 can extend from a bottom of the vertical portions 126 along the sides of the operator. That is, the horizontal portions 128 can extend from the rear of the operator where the horizontal portions 128 join the vertical portions 126 towards a front of the operator. The horizontal portions 128 can comprise front rollers 118 and rear rollers 119. For purposes of this description, front indicates the direction the operator faces while donning the exoskeleton 102, and rear indicates the direction opposite the direction the operator faces. The front and rear rollers 118, 119 can be any suitable type of rollers facilitating movement of the walk-about exoskeleton system about a ground surface. For example, the rollers 118, 119 can comprise wheels or tracks. In some examples, instead of front and rear rollers 118, 119, the rollers can comprise a single roller on each lateral member 124a, 124b in the form of a track that extends the length of the horizontal portion 128 (see FIG. 11). The rollers 118, 119 can comprise wheels or tracks which can be omnidirectional wheels or omnidirectional tracks. Each of the front rollers 118 and the rear rollers 119 can be actuated to move the walk-about exoskeleton system 100 as discussed in more detail below. In some examples, just the front rollers 118 or the rear rollers 119 can be actuated while the other of the front rollers 118 or the rear rollers 119 can be passive (i.e., are not actuated but roll freely). In some examples, all of the rollers 118, 119 are passive and the walk-about exoskeleton system 100 can be moved by the strength of the operator or via another external force acting on the exoskeleton system 100.

The lateral members 124a, 124b and support bridge 122 can define the bi-pedal locomotion zone 106. The bi-pedal locomotion zone 106 can comprise a space between the horizontal portions 128 of the lateral members 124a, 124b and in front of the support bridge 122 within which an operator donning the exoskeleton 102 can walk, run, or otherwise move about a ground surface. In other words, the bi-pedal locomotion zone 106 can comprise the space between the front rollers 118 and the rear rollers 119 as shown in FIGS. 1-4. Thus, while the operator is wearing the exoskeleton 102, the operator is positioned within the bi-pedal locomotion zone 106.

The vertical portions 126 of the lateral members 124a, 124b can be formed integrally with the horizontal portions 128 or can be coupled thereto. The vertical portions 126 can be further attached to or formed integrally with the support bridge 122. The vertical portions 126 can be sized and configured to receive and support a power source 120, such as a battery. Further, the vertical portions 126 can be positioned so as to be at the rear of the bi-pedal locomotion zone 106. This places the power source 120 (e.g., battery) at the rear of the bi-pedal locomotion zone 106. Typically, a power source 120 such as a battery can comprise a relatively large amount of weight. Thus, with the power source 120 being disposed on the vertical portions 126, the power source 120 can operate as a counterweight to the walk-about exoskeleton system 100. In other words, the power source 120 can help to stabilize the walk-about exoskeleton system 100 to prevent the walk-about exoskeleton system 100 from tipping during use. This is because the exoskeleton 102 and operator using the exoskeleton 102 pick up or otherwise interact with loads in front of the operator. The weight of the vertical portions 126 and power source 120 being behind the operator can provide a torque that counters the torque caused by the weight of the exoskeleton 102 and a load carried by the exoskeleton 102 to keep the walk-about exoskeleton system 100 from tipping. Of course, the power source 120 could be disposed at any position behind the operator during use such as on the support bridge 122.

With the power source 120 as a counterweight in a position at the rear of the walk-about exoskeleton system 100, or at the rear of the bi-pedal locomotion zone 106, the walk-about exoskeleton system 100 can maintain a center of gravity that falls within an area of the bi-pedal locomotion zone 106 (i.e., within an area between the front rollers 118 and the rear rollers 119) even when the exoskeleton 102 carries a load (that is within pre-determined specifications) in front of the operator. Because the power source 120 can operate as a counterweight at the rear of the bi-pedal locomotion zone 106, the walk-about exoskeleton system 100 can be operable to prevent tipping during operation by maintaining a center of gravity within an area of the bi-pedal locomotion zone 106. For example, even if an operator donning the exoskeleton 102 uses the robotic limbs 113a, 113b to carry a load in front of the operator, the walk-about exoskeleton system 100 can maintain a center of gravity within the bi-pedal locomotion zone 106 to avoid tipping due at least in part to the power source 120 (e.g. battery) being located at the rear of the bi-pedal locomotion zone 106 within the vertical portions 126 of the lateral members acting as a counterweight to the load carried by the exoskeleton 102. This is because the weight of the power source 120 at the rear of bi-pedal locomotion zone creates a torque acting on the walk-about platform 104 and the walk-about exoskeleton system 100 that acts in an opposite direction as the torque created by the load carried by the exoskeleton 102. Thus, the center of gravity can be maintained within the bi-pedal locomotion zone (or within an area defined by the front and rear rollers 118, 119) to prevent tipping.

In some examples, the power source 120 can be removable from the vertical portions 126 of the lateral members 124a, 124b. Thus, the power source 120 can be easily swapped for a new power source, for example, to quickly change from a depleted battery to a fully charged battery. In some examples, if even more counterweight is desired for a particular application, an additional counterweight can be provided that can be attachable to the walk-about base 104. For example, additional power sources 120 could be attached to the vertical portions 126 of the lateral members 124a, 124b or the support bridge 122. In some examples, a counterweight that is not a power source 120 could also be used. Further, the specific shape and configuration of the lateral members 124a, 124b, support bridge 122, and mast 110 are not limited to the exact features shown in FIGS. 1-4. It should be understood that modifications can be made while still facilitating a bi-pedal locomotion zone accommodating the operator and supporting structure behind the operator providing a counterweight to the exoskeleton 102 and load carried by the exoskeleton 102 to avoid tipping.

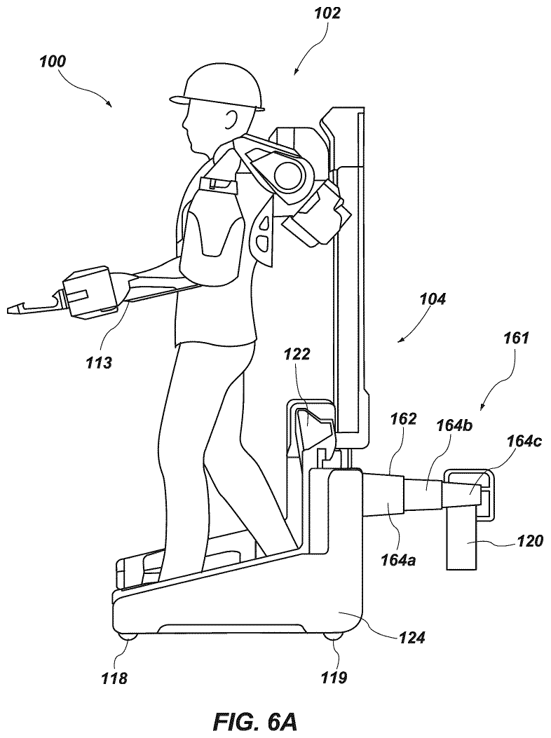

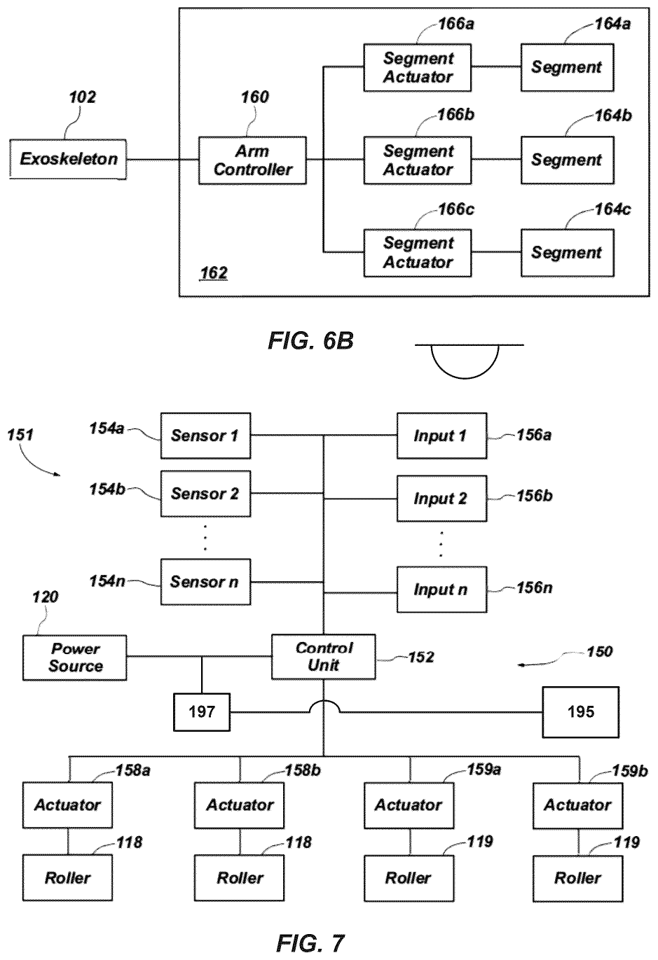

Other mechanisms to prevent tipping during use can also be incorporated into the walk-about exoskeleton system 100. For example, FIG. 6A shows a side view of the walk-about exoskeleton system 100 having a moveable counterweight system 161 according to one example of the present disclosure. As indicated, the exoskeleton system 100 can comprise a moveable counterweight system 161 operable to move and vary the location of the center of gravity of the walk-about exoskeleton system 100 during operation. The moveable counterweight system 161 can operate to vary the center of gravity to reduce the likelihood of, or to prevent altogether, tipping of the walk-about exoskeleton system 100. In this example, the moveable counterweight system 161 can provide an adjustable counterweight to counteract any loads or forces having a tendency to cause the walk-about platform 104 to tip. Such loads can change depending upon the tasks carried out using the walk-about exoskeleton system 100.

Generally speaking, the moveable counterweight system 161 can comprise a support arm and a weighted mass or counterweight coupled to or otherwise supported by the support arm. The support arm can be configured to facilitate movement of the counterweight into one of a plurality of positions relative to the walk-about platform 104. The support arm can be moved in response to or in preparation for loads acting on the walk-about exoskeleton system 100.

In one example, as shown in FIGS. 6A and 6B, the moveable counterweight system 161 can comprise a support arm in the form of an extendable arm 162. The extendable arm can be configured to support a counterweight. In some examples, the counterweight can comprise a power source 120, such as a battery. The extendable arm 162 can be a multi-segment arm having a first segment 164a, a second segment 164b, and a third segment 164c. While three segments 164a, 164b, 164c are shown in FIGS. 6A and 6B, any number of segments could be incorporated into the extendable arm 162. The segments 164a, 164b, 164c can be operable to move relative to one another such that the extendable arm 162 can extend and retract in a telescopic fashion. The extendable arm 162 can be coupled to the walk-about platform 104 at any location suitable to accomplish its intended purpose of preventing tipping of the walk-about exoskeleton system 100 by providing a counterweight to any loads or forces having a tendency to cause the platform 104 to tip. In the example shown, the extendable arm 162 can be coupled to the walk-about base 108, such as to the support bridge 122 or to one of the lateral members 124. In some examples, two extendable arms 162 (or more) can be utilized such as with one arm being attached to each of the lateral members 124 of the walk-about base 108.

The extendable arm 162 can be operable to carry the counterweight, in this example the power source 120, and to move the power source 120 into one of a plurality of positions relative to the walk-about platform 104 via movement of the extendable arm 162. In one example, the power source 120 shown can be one or more batteries. However, this is not intended to be limiting in any way. Indeed, in other examples, the counterweight can comprise any type of weighted mass, or any type of object, device, system, or any combination of these. In some examples, the counterweight can be attached to the outermost segment 164c of the extendable arm 162. In some examples, the counterweight can be removeable or replaceable. In some examples, the counterweight can be interchangeable with another counterweight of at least one of a different size, type or weight.

The support arm can be configured and operable to move in one or more degrees of freedom and along one or more axes to position the counterweight in one of a plurality of positions relative to the walk-about platform 104. In one example, as shown, the extendable arm 162 can be configured to extend and retract bi-directionally along an axis parallel to a ground surface. For example, as shown, the extendable arm 162 can extend outward and away from the walk-about platform 104 along an axis parallel to a ground surface, and in a direction opposite the direction in which the lateral members 124 extend (i.e., in a rearward direction, or in other words, a direction away from a back of the operator with the operator donning the exoskeleton 102). Likewise, the extendable arm 162 can be retracted in the opposite direction along the same axis.

In this manner, the extendible arm 162 can selectively move the counterweight 120 in a forward and rearward direction toward and away from the lateral members 124, thereby moving the center of gravity of the walk-about exoskeleton system 100 in a corresponding forward and rearward direction. By moving the counterweight in the forward and rearward directions, the counterweight can be positioned in one of a plurality of positions. This movement can allow the moveable counterweight system 161 to provide an appropriate countering torque that opposes a torque caused by lifting a load with the exoskeleton 102 in front of the operator. By countering the torque from the load with the moveable counterweight system 161, the center of gravity of the walk-about exoskeleton system 100 can be moved and maintained within an area defined by the lateral members 124. That is, the center of gravity can be moved to or maintained within the supports (i.e., the rollers 118 and 119) of the walk-about exoskeleton system 100 to avoid tipping (e.g., the center of gravity can be maintained within a bi-pedal locomotion zone such as the bi-pedal locomotion zone 106 in FIGS. 1-4).

Advantageously, the moveable counterweight system 161 (in any form or configuration) can be adjustable. In other words, the position of the counterweight relative to the walk-about platform 104 can be varied in order to vary the location of the center of mass of the walk-about exoskeleton system 100. This can reduce the likelihood of and/or prevent altogether the tipping of the walk-about exoskeleton system 100.

In some examples, the support arm, such as the exemplary extendable arm 162, can be actuated manually. In some examples, the support arm can be actuated automatically in response to a given load carried by the walk-about exoskeleton system 100. FIG. 6B is a schematic view of the exemplary extendable arm 162 of the walk-about exoskeleton system 100 of FIG. 6A. Referring to FIGS. 6A and 6B, the extendable arm 162 can comprise an arm controller 160 that controls the extension and retraction of the extendable arm 162. In this example, the extendable arm 162 can comprise the arm controller 160. However, the arm controller 160 could be incorporated into one or more other controllers or control systems of the walk-about exoskeleton system 100. For example, the controller 160 can be incorporated into same the same device as the control unit 172 discussed above, or can be separate controller from the control unit 172.

The arm controller 160 can be communicatively coupled to the exoskeleton 102, such that the arm controller 160 can receive information about a position of one or more of the limbs 113 of the exoskeleton 102 and/or a weight of a load carried by the limbs 113 of the exoskeleton 102. Based on the information received at the arm controller 160, a torque caused by a load carried by the exoskeleton 102 (e.g., a torque acting on the exoskeleton system 100 based on the position of the limbs 113 and/or the weight of the load carried by the exoskeleton 102) can be determined. If the torque is determined to have the potential to cause the walk-about exoskeleton system 100 to tip, the arm controller 160 can cause the extendable arm 162 to extend outwards in the rearward direction. This in turn can move the counterweight (in the form of the power source 120 in this example) in a rearward direction to a second position from a first position to increase a counter-torque provided by the counterweight 120 (i.e., by increasing a moment arm of the power source 120 counterweight relative to the walk-about platform 104 of the walk-about exoskeleton system 100) to oppose the torque caused by the load acting on the exoskeleton 102 and the position of the limbs 113. In some examples, the arm controller 160 can cause the extendable arm 162 to fully extend or to partially extend based on the information received at the arm controller 160 regarding the torque caused by the load carried by the exoskeleton 102.

In one example, the extendable arm 162 can comprise actuators 166a, 166b, 166c associated with the segments 164a, 164b, 164c, respectively. Each of the actuators 166a, 166b, 166c can comprise a linear or other type of actuator operable to extend and retract the associated segment 164a, 164b, 164c, respectively. For examples, the actuators 166a, 166b, 166c can be any suitable linear actuators including mechanical linear actuators, hydraulic linear actuators, pneumatic linear actuators, or the like. Of course, other types of actuators other than linear actuators can be employed to move the extendable arm 162. In addition, other types, different types, and any number of actuators can be employed to move the support arm, depending upon its configuration.

Those skilled in the art will appreciate that the support arm of the moveable counterweight system 161 that is shown as being in the form of an extendable arm 162 is not intended to be limiting in any way. Indeed, it is contemplated herein that the support arm of the moveable counterweight system 161 can be configured in a number of different ways, and can comprise a number of different types of mechanisms, components, etc. Indeed, any type of mechanism, system, and collection of components can be used to provide a support arm capable of moving a counterweight that is coupled to or otherwise supported by (e.g., integrally formed therewith) the support arm between a plurality of positions relative to the walk-about platform 104.

Returning the FIGS. 1-4, the walk-about exoskeleton system 100 allows an operator to move about a ground surface under his/her own power (e.g., walk, stand, squat, etc.) while amplifying the strength of the operator via the exoskeleton 102. FIG. 7 is a schematic view of an operator input interface in association with a conveyance system of the walk-about exoskeleton system shown in FIG. 1. Referring to FIGS. 1-4 and 7, the walk-about platform 104 of the walk-about exoskeleton system 100 can comprise a conveyance system 150 comprising various components as discussed herein, wherein the conveyance system 150 is operable to initiate and control movements of the walk-about platform 104 about a ground surface via inputs from the operator. The walk-about platform 104 can also define, at least in part, the bi-pedal locomotion zone 106 that provides clearance for bi-pedal locomotion of an operator donning the exoskeleton. The conveyance system 150 can be communicatively coupled to an operator input interface 151 to receive information from an operator of the walk-about exoskeleton system 100 to facilitate the movement of the walk-about platform 104 about the ground surface.

In some implementations, the walk-about exoskeleton 100 can include an interface 197 that can connect the walk-about exoskeleton 100 to the remote navigation system 195. The remote navigation system 195 can enable the walk-about exoskeleton 100 to be in operable communication with the remote navigation system 195. For example, the interface 197 can be an interface that enables electronic communication between the remote navigation system 195 and the walk-about exoskeleton 100 (e.g., at least one of log-in communication, status communication, or operational control communication). In some cases, the interface 197 may be associated with or integrated with one or both of the operator interface input 151 or the control unit 152.

In one example, the operator input interface 151 can comprise a plurality of sensors 154a, 154b, 154n (the letter “n” being used herein to represent and convey that any number of sensors (or other components, elements identified herein) are contemplated). In one example, the plurality of sensors 154a-n can be strategically supported and located to be able to sense the operator donning the exoskeleton 102. For example, one or more sensors of the plurality of sensors 154a-n can be deployed to measure or determine a speed and a direction in which the operator travels about the ground surface. In some examples, one or more sensors of the plurality of sensors 154a-n can be attached to, integrated with, or otherwise operable with a harness 130 that is coupled to the exoskeleton 102, and that is sized and configured to interface with the operator. In the example shown, the harness 130 can be sized and configured to be worn about the shoulders and torso of the operator.

The plurality of sensors 154a-n can comprise any one or more of a variety of different types. In one example, one or more sensors of the plurality of sensors 154a-n can comprise force sensors. For example, one or more sensors of the plurality of sensors 154a-n can comprise a six degree of freedom force moment sensor strategically located on and supported by the harness 130. The six degree of freedom force moment sensor can be utilized to sense the movement of the operator via the harness 130 as the operator walks, turns, squats, and/or returns to a standing position. These movements of the operator can induce a force on the walk-about exoskeleton system 100 through the harness 130 due to the movement of the operator relative to the walk-about exoskeleton system 100. The induced force can be sensed by the six degree of freedom force moment sensor. A corresponding speed and direction can be determined based on the sensed movements of the operator.

In another example, one or more sensors of the plurality of sensors 154a-n can comprise position sensors. For example, the position sensor can be a displacement sensor strategically located on and supported by the harness 130. The position sensor(s) can be operable to detect a position of the operator when the operator moves about the ground surface. The movement of the operator can cause a displacement in the position sensor via the harness 130 in one or more degrees of freedom. The displacement can be sensed by the displacement sensor, and a corresponding speed and direction of the operator can be determined based on the displacement caused by the movement of the operator.

Other types of sensors could also be utilized to provide information to the conveyance system 150 to determine the speed and direction in which the operator travels about the ground surface. For example, the sensors 154 can comprise one or more optical sensors or ultrasonic sensors. The optical sensors or ultrasonic sensors can be disposed on and supported anywhere on the walk-about base 104, such as in the lateral members 124 and/or the support bridge 122 of the walk-about base 104. The optical sensors or ultrasonic sensors can be configured, along with an image processor and/or an ultrasonic energy processor, to detect a position and orientation of the operator within the bi-pedal locomotion zone 106. For example, the optical sensors and/or ultrasonic sensors can detect the position and orientation of the operator's legs and/or feet within the bi-pedal locomotion. When the operator takes a step, the optical sensors and/or ultrasonic sensors can be configured to detect the direction and speed of the operator's legs/feet and can transmit corresponding processed information to the conveyance system 150 regarding the movement of the operator including a direction and speed within the bi-pedal locomotion zone 106.

In another example, the operator input interface 151 can comprise a plurality of operator input devices 156a, 156b, 156n that the operator can manually interact with to initiate and control movement of the walk-about platform 104. The operator input devices 156a-n can provide input to the conveyance system 150 to facilitate the movement of the walk-about platform 104 about a ground surface. The operator input devices 156a-n can be configured to provide the operator with the ability to manually provide control instructions to the conveyance system 150 to facilitate the movement of the walk-about platform 104 about the ground surface (i.e., the operator can directly control the movement of the walk-about platform 104 by manipulating one or more operator input devices of the plurality of operator input devices 156a-n).

For example, one of the input devices 156 can comprise a wireless transceiver that is operable to wirelessly send and receive information from a remote device, such as a mobile phone 131 or the like. The transceiver can be operable to wirelessly receive and transmit information via any suitable wireless protocol such as Bluetooth, Wi-Fi, NFC, or the like. The exoskeleton 102 can, for example, have a mounting receiver for a mobile phone 131. The operator can operate the mobile phone 131 which can run an application that is operable to wirelessly transmit information to the wireless transceiver. The information can comprise control instructions for moving the walk-about platform 104 in a desired direction at a given speed. In another example, the input devices can comprise a wired transceiver that can connect to a remote device via a wired connection. For example, the exoskeleton 102 can comprise a mobile device dock to which the mobile phone 131 can connect via a wired connection. The input devices 156 can also comprise other devices to provide input such as a joystick, a keyboard, or other known input devices.

The information from the operator input interface 151 can be sent to the conveyance system 150 to facilitate the movement of the walk-about platform 104. In one example, the conveyance system can comprise a control unit 152, one or more actuators 158a, 158b, 159a, 159b, and the rollers 118, 119. The control unit 152 can comprise a processor and one or more non-transitory storage media that can store control instructions which are executable by the processor. The control unit 152 can be connected to the operator input interface 151 to receive information from the sensors 154 and/or inputs 156 of the operator input interface 151. It is noted that the control unit 152 can be incorporated into the same device as the control unit 172 and/or controller 160, or the control unit 152 can be an independent device.

The control unit 152 can be further connected to the one or more actuators 158a, 158b, 159a, 159b which can actuate the rollers 118, 119. The actuators 158a, 158b, 159a, 159b can comprise any suitable actuator to cause the rollers 118, 119 to move in a desired direction and at a desired speed. For example, the actuators 158a, 158b, 159a, 159b can comprise one or more electric motors that can control the rotation and/or orientation of the rollers 118, 119. In some examples, the actuators 158a, 158b, 159a, 159b can be connected to the rollers 118, 119 via transmissions. The actuators 158a, 158b, 159a, 159b can comprise front actuators 158a, 158b connected to each of the front rollers 118, respectively, and rear actuators 159a, 159b connected to each of the rear rollers 119, respectively. The conveyance system 150 can be connected to the power source 120 such as one or more batteries to power the control unit 152 and actuators 158a, 158b, 159a, 159b.

When an operator moves about a ground surface while wearing the exoskeleton 102 of the walk-about exoskeleton system 100, the operator can cause the walk-about platform 104 to move the walk-about exoskeleton system 100 in a desired direction and speed. For example, the operator can wear the harness 130 in conjunction with donning the exoskeleton 102. When the operator begins to walk within the bi-pedal locomotion zone 106, one or more of the sensors 154a-n can detect the operator's movement and transmit information regarding the operator's movement to the control unit 152 of the conveyance system 150. The control unit 152 can cause one or more of the actuators 158a-b, 159a-b to drive the rollers 118, 119 based on the information received.

In one example, one or more of the plurality of sensors 154a-n can comprise a six degree of freedom force moment sensor as mentioned above. The sensor can be operable to detect a force caused by the movement of the operator as the operator begins to walk or otherwise move within the bi-pedal locomotion zone 106. The sensor can detect a magnitude and a direction of the force which can correspond with an acceleration and direction of the operator. The control unit 152 can receive information regarding the force sensed by the sensor. Based on the information received, the control unit 152 can send instructions to one or more of the actuators 158a, 158b, 159a, 159b to actuate one or more of the rollers 18, 19 such that the walk-about platform 104 moves in the same direction as the operator. In one example, the control unit 152 can direct the actuators 158a, 158b, 159a, 159b to move the walk-about platform 104 in such a manner as to continually attempt to zero out the force sensed by the sensor 154. In this manner, the walk-about platform 104 can move in the same direction and speed as the operator.

In another example where one or more of the plurality of sensors 154a-n comprises a position sensor such as displacement sensor, the sensor can detect a direction and a magnitude of displacement caused the by operator beginning to walk or otherwise move within the bi-pedal locomotion zone 106. The control unit 152 can receive information regarding the displacement of the sensor. Based on this information, the control unit 152 can send instructions to one or more of the actuators 158a, 158b, 159a, 159b to actuate one or more of the rollers 18, 19 such that the walk-about platform 104 moves in the same direction and speed as the operator. For example, the control unit 152 can direct the actuators 158a, 158b, 159a, 159b to move the walk-about platform 104 in such a manner as to continually attempt to zero out the displacement sensed by the sensor 154.

In another example where the one or more sensors 154 comprises an optical or ultrasonic sensor, the sensor 154 can detect the position, orientation, and movement of the legs and/or feet of the operator as the operator begins to walk or otherwise move within the bi-pedal locomotion zone 106. The control unit 152 can receive information from the sensor 154 regarding the position, orientation, and movement of the legs and/or feet of the operator. Based on this information the control unit 152 can send instructions to one or more of the actuators 158a, 158b, 159a, 159b to actuate one or more of the rollers 18, 19 such that the walk-about platform 104 moves in the same direction and speed as the operator. For example, the control unit 152 can direct the actuators 158a, 158b, 159a, 159b to move the walk-about platform 104 in such as manner as to continually maintain the legs and/or feet of the operator within the bi-pedal locomotion zone 106 as the operator moves about the ground surface.

In another example, the operator can control the movement of the walk-about platform 104 directly via one or more of the inputs 156. For example, the operator can use a mobile device 131 to send control instructions to the control unit 152 via a wired or wireless input 156 of the operator input interface 151. Based on the input received at the control unit 152, the control unit 152 can send control instructions to the actuators 158a, 158b, 159a, 159b to move the walk-about platform 104 in accordance with the input provided by the operator. The operator can similarly manually control the movement of the walk-about platform via another input device such as via a joystick, keyboard, or the like.

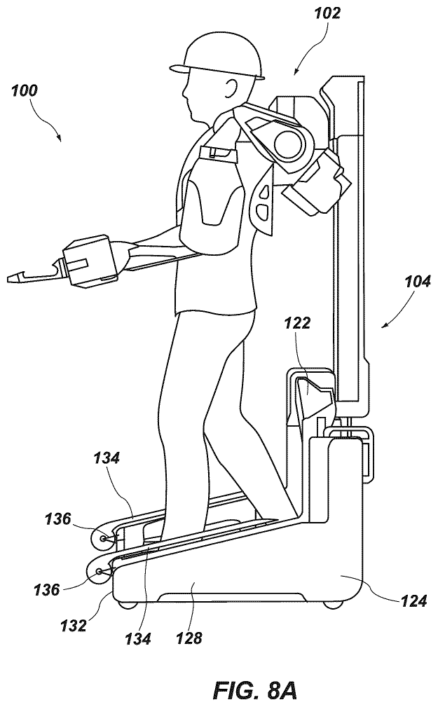

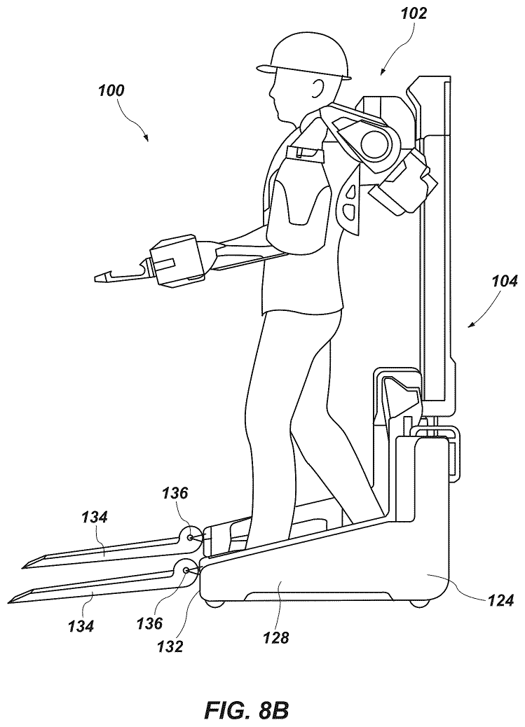

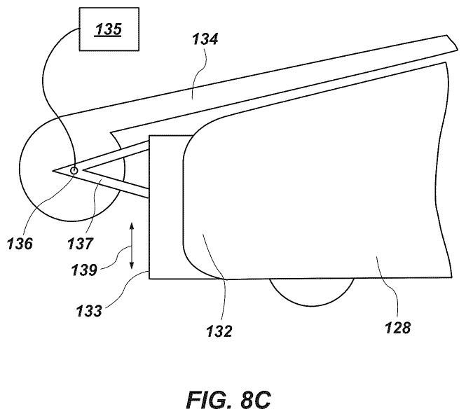

In some examples, a walk-about exoskeleton system can be used to transport pallets in addition to amplifying the work of a human via an exoskeleton. FIGS. 8A and 8B show side views of a walk-about exoskeleton system having deployable forks, and FIG. 8C shows an enlarged view of a front of a lateral member of the walk-about exoskeleton system shown in FIGS. 8A and 8B. Referring to FIGS. 8A-8C, the walk-about platform 104 can comprise lateral members 124 spaced apart by a support bridge 122 as mentioned above. Each of the lateral members 124 can comprise horizontal portions 128. Deployable forks 134 can be configured to attach to the front 332 of the horizontal portion 128 of each of the lateral members 124. The forks 134 can be rotatably attached to the lateral members 124 in any suitable manner. In the example shown, the forks 134 can be attached to the front 132 of the lateral member members 124 via respective axles 136. The forks 134 can be configured to rotate about the axle 136 to rotate from a stowed position (as shown in FIG. 8A) to a deployed position (as shown in FIG. 8B).

In some examples, the deployment and retraction of the forks 134 can be powered by actuators 135. For example, the actuators 135 can comprise electric motors and optionally transmissions coupled to each fork 134, respectively. The actuators 135 can provide a torque sufficient to rotate the forks 134 from the stowed position (FIG. 8A) to a deployed position (FIG. 8B) and from the deployed position to the stowed position. In other examples, the forks 134 can be rotated manually by the operator from the stowed position to the deployed position and back.

With the forks 134 in the deployed position as shown in FIG. 8B, the walk-about exoskeleton system can be used to pick up and transport pallets via the forks 134. For example, the forks 134 can be mounted to the front side 132 of the lateral members 124 via a mount 137. The mount 137 can be configured to extend from an actuator 133. The actuator 133 can be any suitable actuator such as a linear actuator operable to move the mount 137 vertically, indicated by arrow 139. By lowering the mount 137 with the actuator 133 while the forks 134 are in the deployed position, the forks 134 can be moved to a position to pick up a pallet on a ground surface. When the forks 134 are under a pallet, the actuator 133 can raise the mounts 137, thereby raising the forks 134 to lift the pallet to be transported to another location. Optionally, the actuator 135 can be configured to rotate the forks 134 while carrying a pallet such that the forks are angled to maintain the pallet on the forks 134 during transport.

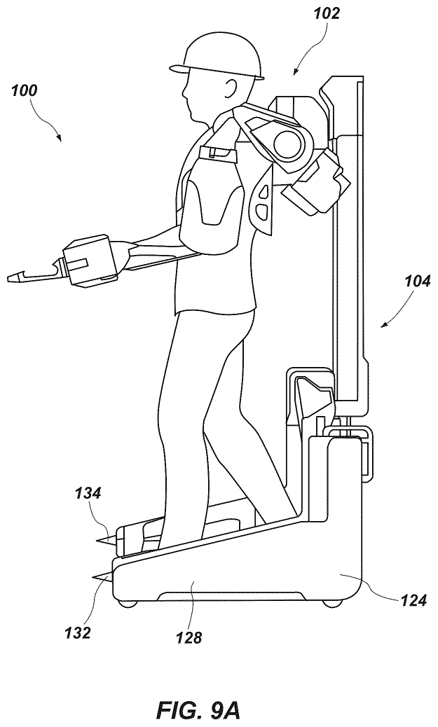

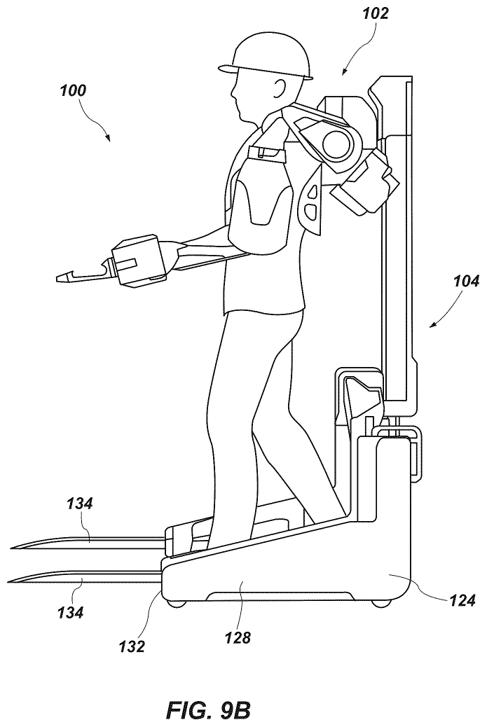

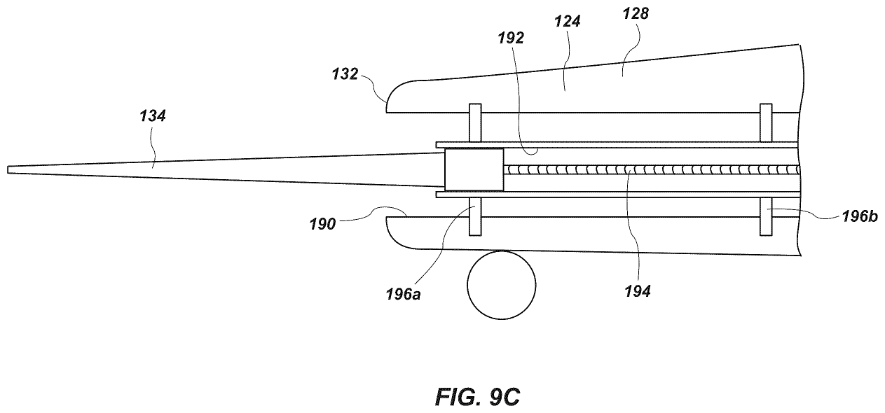

The deployable forks are not limited to rotatable forks as shown in FIGS. 8A and 8B. FIGS. 9A and 9B show side views of a walk-about exoskeleton system also having deployable forks, and FIG. 9C shows an enlarged view of a front of a lateral member of the walk-about exoskeleton system shown in FIGS. 9A and 9B. Referring to FIGS. 9A-9C, the deployable forks 134 can be configured to be housed within or alongside the horizontal portion 128 of each of the lateral members 124 when in the stowed position as shown in FIG. 9A. For example, the forks 134 can be stowed within a fork compartment 190 of the lateral member 124. The forks 134 can be operable to extend from and retract into the lateral members 124 via any suitable mechanism. In the example shown in FIGS. 9A-9C, the forks 134 can be attached to a linear track 192 such that the forks 134 can translate out of the horizontal portions 128 of the lateral members 124 to the deployed position as shown in FIG. 9B.

In some examples, the deployment and retraction of the forks 134 can be done manually by the operator. In other examples, the deployment and retraction of the forks 134 can be powered by an actuator 194 such as a mechanical, hydraulic, or pneumatic linear actuator. In order to raise and lower the forks to pick up and put down pallets, the track 192 and the forks 134 can be raised and lowered vertically via one or more actuators 196a, 196b. Thus, with the forks 134 in the deployed position as shown in FIG. 9B, the walk-about exoskeleton system can be used to pick up and transport pallets via the forks 134.

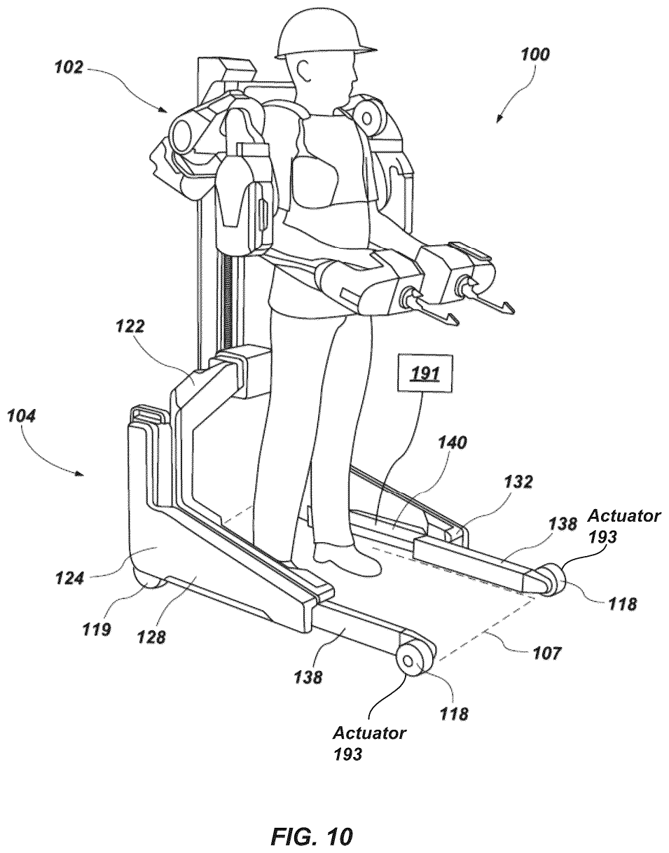

Referring now to FIG. 10, illustrated is an isometric view of a walk-about exoskeleton system having retractable extensions. In this example, the lateral members 124 of the walk-about base 104 can comprise horizontal portions 128 that can house retractable extensions 138. The retractable extensions 138 can be operable to be stowed within the horizontal portions 128 of the lateral members 124 and to extend outwards from a front side 532 of the lateral members 124, similar to the forks 134 discussed above with reference to FIGS. 9A-9C.

For example, the retractable extensions 138 can be mounted on respective tracks 140 on which the retractable extensions 138 can translate in and out of the horizontal portions 128 of the lateral members 124. In some examples, the retractable extensions 138 can be configured to extend and retract in a powered manner. For example, a linear actuator 191 can be provided and can be operable to extend the retractable extensions 138 out of the lateral members 124 and to retract the retractable extensions 138 back into the lateral members 124. In another example, the front ground contacting rollers 118 can each include an actuator 193 that can be operable to extend the retractable extensions 138 out of the lateral members 124 and to retract the retractable extensions 138 back into the lateral members 124. In implementations in which the actuators are included in the front ground contacting rollers, the actuators for the retractable extensions maybe be omitted from the walk-about base, which can save space, reduce cost, and allow increased design flexibility (e.g., with regard to weight distribution, configuration, and so forth). A locking mechanism can be implemented that locks the retractable extensions 138 in a retracted position and in an extended position. The locking mechanism can operate to lock the retractable extensions 138 in a retracted position relative to the lateral members 124, such that actuation of the front ground contacting rollers 118 does not cause the retractable extensions to extend, but still facilitates locomotion of the walk-about platform 104. Likewise, the locking mechanism can operate to lock the retractable extensions 138 in an extended position relative to the lateral members 124, such that continued actuation of the front ground contacting rollers 118 does not cause the retractable extensions to retract, but still facilitates locomotion of the walk-about platform 104. The locking mechanism can comprise a manual lock, such as a pin that extends through a through hole extending through the lateral members 124 and the retractable extensions 138. In another example, the locking mechanism can comprise an actuatable locking mechanism, wherein an actuator (e.g., a linear actuator, such as a solenoid) associated with a locking member (e.g., a latch, a pin, and others) can be selectively controlled to actuate the locking member. There are numerous types and ways in which to implement a locking mechanism as will be recognized by those skilled in the art.

In this example, the front rollers 118, which can be omnidirectional wheels, can be disposed on ends of the retractable extensions 138. Thus, when the retractable extensions 138 are moved outward to the deployed position, the front rollers 118 move outward along with the retractable extension 138. When the front rollers 118 move outward, the possibility of the walk-about exoskeleton system 100 tipping can be prevented by increasing an area within the supports (i.e., within the rollers 118 and 119).

For example, if a load is carried by the exoskeleton 102 in front of the operator, and if the load extends sufficiently forward of the front rollers 118 when the retractable extensions 138 are in the stowed or retracted position, the risk of the walk-about exoskeleton system 100 tipping may increase. This is because the load carried by the exoskeleton 102 can cause the center of gravity of the walk-about exoskeleton system 100 to move forward of the front roller 118 when in the stowed position. The risk of tipping can be prevented by extending the retractable extensions 138 such that the front rollers 118 move forward to a position forward of or underneath the load (or at least to approach a position underneath the load) such that a center of gravity of the walk-about exoskeleton system 100 with the load remains within an area defined by the front rollers 118 in the extended position and the rear rollers 119 (that is, center of gravity remains within an extended bi-pedal locomotion zone 107 shown in FIG. 10 defined by the front rollers 118, the rear rollers 119, the lateral members 124 including the retractable extensions 138, and the support bridge 122). Because the center of gravity remains within an area defined by the front rollers 118 and the rear rollers, the walk-about exoskeleton system 100 can be prevented from tipping.

In some examples, the retractable extensions 138 can be extended automatically based on a load carried by the exoskeleton 102. The retractable extensions 138 can be actuated based on control instructions received from a control unit on the walk-about exoskeleton system 100 (e.g., the control unit 172, 160, 152 discussed herein or a separate control unit). The control unit can receive information regarding a torque caused by a load carried by the exoskeleton 102 (e.g., a torque acting on the exoskeleton system based on the position of the limbs of the exoskeleton 102 and the weight of the load carried by the exoskeleton 102). If the torque is determined to potentially cause the walk-about exoskeleton system 100 to tip, the control unit can cause the retractable extensions 138 to extend outwards, thus moving the front rollers 118 in a forward direction to prevent tipping. In some examples, the retractable extensions 138 can be operable to extends outwards to a furthermost position. In some examples, the retractable extensions 138 can be operable to extend partially outwards based on the position of limbs the exoskeleton 102 and the weight of the load carried by the exoskeleton 102.

Referring now to FIG. 11, FIG. 11 is an isometric view of a walk-about exoskeleton system having track rollers. In this example, and as mentioned above, the rollers 118 of a walk-about exoskeleton can comprise wheels or tracks. In this example shown in FIG. 11, the rollers 118 are shown as tracks. In some examples, the tracks can comprise omnidirectional tracks. The examples of the rollers herein are not intended to be limiting in any way. It should be understood that any suitable roller can be utilized to facilitate movement of the walk-about exoskeleton system 100 about a ground surface.

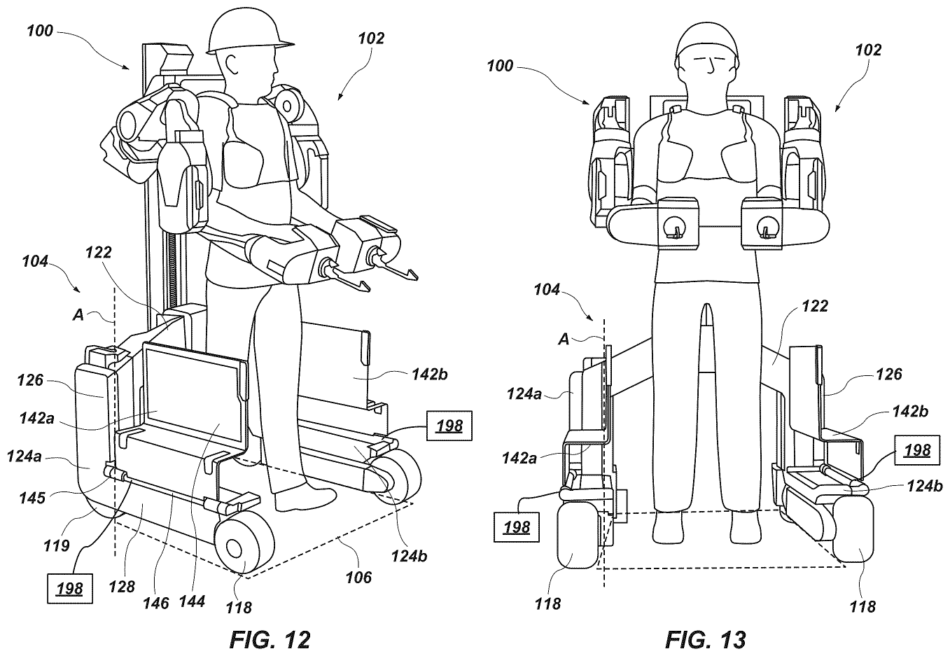

In some instances, an operator may desire to travel using a walk-about exoskeleton system without walking. Thus, in some examples, the walk-about exoskeleton system 100 can be configured to switch between a walking configuration and a riding configuration. FIGS. 12-15 show a walk-about exoskeleton system having a deployable riding platform. Referring to FIGS. 12-15, during use of the walk-about exoskeleton system 100, the operator may desire to ride on the system 100 instead of walking with the system 100. To facilitate this, the walk-about platform 104 can comprise a riding platform attached to the walk-about platform. The riding platform can be selectively moveable into the bi-pedal locomotion zone 106 to allow the operator to ride on the walk-about platform 104. In this example, the riding platform can comprise a right foot platform 142a connected to a right lateral member 124a and a left foot platform 142b connected to a left lateral member 124b. Thus, in this example, the walk-about platform 104 can be considered a convertible ride-on and walk-about platform.

Each of the foot platforms 142a, 142b are operable to selectively move into and out of the bi-pedal locomotion zone 106 such that the operator can selectively ride on or walk with the walk-about exoskeleton system 100. In this example, the right and left foot platforms 142a, 142b are rotatably attached to the right and left lateral members 124a, 124b, respectively. The right and left foot platforms 142a, 142b can connect to an outside edge of the horizontal portion 128 of each of the right and left lateral members 124a, 124b. The right and left foot platforms 142a, 142b can rotate about an axle 146 that runs along the outside edge of the horizontal portion 128 of each of the right and left lateral members 124a, 124b. Each of the right and left foot platforms 142a, 142b can comprise a friction enhancing surface 144 to increase safety such that the operator can be prevented from slipping off of the right and left foot platforms 142a, 142b.

As shown in FIGS. 12 and 13, the right and left foot platforms 142a, 142b can be rotated to walking position where the right and left foot platforms 142a, 142b are rotated up and away from the bi-pedal locomotion zone such that a plane defined by the friction enhancing surface 144 is parallel with an axis A defined by the vertical portions 126 of the left and right lateral members 124a, 124b. With the right and left foot platforms 142a, 142b in the walking position, the operator can walk in the bi-pedal locomotion zone 106 with the walk-about exoskeleton system 100 as described above.

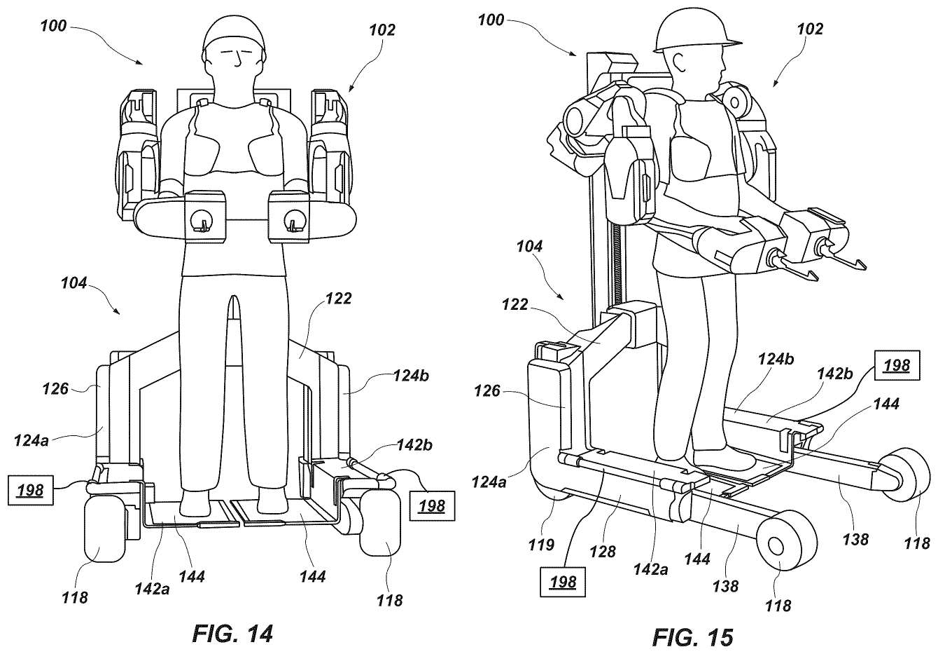

As shown in FIGS. 14 and 15, the right and left foot platforms 142a, 142b can be rotated to a riding position wherein the right and left foot platforms 142a, 142b are rotated down into the bi-pedal locomotion zone such that a plane defined by the friction enhancing surface 144 is parallel with a ground surface. With the right and left foot platforms 142a, 142b in the riding position, the operator can ride on the walk-about platform 104 while donning the exoskeleton 102 of the walk-about exoskeleton system 100. The operator can control the walk-about platform 104 via an operator input such as one of the operator input devices 156a-n described above with reference to FIG. 7.

In one example, the right and left foot platforms 142a, 142b can each be rotatably connected to the right and left lateral member 124a, 124 via a bi-stable mechanism. The bi-stable mechanism can be operable such that the right and left foot platforms 142a, 142b are biased to remain out of the bi-pedal locomotion zone 106 when the right and left foot platforms 142a, 142b are in the walking position and are biased to remain in the bi-pedal locomotion zone 106 when the right and left foot platforms 142a, 142b are in the riding position. For example, the right and left foot platforms 142a, 142b can connect to the right and left lateral members 124a, 124b via a torsion spring 145. The torsion spring 145 can be configured to have a stiffness such that when the right and left foot platforms 142a, 142b are in the upright walking position, the torsion spring 145 can maintain the right and left foot platforms 142a, 142b in the upright walking position. The torsion spring 145 can be further configured with a stiffness such that when the right and left foot platforms 142a, 142b are down in the riding position, the spring force of the torsion spring 145 is insufficient to overcome a torque caused gravity acting on the right and left foot platforms 142a, 142b such that the right and left foot platforms 142a, 142b remain in the riding position.

In some examples, the operator can manually move the right and left foot platforms 142a, 142b from the walking position to the riding position and from the riding position to the walking position. In other examples, an actuator 198 such as an electric motor can be provided with each of the right and left foot platforms 142a, 142b to move the right and left foot platforms 142a, 142b from the walking position to the riding position and from the riding position to the walking position.

As shown in FIG. 15, the walk-about exoskeleton 100 can also comprise retractable extensions 138 as discussed above with reference to FIGS. 9A-9C and 10. Of course, it is noted that any of the features of the exoskeleton system 100 discussed herein can be incorporated in any suitable combination and the examples provided herein are not intended to be limiting in any way.

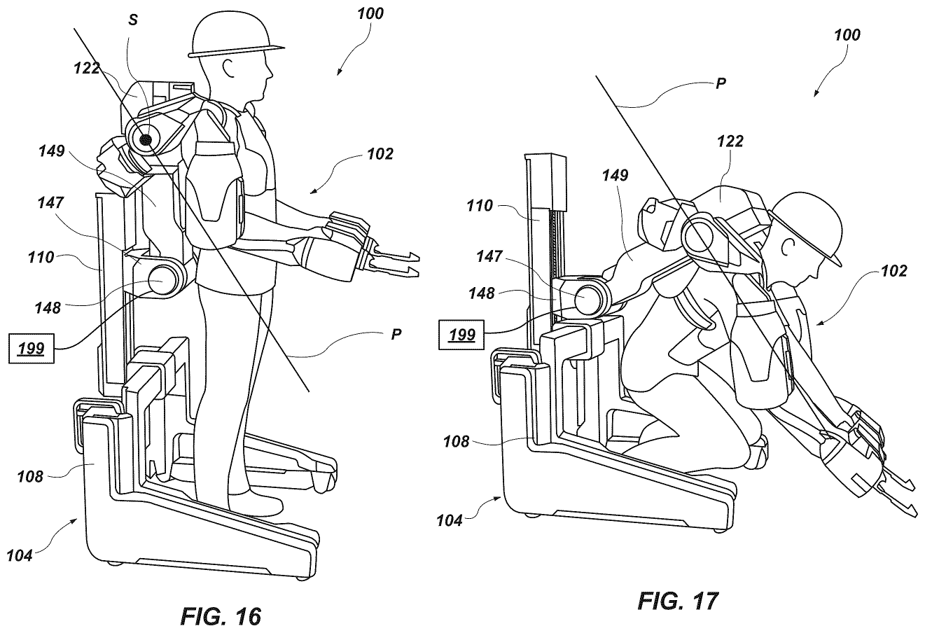

Referring now to FIGS. 16-18, FIGS. 16-18 show a walk-about exoskeleton system having a torso-forebend. When an operator desires to pick something up that is on a ground surface in front of the walk-about exoskeleton system 100, the operator may naturally want to lean forward over the item to be picked up. Accordingly, the walk-about base 104 of the walk-about exoskeleton system 100can comprise a torso member 149 and a mast interface member 147 that rotate relative to one another. In some examples, the torso member 149 can be attached to the support bridge 122 of the exoskeleton 102 shown in FIGS. 1-4. In other examples, the torso member 149 can be formed integrally with the support bridge 122 of the exoskeleton 102. In this example, the torso member 149 and the mast interface member 147 can be joined at a joint 148. The torso member 149 and mast interface member 147 can rotate about an axis of rotation at the joint 148 to allow for a torso-forebend motion, wherein a point S on the right and left robotic limbs 113a, 113b undergoes inclined displacement in a sloped vertical degree of freedom along the sloped vertical axis P, such that the right and left robotic limbs 113a, 113b, and specifically the point S on these, approximate the inclined path of movement or travel of a shoulder of the operator when operating the walk-about exoskeleton system 100, and when moving between a standing and squatting position. In some examples, when the operator leans forward, such as shown in FIG. 17, the torso member 149 rotates relative to the mast interface member 147 to remain substantially parallel with the operator's torso.

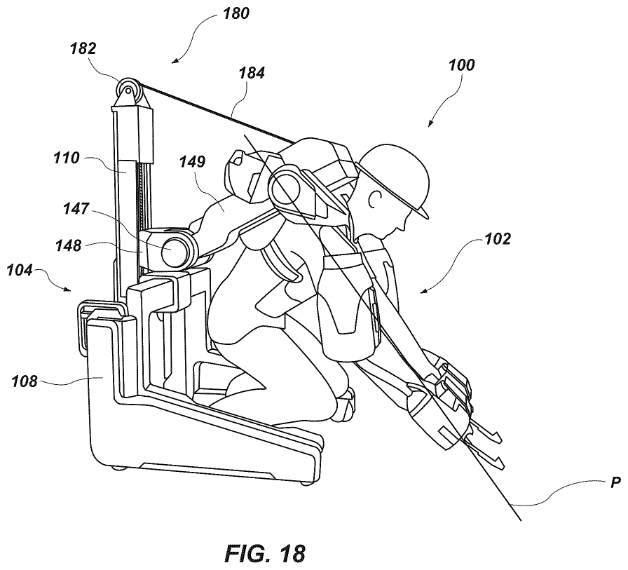

The rotation between the torso member 149 and the mast interface member 147 can be a powered rotation. For example, an actuator 199 can be provided between the torso member 149 and the mast interface member 147 to rotate the torso member 149 relative to the mast interface member 147 about the axis of rotation at the joint 848. The actuator 199 can comprise an electric motor and a transmission, though any other suitable actuator could also be used. In the example shown in FIG. 18, a winch system 180 can be provided to facilitate the rotation between the torso member 149 and the mast interface member 149. The winch system 180 can comprise a winch 182 that can be disposed on the mast 110. The winch system 180 can further comprise a cable 184 can connect the torso member 149 and exoskeleton 102 to the winch 182 such that the winch 182 can raise and lower the torso member 149 causing the torso member 149 to rotate about the axis at the joint 848.

The mast interface member 147 can be operable to move vertically along the mast 110 in a similar manner as the exoskeleton 102 can moves vertically along the mast 110 as described above with reference to FIGS. 1-5. Thus, the operator can perform a squatting motion and lean forward with torso-forebend while using the walk-about exoskeleton system 100.

It should be noted that while various examples of a walk-about exoskeleton system are described above, the examples are illustrative of different features that can be incorporated in a walk-about exoskeleton system. Thus, the features in each of the walk-about exoskeleton systems described above can be combined together in any combination desired.

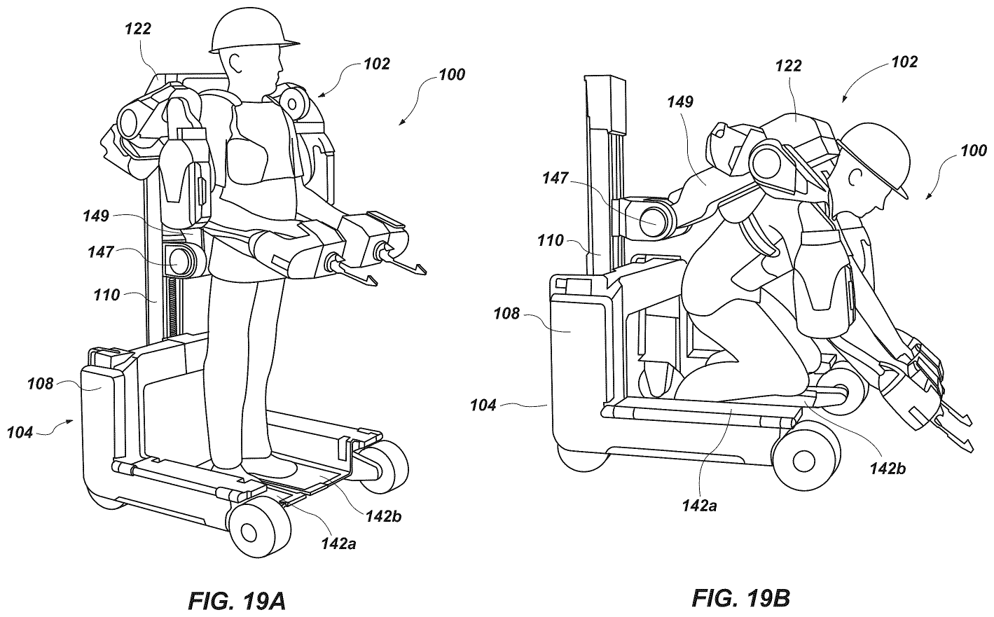

As an example, FIGS. 19A and 19B show the walk-about exoskeleton system 100 incorporating torso-forebend with the torso member 149 and a mast interface member 147 that rotate relative to one another to provide torso-forebend as described above. Further, the walk-about exoskeleton system 100 can also comprise the riding platform that can be selectively moveable into a bi-pedal locomotion zone to allow the operator to ride on the walk-about platform 104. As explained above, a riding platform can comprise a right foot platform 142a and a left foot platform 142b on which an operator can stand to ride on the walk-about platform 104. This is just another example of a combination of features of the walk-about exoskeleton system and the features described herein can be combined in any desired configuration.

In some implementations, the walk-about exoskeleton system 100 or the conveyance system 150 of the walk-about exoskeleton can be operably integrated (e.g., in operable communication) with a remote navigation system 195 in a work environment, such as an in-building navigation system, comprising one or more robotic assets of a different type (e.g., existing robotic assets that perform various automated tasks, such as those within a warehouse) than the walk-about exoskeleton system 100 that move within an environment. For example, the remote navigation system 195 can comprise robotic assets whose movements are based on in-floor guidance, (e.g., using radio frequency (RF) signals from an in-floor wire), magnetic tape guidance, laser-based guidance, gyroscopic (e.g., inertial) guidance, camera-based visual guidance, and so forth.

The walk-about exoskeleton system 100 can be operably integrated with the remote navigation system 195 and operated in conjunction with the other robotic assets. The walk-about exoskeleton system 100 can be operated in a variety of modes, including for example, a live-operator mode, a remote (e.g., tele-operation) mode, or an autonomous mode. The live-operator mode is a mode in which the operator is present in the exoskeleton 102 in either a walking mode or a riding mode, as described herein. The remote mode is a mode in which the operator controls the exoskeleton system 100 (e.g., controls at least in part) remotely with the remote navigation system 195 using a remote device, such as a mobile phone 131, a joystick, a keyboard, or the like, as described herein.

The autonomous mode is a mode in which the operator may not be necessary to control the walk-about exoskeleton system 100. For example, the operator may only monitor the walk-about exoskeleton system 100 in case an intervention is necessary. In other cases, the operator may have no interaction with the walk-about exoskeleton system 100. The walk-about exoskeleton system 100 can also include a controller for switching between the modes (e.g., the interface can include an input system that allows an operator and/or the remote navigation system 195 to switch between modes). In some implementations, the modes can be hot-switched, in other words, the walk-about exoskeleton system 100 can switch, or be switched, between modes in real time, without having to return to a predefined starting point, such as a base station or charging station.

In integrated implementations, the walk-about exoskeleton system 100 can include an interface 197 that can connect the walk-about exoskeleton 100 to the remote navigation system 195. The remote navigation system 195 can enable the walk-about exoskeleton system 100 to be in operable communication with the remote navigation system 195. For example, the interface 197 can be an interface that enables electronic communication between the remote navigation system 195 and the walk-about exoskeleton system 100 (e.g., at least one of log-in communication, status communication, or operational control communication). In some cases, the interface 197 may be associated with or integrated with one or both of the operator interface input 151 or the control unit 152. The walk-about exoskeleton system 100 can also include one or more sensors that enable integration, such as sensors that can detect the RF signals, magnetic sensors, lasers and laser-detection mechanisms, a gyroscope system, cameras (e.g., image capture devices in various spectra, such as visible, infra-red, and so forth).

In some cases, the interface 197 can allow the walk-about exoskeleton system 100 to provide various parameters to the remote navigation system 195 and to receive various commands from the remote navigation system 195. For example, the walk-about exoskeleton system 100 can provide parameters such as maximum and minimum speed, turning radius, weight (e.g., mass), and footprint (e.g., how much space the walk-about exoskeleton system 100 occupies, which can include one or both of floor area and volume). Further, the walk-about exoskeleton system 100 can provide information from its various sensors to the remote navigation system 195.

The remote navigation system 195 can then send commands to the walk-about exoskeleton system 100 that control one or more aspects of the walk-about exoskeleton system 100, such as the conveyance system 150, to facilitate movement of the walk-about platform 104 about the ground surface (e.g., the floor of the work environment). Further, the remote navigation system 195 can also send commands to control one or more systems or subsystems of the walk-about exoskeleton system 100 described in this document, including (but not limited to) the power source 120, the mast exoskeleton interface system 171, the extendible arm 162 of the moveable counterweight system 161, the retractable extensions 138 for the forward rollers 118 (e.g., via either or both of the actuators 191 and 193), the torso-forebend, the winch system 180, the limb members 114, the joints 115, the forks 134, and so forth.

In some implementations, the walk-about exoskeleton system 100 as integrated with the remote navigation system 195 can also include a training mode. The training mode can allow an operator to perform tasks while the walk-about exoskeleton system 100 is in a learning mode so that the walk-about exoskeleton system 100 can perform those tasks in the autonomous mode.

The benefits of integration with a remote navigation system 195 can include route-optimization, collision-avoidance with existing robotic assets already part of the navigation system 195, and increased speed. These advantages may be greater in modes without an operator (e.g., remote or autonomous), but even in the live-operator or remote mode, route-optimization collision-avoidance can be improved, and speed may be increased when the walk-about exoskeleton system 100 is operated in a riding configuration (e.g., as described with reference to FIGS. 12-15). Further, the autonomous mode may also allow the operator to perform other functions, rather than operating the exoskeleton system 100.

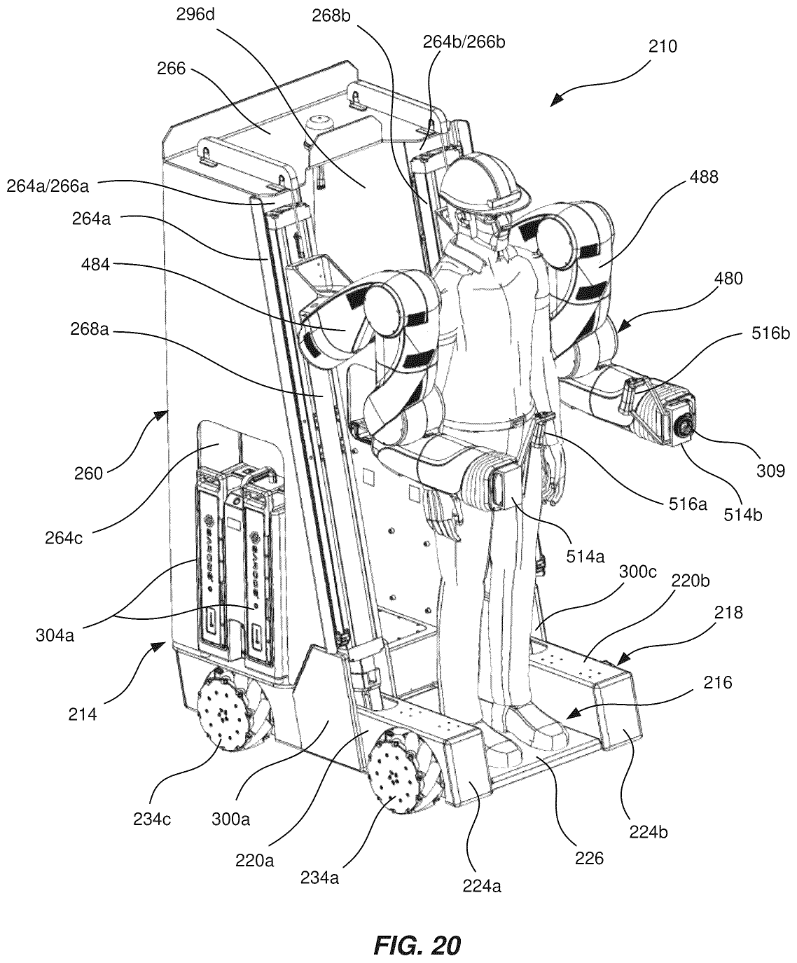

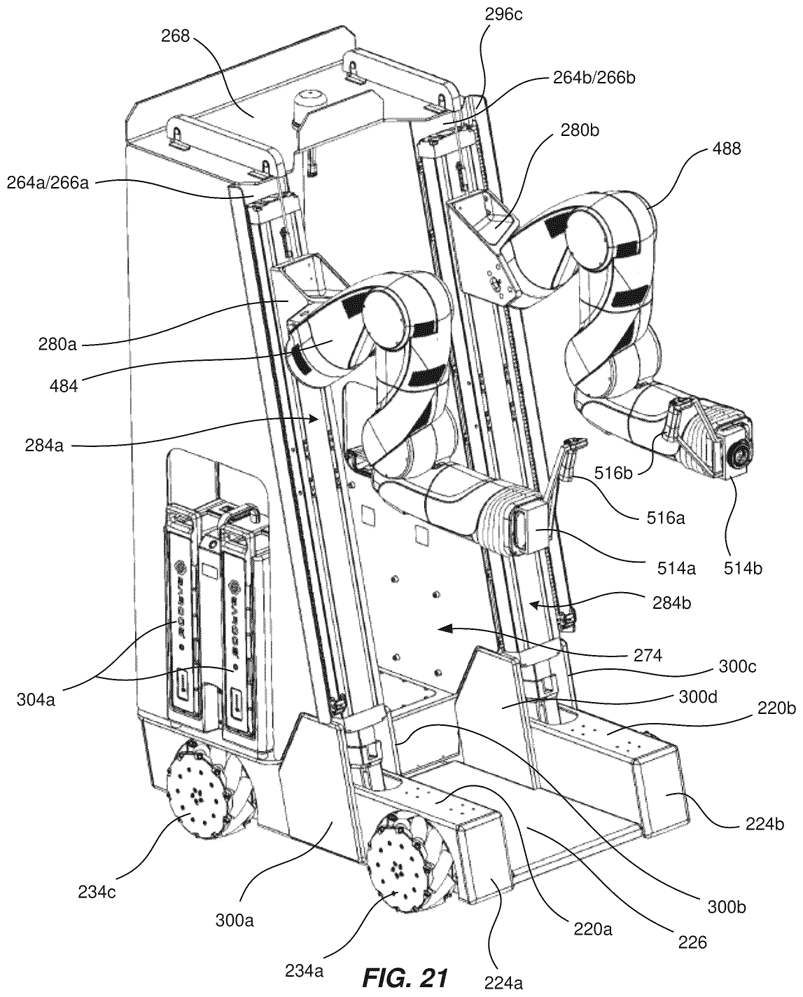

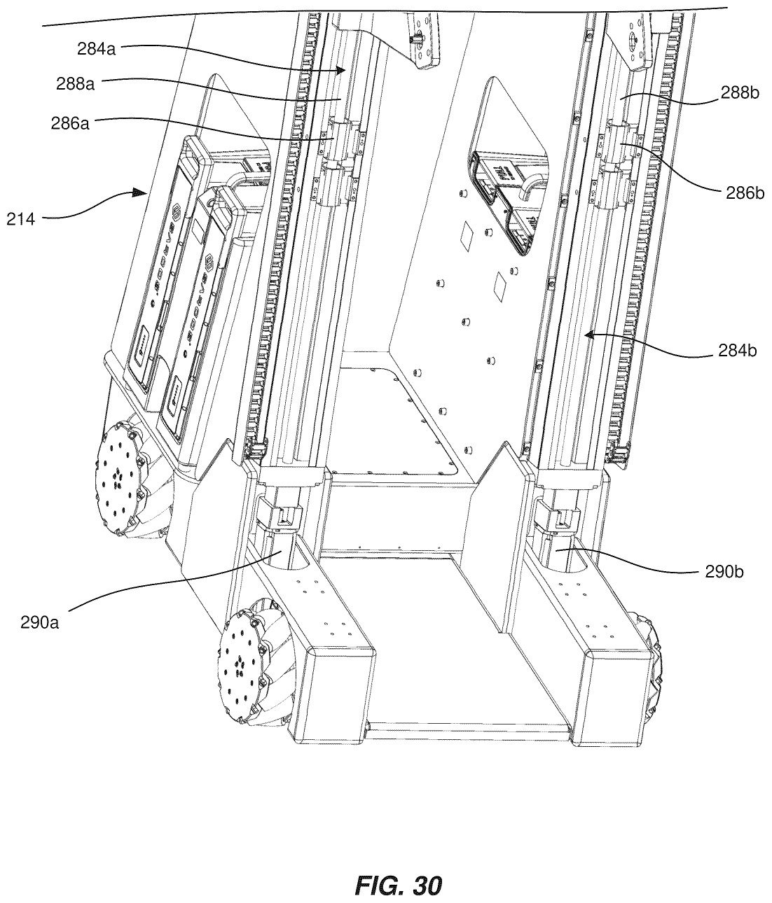

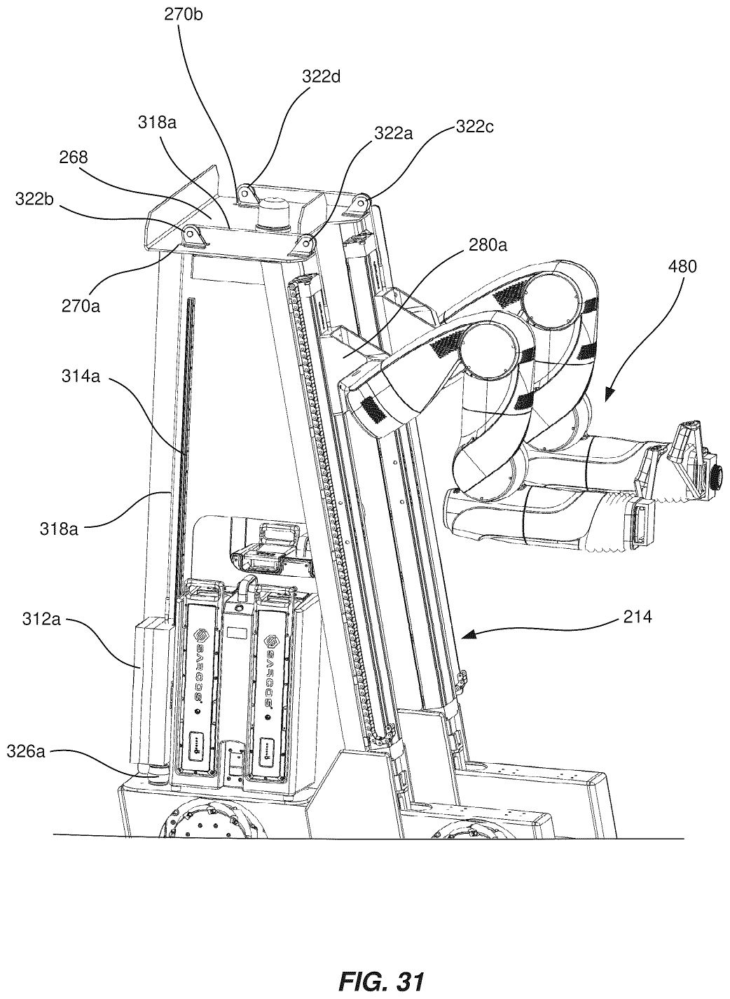

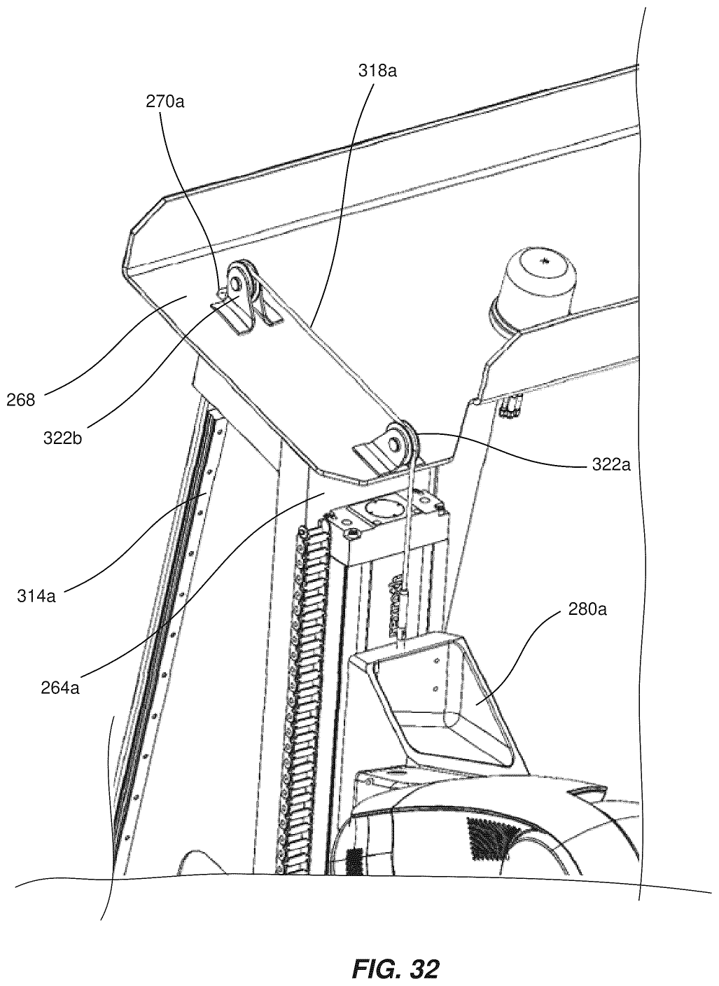

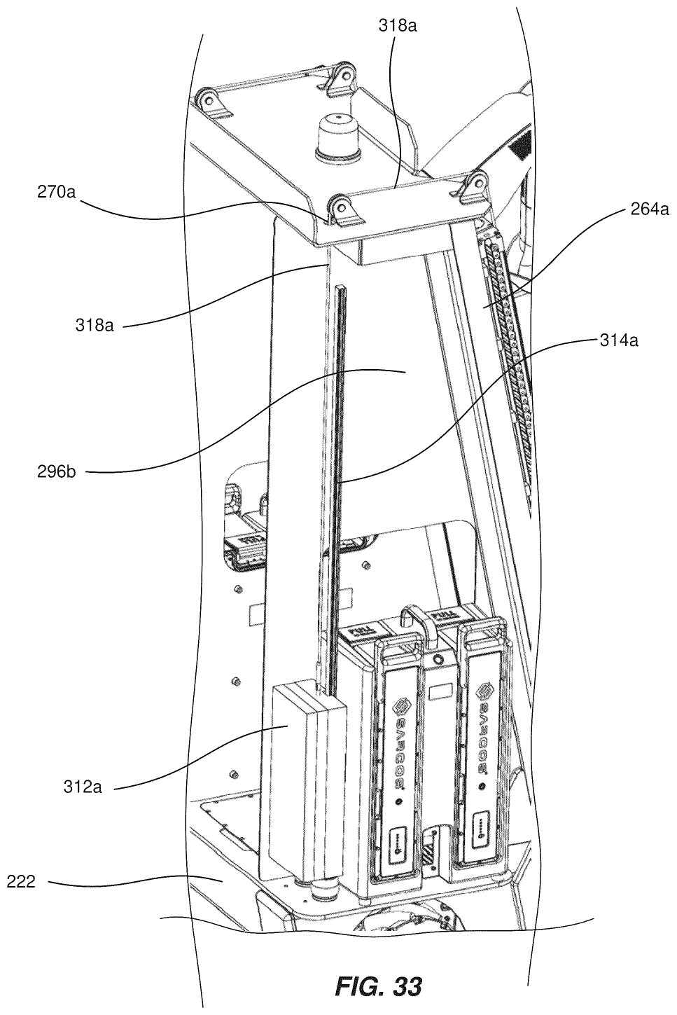

With reference to FIGS. 20-40, illustrated is a walk-about human augmentation system 210 (hereinafter walk-about augmentation system 210 or system 210). This walk-about augmentation system 210 can comprise a walk-about platform 214 comprising a walk-about base 218 and mast in the form of a carrier support assembly 260 supported by the walk-about base 218, wherein the walk-about platform is moveable about a contacting surface (e.g., a ground surface or a ground-like surface). The system 210 can further comprise, and the carrier support assembly 260 (as part of the walk-about platform 214) can be in support of, an upper-body robotic human augmentation system 480, such as comprising one or more robotic arms, operable to interface with an operator to facilitate use by the operator in augmenting the movements and abilities of the operator, and in operating the walk-about system 210. The walk-about system 210 is similar in many respects to the walk-about system 100 discussed above and shown in FIGS. 1-19B. As such, the description of that system is incorporated here in the sense that it discusses certain detail of components, elements, object, systems, etc. that may be applicable to the walk-about system 210 as will be recognized by those skilled in the art, which detail is not repeated for the sake of brevity. For example, various types of sensors that can be utilized and incorporated into a walk-about system are discussed above, with the understanding that they do not need to be discussed in as great detail here.

In one example, the upper-body robotic human augmentation system, having one or more robotic arms, can be in the form of an upper-body exoskeleton type of human augmentation system (e.g., an upper-body exoskeleton that couples to at least a portion of an upper body of the operator (e.g., one that couples to the torso and/or the arms of the operator, or that is donned by the operator)). As an example, the upper-body exoskeleton can be similar to the upper-body exoskeleton described above, and shown in any of FIGS. 1-19B. In another example, the upper-body robotic human augmentation system can comprise one or more robotic arms that are independent of one another, and that are not part of an exoskeleton type of interface system (meaning that the independent robotic arms do not physically couple to the operator), wherein the independent robotic arms each are associated with a human interface (e.g., a human controlled end effector operable with a respective robotic arm) that facilitate operation of the robotic arms, the walk-about platform 214, or both by the operator. In still another example, the upper-body robotic human augmentation system can comprise both an upper-body exoskeleton-type system and configuration that couples, at least in part, to the operator in one or more ways, and a type of end-effector that the operator can interface with to control the robotic arms and the walk-about platform 214 without necessarily being coupled to the coupling system of the exoskeleton. It is noted that in any of these examples, the upper-body robotic human augmentation system can be operated remotely (i.e., can be operated via teleoperation), or autonomously or semi-autonomously via a suitably configured control system and associated computer programming. In any case, the walk-about system 210 allows an operator to move about a ground surface under his/her own power (e.g., walk, stand, squat, etc.) while amplifying the strength of the operator via the upper-body robotic human augmentation system 480.

Although the walk-about platform 214 can be in support of a number of different types of upper-body robotic human augmentation systems, FIGS. 20-40 are directed to and disclose a type of upper-body robotic human augmentation system 480 having first and second robotic arms 484, 488 that are not part of a wearable (i.e., one that is put on or donned) exoskeleton type of system, and that do not couple (do not physically secure (e.g., strap or otherwise secure)) to the operator during use, but that instead support various user input devices, such as user graspable user input devices (i.e., one that a user can grasp and release as needed or desired), that the operator interfaces with to control the first and second robotic arms 484, 488. With respect to the feature and advantage of decoupling of the operator, the operator is decoupled from the upper-body robotic human augmentation system 480 (and the walk-about augmentation system 210 as a whole) as the one or more robotic arms 484, 488 of the upper-body robotic human augmentation system 480 do not couple to any portion of the body (e.g., arms, torso, waist, legs) of the human operator. It is noted that by “decoupled” this does not mean that the operator does not interface with one or more components of the walk-about system 210. Indeed, the operator can interface with one or more components of the walk-about system 210 to control and operate the system 210. For example, as indicated, the walk-about system 210 can comprise, and the user can interact with, one or more user input devices or systems, such as an end effector, a joystick controller, or any other type of user input device or system, or a combination of these, as discussed herein, where the user input devices or systems are part of and supported on the walk-about system 210. Being “decoupled” means that the operator is not physically secured to the walk-about system 210. For instance, the operator is not strapped to the walk-about system 210 via one or more straps; the operator is not wearing or donning any structural members or components of the walk-about system 210; nor is the operator otherwise secured to the walk-about system 210 about the operator's arms, legs, or torso. Rather, the operator can simply approach the walk-about system 210, interact with (e.g., grasp, hold, etc.) one or more user input devices or systems, and operate the walk-about system 210. Thus, it can be said that operation of the walk-about system 210 facilitates selective, unconstrained operator interface with the user input components of the system. With this in mind, the upper-body robotic human augmentation system 480, and particularly the first and second robotic arms 484, 488, does not need to match or even closely conform to the kinematics of the arms of the human operator, although in some examples it can be configured to match or mimic the kinematics of the arms of the operator, or at least partially conform to the kinematics of the operator. Moreover, the complexity of the walk-about platform 214, which operates as a support for the upper-body robotic human augmentation system 480, can be reduced as compared with other lower body human augmentation systems (e.g., lower body exoskeletons, walk-assist systems, rehabilitation systems, and others) that do interface with, and in many cases couple to, the waist and/or legs of a human operator, and that comprise various actuated joints and associated degrees of freedom that resemble or match the kinematics of the lower body of the human operator. As in the example shown, the first and second robotic arms 484, 488 can comprise a plurality of structural segments coupled to one another via a plurality of actuatable joints (e.g., rotational joints). For instance, the first robotic arm 484 can comprise a first segment 490, a second segment 492, a third segment 494, a fourth segment 496, a fifth segment 498, and a sixth segment 500. The first and second segments 490, 492 can be rotatably coupled together via a first rotatable joint 502. The second and third segments 492, 494 can be rotatably coupled together via a second rotatable joint 504. The third and fourth segments 494, 496 can be rotatably coupled together via a third rotatable joint 506. The fourth and fifth segments 496, 498 can be rotatably coupled together via a fourth rotatable joint 508. The fifth and sixth segments 498, 500 can be rotatably coupled together via a fifth rotatable joint 510. The second robotic arm 488 can be configured in the same manner with the same structural segments and joints. All or some of the joints can be associated with one or more actuators and one or more sensors, and can be selectively actuatable and controllable, as is known in the art of robotics.

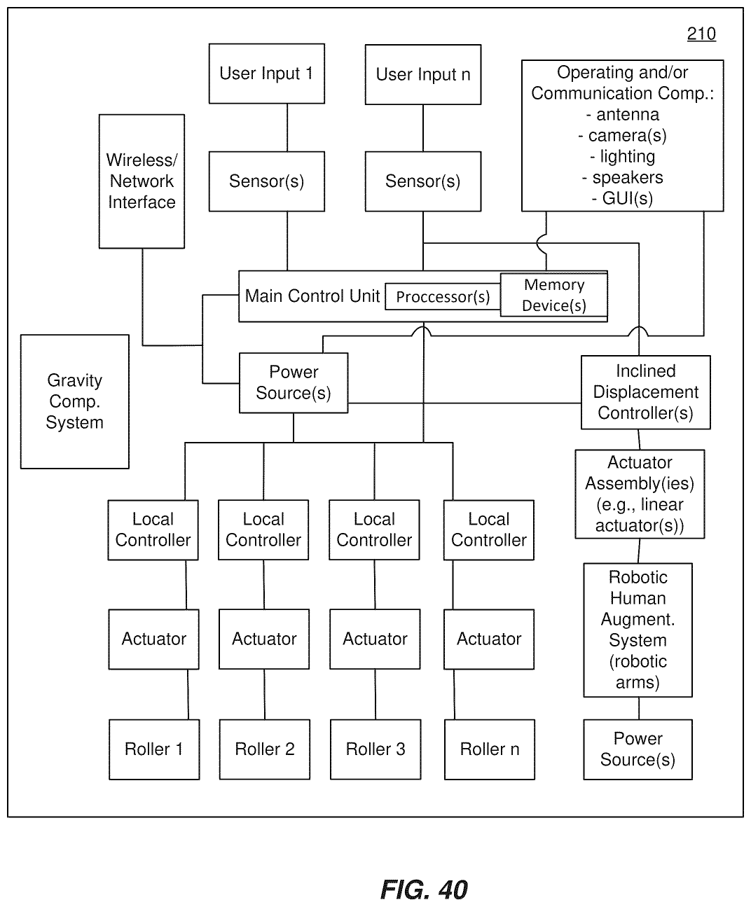

The upper-body robotic human augmentation system 480 can further comprise one or more user/operator input devices supported by first robotic arm 484, and/or one or more user/operator input devices supported by the second robotic arm 488 (see user input devices and associated sensors in communication with the main control unit in FIG. 40). In one example, a user/operator input device can be in the form of an operator end effector 514a (see FIGS. 20-26) supported by the first robotic arm 484. The operator end effector 514a can be configured to facilitate the interface of an operator with the end effector 514a and the upper-body robotic human augmentation system 480 overall. In one aspect, the operator end effector 514a can comprise a handle 516a configured to be releasably grasped by the operator for the purpose of operating and controlling at least one of the first robotic arm 484 of upper-body robotic human augmentation system 480, the walk-about platform 214, or other components of the walk-about system 210. The operator end effector 514a can be coupled to the endmost structural segment (e.g., in this example the sixth structural segment 500 (the forearm segment)) of the first robotic arm 484 via a robotic arm interface, such as via fasteners, a quick connect/disconnect system, or others. Moreover, the upper-body robotic human augmentation system 480 can further comprise one or more sensors (e.g., see sensor 518a in the form of a six degree of freedom load cell), supported between the sixth structural segment 500 and the handle 516a of the operator end effector 514a (e.g., the sensor 518a can be supported on at least one of the first robotic arm 484 or the operator end effector 514a). The sensor 518a can be supported and configured to facilitate control of one or more actuated joints of the first robotic arm 484, the walk-about platform 214 (e.g., the conveyance system operable to facilitate locomotion of the walk-about platform 214), or a combination of these and any other systems or subsystems that can be controlled via the operator end effector 514a. In operation, as the operator manipulates the operator end effector 514a via the handle 516a, the sensor 518a operates to sense the forces or loads induced through corresponding movements of the operator end effector 514a. Based on the forces or loads sensed, the sensor 518a can operate to send associated signals to a control unit for processing and the generation of various operating commands to be sent, thus providing the operator control of the first robotic arm 484 or the walk-about platform 214 or both.

The second robotic arm 488 can comprise a similar setup, namely an operator end effector 514b (see FIGS. 20-26) supported by the second robotic arm 484. The operator end effector 514b can be configured to facilitate the interface of an operator with the end effector 514b and the upper-body robotic human augmentation system 480 overall. In one aspect, the operator end effector 514b can comprise a handle 516b configured to be releasably grasped by the operator for the purpose of operating and controlling at least one of the second robotic arm 488 of upper-body robotic human augmentation system 480, the walk-about platform 214, or other components of the walk-about system 210. The operator end effector 514b can be coupled to the endmost structural segment (e.g., in this example the sixth structural segment (the forearm segment)) of the second robotic arm 488 via a robotic arm interface, such as via fasteners, a quick connect/disconnect system, or others. Moreover, the upper-body robotic human augmentation system 480 can further comprise a sensor 518b, such as a six degree of freedom load cell, supported between the sixth structural segment of the second robotic arm 488 and the handle 516b of the operator end effector 514b (e.g., the sensor 518b can be supported on at least one of the second robotic arm 488 or the operator end effector 514b). The sensor 518b can be supported and configured to facilitate control of one or more actuated joints of the second robotic arm 488, the walk-about platform 214 (e.g., the conveyance system operable to facilitate locomotion of the walk-about platform 214), or a combination of these and any other systems or subsystems that can be controlled via the operator end effector 514b. In operation, as the operator manipulates the operator end effector 514b via the handle 516b, the sensor 518a operates to sense the forces or loads induced through corresponding movements of the operator end effector 514b. Based on the forces or loads sensed, the sensor 518b can operate to send associated signals to a control unit for processing and the generation of various operating commands to be sent, thus providing operator control of the second robotic arm 488 or the walk-about platform 214 or both.

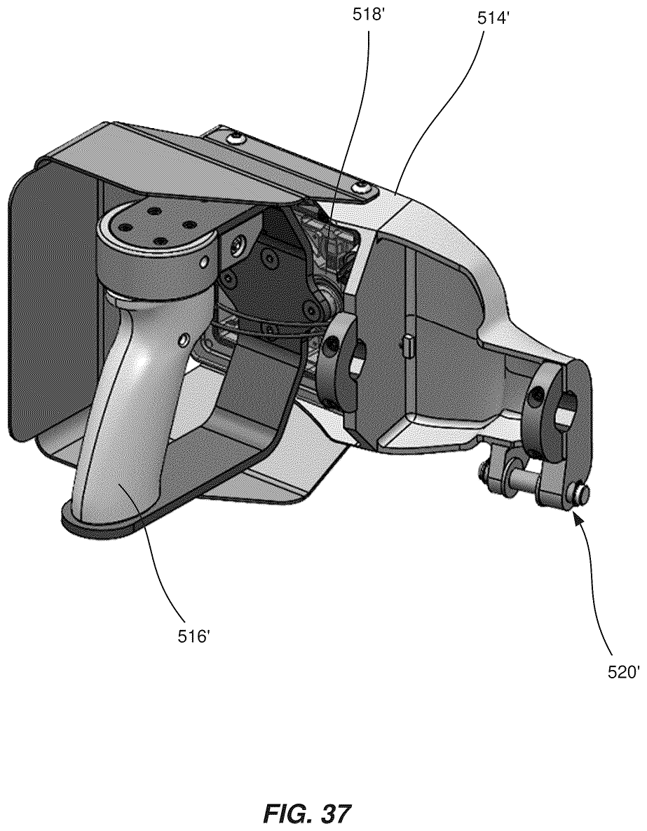

The operator end effectors 514a, 514b, although shown with one configuration, can comprise a number of different configurations and functions. For example, alternative to the first and second operator end effectors 514a, 514b, the upper-body robotic human augmentation system 480 can comprise operator end effectors configured as the operator end effector 514′ shown in FIG. 37, with its handle 516′ and sensor (six degree of freedom load cell) 518′. With any configuration, the operator end effector(s) can further comprise a robotic arm interface operable to physically couple the operator end effector to a robotic arm (e.g., see robotic arm interface in FIG. 37 comprising a mechanical coupling system 520′ operable to releasably couple the operator end effector 514′).

The user/operator input devices discussed herein are not intended to be limiting in any way. Indeed, other user/operator input devices can include, but are not limited to, joysticks, graphical user interfaces (GUIs), and others as will be recognized by those skilled in the art. These can be used to control one or more components, systems, subsystems, communications devices/systems, or a combination of these as found within the walk-about system 210.

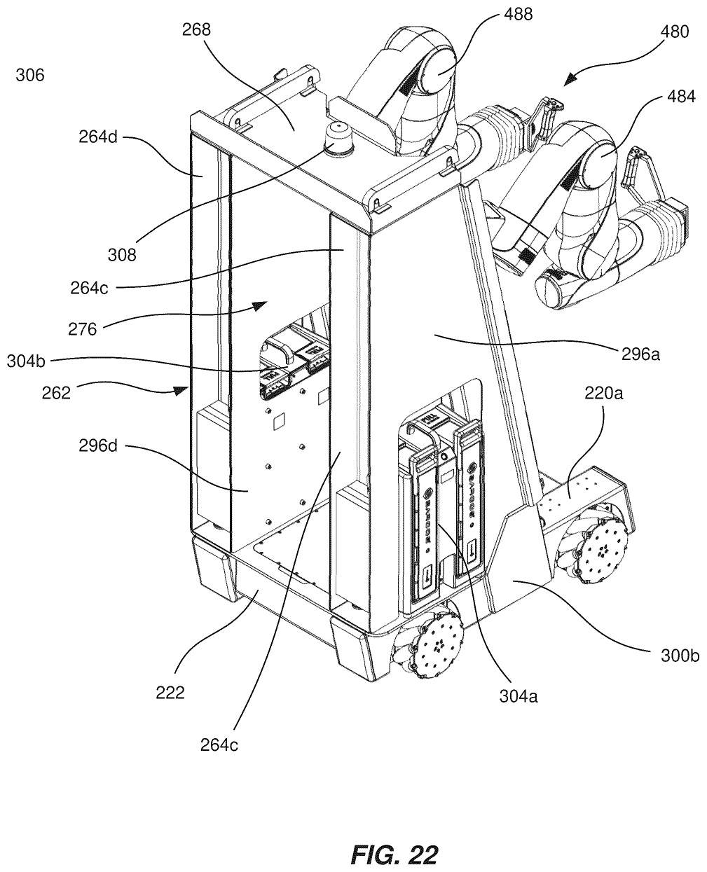

The upper-body robotic human augmentation system 480 can be powered by any power source associated with (e.g., a power grid and connecting power line, one or more power sources on-board the walk-about platform 214, or a combination of these) the walk-about system 210 (see power source(s) in FIG. 40, and in FIGS. 22, 26, and 29). In some examples, the upper-body robotic human augmentation system 480 can comprise its own dedicated power source (see FIG. 40).

The walk-about platform 214 can comprise a walk-about base 218 in support of a mast in the form of the carrier support assembly 260. The walk-about base 218 can comprise any type of structural configuration capable of supporting the carrier support assembly 260, and facilitating movement about a ground surface. In one example, the walk-about base 218 can comprise the same or a similar configuration as the walk-about base discussed above and shown in FIGS. 1-4, including, optionally, any extensible members (e.g., see FIG. 10), deployable forks (e.g., see FIGS. 8A-8C), and/or other features. In another example, as shown here, the walk-about base 218 can comprise a frame or chassis-like structural configuration comprising first and second lateral members 220a, 220b, that are structurally supported by a support bridge 222. The first and second lateral members 220a, 220b can be directly or indirectly coupled to the support bridge 222, depending upon the configuration of the walk-about base 218. In one aspect, the support bridge 222 can be joined directly to and can space apart the first and second lateral members 220a, 220b, and can also provide at least a portion of the supporting structure for the carrier support assembly 260. The support bridge 222 can be located at any position relative to the ground surface, and can comprise any number of different configurations. In one example, the support bridge 222 can span between the first and second lateral members 220a, 220b and located at a rearward position of the walk-about base 218 so as to be behind the legs of the operator when the system 210 is in use, thus reducing the likelihood that the support bridge 222 will interfere with the operator's movements while operating the system 210, such as during a gait cycle or other movements of the operator. Moreover, the support bridge 222 can be located anywhere along a vertical axis relative to the support surface or ground. In the example shown, the support bridge 222 is located close to and above the ground surface, but in other examples, the support bridge 222 could be located at different elevations or heights relative to the ground surface, such as at a midpoint of the carrier support assembly 260, or near the top of the carrier support assembly 260. Moreover, the system 210 can be configured to comprise two or more support bridges. In these examples, the support bridge 222 can be indirectly coupled to the first and second lateral members 220a, 220b via one or more other structural members of the walk-about platform 214, such as one or more structural members of the carrier support assembly 260.

The first and second lateral members 220a, 220b can comprise any configuration (e.g., linear, curved, or a combination of linear and curved segments), can be spaced apart from one another at any lateral distance, and can extend any given length so as to provide stability to the walk-about platform 214. The size, configuration, support locations, and relative offset distance between, the first and second lateral members 220a, 220b can vary, and will largely depend upon the intended use of the system 210, which can include taking into account the types of payloads to be carried or otherwise manipulated by the system 210. Moreover, in one aspect, the first and second lateral members 220a, 220b can be separate structural members that couple to the support bridge 222. In another aspect, the first and second lateral members 220a, 220b can be integrally formed with the support bridge 222. The first and second lateral members 220a, 220b can each be formed of any number of different components. In one example, the first and second lateral members 220a, 220b can be rigid, monolithic members. In another example, the first and second lateral members 220a, 220b can each comprise a plurality of structural components that are coupled together. In one aspect, the plurality of structural components can be made to move relative to one another, such as first and second lateral members 220a, 220b that comprise one or more moveable portions that can be selectively extended or retracted by way of an actuator (e.g., a motor or fluid actuator) to lengthen and shorten the lengths of the first and second lateral members 220a, 220b (similar to the system with the retractable extensions discussed above and shown in FIG. 10).

The walk-about base 218 can further comprise a riding platform 226. Similar to the examples discussed above, in some cases, the operator may desire to ride on the walk-about system 210 instead of walking with the walk-about system 210. To facilitate this, the walk-about base 218 can comprise a riding platform 226 supported by at least one of the first lateral member 220a, the second lateral member 220b, or the support bridge 222 of the walk-about base 218, or parts of the carrier support assembly 260. In one example, as shown, the riding platform 226 can be one or more fixed structures that is/are integrally formed with, or coupled to, the one or more components of the walk-about base 218. In another example, the riding platform 226 can comprise one or more deployable platforms, wherein the riding platform 226 is removable from the walk-about base 218. In still another example, the riding platform 226 can comprise one or more deployable platforms that are moveably coupled to one or more structures of the walk-about base 218 and/or the carrier support assembly 260, wherein the riding platform 226 can be selectively moveable into the bi-pedal locomotion zone 216 from a stowed position to allow the operator to ride on the walk-about platform 104. In this example, the riding platform can be selectively deployed, or in other words, moveable between a riding position and a stowed position. In one aspect, the riding platform can comprise a single moveable or deployable platform. In another aspect, the riding platform can comprise multiple moveable or deployable platforms, such as a right foot platform moveably supported by the first lateral member 220a and a left foot platform moveably supported by the second lateral member 220b. Each of the right and left foot platforms can be operable to selectively move into and out of the bi-pedal locomotion zone 216 such that the operator can selectively ride on or walk with the walk-about system 210. The configuration, mounting, operation and function of the left and right foot platforms operable with the walk-about base 218 can be the same or similar to the right and left foot platforms discussed above and shown in FIGS. 12-15. As such, these will not be discussed in further detail here.

The walk-about base 218 can be configured such that the bi-pedal locomotion zone 216 extends both forward and rearward of the sloped vertical degree of freedom defined by the carrier support assembly 260. As such, the bi-pedal locomotion zone 216 can be configured to extend rearward, to some extent, of the upper-body robotic human augmentation system 480. As such, the riding platform 226 can also extend forward and rearward of this degree of freedom, and rearward of the upper-body robotic human augmentation system 480. In the example shown, the sloped degree of freedom is defined by the first and second support columns 264a, 264b of the framework 262 of the carrier support assembly 260, as well as the first and second actuator assemblies 284a, 284b coupled to the first and second support columns 264a, 264b, these being discussed below. In this configuration, the riding platform 286 and the bi-pedal locomotion zone 216 can extend rearward and forward of the coupling location of the upper-body robotic human augmentation system 480 to the carrier support assembly 260 by way of the first and second arm mount brackets 280a, 280b. Configuring the walk-about platform 214 to comprise the bi-pedal locomotion zone 216 that extends rearward of the sloped vertical degree of freedom and rearward of the upper-body robotic human augmentation system 480 facilitates room for the operator to move and maneuver during operation of the walk-about system 210.

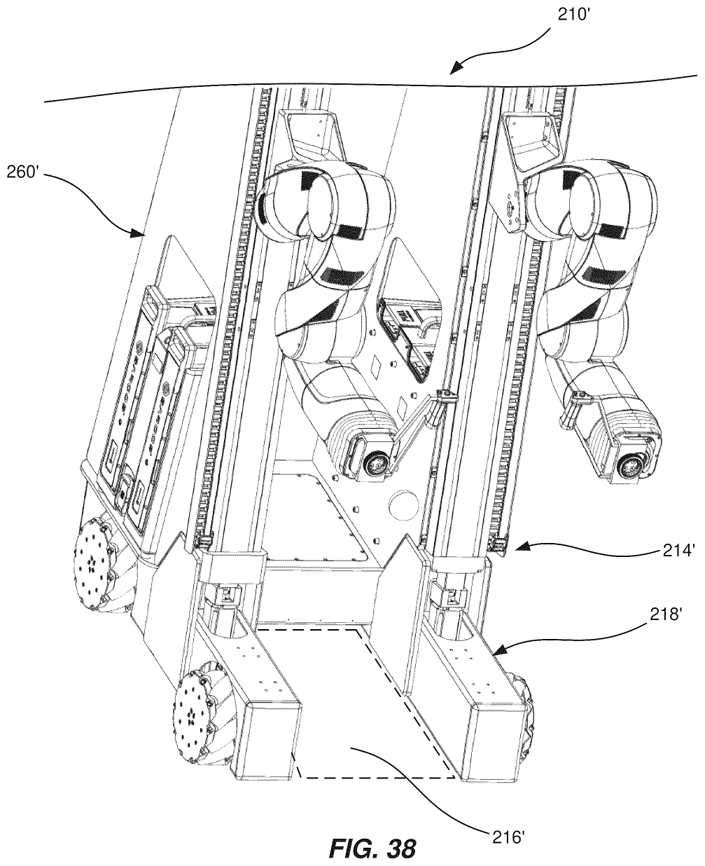

In another example, the walk-about base can be configured without a riding platform. For example, FIG. 38 illustrates a walk-about system 210′ comprising a walk-about platform 214′ comprising a walk-about base 218′ in support of a carrier support assembly 260′, which walk-about system 210′ is identical to the walk-about system 210 discussed herein, except that the walk-about system 210′ does not comprise a riding platform. In this example, the bi-pedal locomotion zone 216′ extends all the way to the ground surface.

The walk-about platform 214, and particularly the walk-about base 218, can further comprise a conveyance system 230 that is operable in connection with a main control unit (see main control unit in FIG. 40) to facilitate movement and locomotion of the walk-about platform 214 about a ground surface, which conveyance system 230 can be operable to receive commands in response to various inputs to enable operation of the conveyance system 230, such as inputs from a local or on-board operator through a human interface device or system (e.g., an end-effector), a remote teleoperator, or via autonomous commands received from the main control unit via one or more sensors. The conveyance system 230 can comprise one or more types of ground-contacting elements supported by the walk-about base 218, and respective local controllers that are associated with these and respective actuators, wherein the local controllers are in communication with the main control unit. As in the example shown, the walk-about platform 214 can comprise ground-contacting elements that are a type of roller. The rollers can be any suitable type and configuration facilitating movement of the walk-about platform 214 about the ground surface. In one example, as shown, each of the first and second lateral members 220a, 220b can be in support of front rollers (e.g., see front roller 234a supported by the first lateral member 220a, and front roller 234b supported by the second lateral member 220b) and rear rollers (e.g., see rear roller 236a supported by the first lateral member 220a, and rear roller 236b supported by the second lateral member 220b). For purposes of this description, front indicates the direction the operator faces while operating the system 210, and rear indicates the direction opposite this. The front and rear rollers can be in the form of a wheel, which can be actively or passively driven. Indeed, with respect to actuation, different operating scenarios are contemplated. For example, in one scenario, each of the front and rear rollers can be actively driven by one or more actuators (e.g., see actuators associated with respective rollers in FIG. 40) as controlled by the main control unit and a respective local controller (see local controllers associated with respective rollers in FIG. 40) to move the walk-about platform 214 (and the entire system 210) about the ground surface (e.g., similar to that as shown in FIG. 7 and discussed above). In another scenario, either the front rollers or the rear rollers can be actively driven by one or more actuators, while the other of the front rollers or the rear rollers can be non-actuated or passively driven (i.e., are not actuated and actively driven, but instead roll freely). In still another scenario, all of the rollers can be non-actuated and passively driven, with the walk-about platform 214 being configured to be moved about the ground surface under the influence of the operator or via another external force acting on the system 210. In other examples, instead of the conveyance system 230 comprising front and rear rollers supported on each of the first and second lateral members 220a, 220b, the walk-about platform 214, and particularly the conveyance system 230, can comprise endless track-type rollers, such as a first roller or endless track supported by the first lateral member 220a, and a second roller or endless track supported by the second lateral member 220b (e.g., similar to the first and second endless tracks shown in FIG. 11). As with the wheel type of rollers, the endless tracks can be actively driven via one or more actuators. The rollers can comprise a variety of different types of wheels, endless tracks, or a combination of these. In one aspect, the wheels can comprise omnidirectional wheels, and the endless tracks can comprise omnidirectional tracks. However, this is not intended to be limiting in any way. The conveyance system 230 can comprise similar components, can be configured in a similar manner, and can function in a similar manner as discussed above with respect to the walk-about human augmentation system of FIGS. 1-4, which disclosure and discussion is incorporated here.

The first and second lateral members 220a, 220b and support bridge 222 of the walk-about base 218 can define, at least in part, a bi-pedal locomotion zone 216. The bi-pedal locomotion zone 216 can comprise a space between the first and second lateral members 220a, 220b (and also between the one or more rollers on each side of the walk-about base 218) and in front of the support bridge 222 within which an operator operating the system 210 can walk, run, squat, turn, or otherwise move about the ground surface while operating the walk-about augmentation system 210, and particularly the upper-body robotic human augmentation system 480. Thus, while the operator is interfacing with the upper-body robotic human augmentation system 480, the operator is positioned within the bi-pedal locomotion zone 216 and about the ground surface (or about a riding platform as discussed herein).

The walk-about base 218 can further comprise one or more bumpers supported on the first and second lateral members 220a, 220b, the support bridge 222, or a combination of these. The bumpers can be configured to provide impact protection to the walk-about bas 218. In the example shown, the first and second lateral members 220a, 220b each comprise a front bumper 224a and a rear bumper 224b supported on their respective first and second ends. The bumpers can be formed of any suitable material or collection of materials capable of providing impact protection (absorbing kinetic energy), such as rubbers, metals, plastics, and combinations of these.

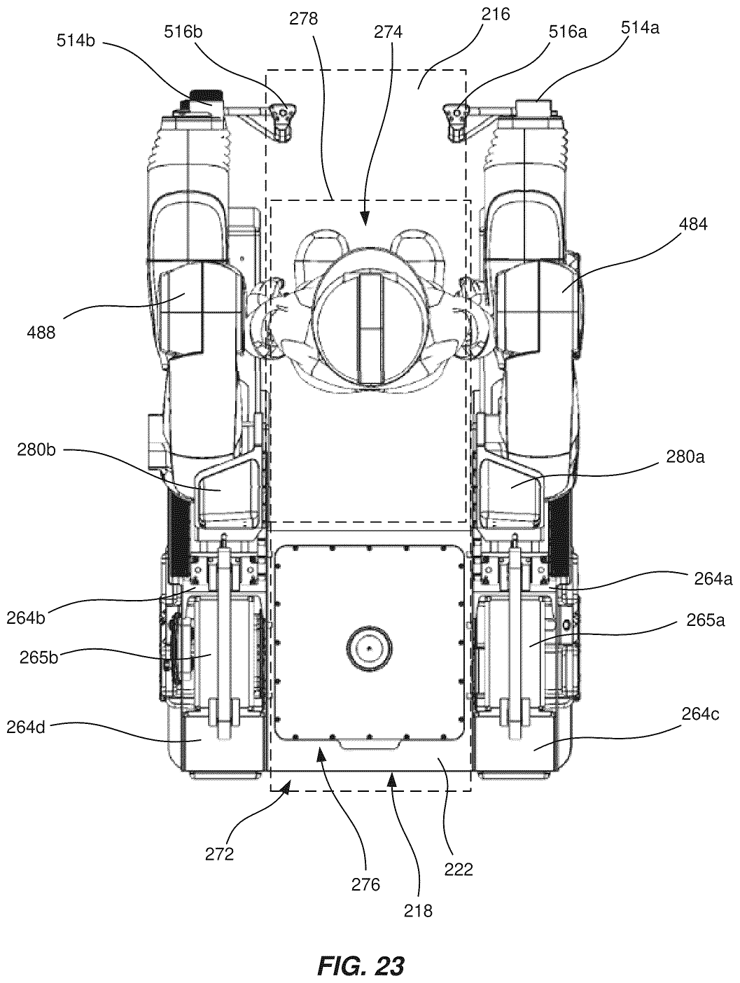

The walk-about platform 214 can further comprise the mast in the form of the carrier support assembly 260 supported by the walk-about base 218, and which operates to support the upper-body robotic human augmentation system 480, as well as to facilitate the interface of an operator with the walk-about system 210 as decoupled from the walk-about system 210. With this configuration, the operator is also free to move within the operator pass-through channel or corridor 270, described herein, as well as within the bi-pedal locomotion zone 216, which can be part of or adjacent the operator pass-through channel 272 (see FIGS. 23-25). Indeed, the operator can enter/exit the operator pass-through channel 272, and into the bi-pedal locomotion zone 216, from the front or the back of the walk-about system 210, and can also move within the operator pass-through channel 272 relative to the walk-about system 210 due to the operator being decoupled from and unconstrained by the system 210. This is different than prior related systems and devices that have one or more components that physically couple to and constrain the movements of the operator or user during use, and also from prior systems having a structural configuration that only permit the operator to enter a respective bi-pedal locomotion zone from a single direction and side of the system.

The carrier support assembly 260 can comprise any structural configuration capable of supporting the upper body robotic human augmentation system 480, and enabling the intended features and functions of the walk-about system 210 as described herein. In one example, as shown, the carrier support assembly 260 can comprise a framework 262 of one or more structural supports or columns supported by and extending upward from the walk-about base 218. The framework 262, with its one or more structural supports or columns, can be referred to as a mast. The framework 262 can be formed of any suitable material or combination of materials (e.g., metal, metal alloys, carbon fiber, or a combination of these) capable of providing the necessary support for the walk-about system 210.

The framework 262 can comprise a first structural support column 264a supported by and extending upward from the walk-about base 218. The first support column 264a can comprise a working surface 266a operable to support the first robotic arm 484 of the upper-body robotic human augmentation system 480, and to facilitate the inclined displacement of the first robotic arm 484, as explained in more detail below. In one example, the working surface 266a can be oriented on an incline relative to a normal axis of the ground surface, as well as on an incline relative to a vertical axis extending through the walk-about system 210. The inclined orientation of the working surface 266a can be achieved by supporting the first support column 264a on an incline so as to place the working surface 266a on an incline, or by configuring or forming the first support column 264a to inherently comprise the inclined working surface 266a. In another example, the working surface can be oriented along an axis normal to the ground surface (i.e., the working surface 266a is not oriented on an incline). In this case, the actuator assembly, discussed below, coupling the first robotic arm 484 to the first support column 264a can be supported by the working surface 266a to be on an incline, thus facilitating the inclined displacement of the first robotic arm 484. The first support column 264a, the working surface 266a and the actuator assembly supported thereon can be configured in a number of different ways to facilitate the inclined, bi-directional displacement of the first robotic arm 484 of the upper-body robotic human augmentation system 480 within a given range of motion. In the example shown, the working surface 266a and the actuator assembly 284a are oriented on a negative incline (i.e., they comprise a negative slope) when viewed from the side view shown in FIG. 26.

The carrier support assembly 260, and particularly the framework 262, can further comprise a second structural support column 264b supported by and extending upward from the walk-about base 218. Similar to the first support column 264a, the second support column 264b can comprise a working surface 266b operable to support the second robotic arm 488 of the upper-body robotic human augmentation system 480, and to facilitate the inclined displacement of the second robotic arm 488, as explained in more detail below. The second structural support column 264b with its working surface 266b can be configured in the same or a similar manner as the first structural support column 264a, and can be operable with an actuator assembly in a similar manner so as to facilitate the inclined, bi-directional displacement of the second robotic arm 488 of the upper-body robotic human augmentation system 480 within a given range of motion. In the example shown, the working surfaces 266a, 266b and the actuator assemblies 284a, 284b are oriented on a negative incline (i.e., they comprise a negative slope) when viewing the walk-about system 210 from the side as shown in FIG. 26.

The framework 262 can further comprise other support columns, such as third support column 264c, and fourth support column 264d (or any number of support columns) that are located rearward of the first and second structural support columns 264a, 264b (the rear of the walk-about platform 214 being behind the upper-body robotic human augmentation system 480, and facing in opposite direction than the front of the walk-about platform 214). A first upper brace 265a can be supported between the first and third structural support columns 264a, 264c, and a second upper brace 265b can be supported between the second and fourth structural support columns 264b, 264d. The first, second, third, and fourth structural support columns 264a-d, respectively, can operate to provide structural support within the walk-about platform 214 above the walk-about base 218 and for many of the various components that are supported on-board the walk-about platform 214. Indeed, the framework 262 can provide support for the upper-body-robotic human augmentation system 480, one or more power sources, networking components, communication components, computer components, sensors and sensor components, lighting, control systems and associated components, and any other components that may be needed or desired to operate the walk-about system 210. The first, second, third, and fourth support columns 264a-d can comprise separate and distinct structural components that are supported by the walk-about base 218 at different locations, as shown. Each of these can be separated or spaced apart from one another, such as to define, at least in part, the pass-through channel 272.

Alternatively, the framework 262 can comprise a first structural support column 264a and a second structural support column 264b that are supported by and that extend upward from opposing sides of the walk-about base 218, and that each comprise a respective working surface 266a, 266b. These can be sized and configured to extend along respective sides of the walk-about base 218, such as along the respective sides between a front and rear of the walk-about base 218. In this manner, the framework 262 would not comprise separate and distinct third and fourth support columns, such as support columns 264c and 264d shown. Rather, in this example, the first and second support columns 264a and 264b can each be sized and configured to comprise an extended wall or wall-like structure having an extended length, so as to provide the support needed within the walk-about platform 214 as positioned along each side of the walk-about base 218. The first and second support columns 264a, 264b can be spaced apart from one another to define, at least in part, the pass-through channel 272.

As indicted, the framework 262, with its first, second, third, and fourth structural support columns 264a-d, respectively, can further operate to define, along with a portion of the walk-about base 218, the operator pass-through channel 272. The structural support columns making up the framework 262 can be spaced apart from one another so as to create a gap therebetween along a lateral axis of the walk-about platform 214, as well as to define openings at the front and rear of the walk-about platform 214 (see front opening 274 and rear opening 276) that are sufficiently sized so that an operator can pass through them and the pass-through channel to enter/exit the bi-pedal locomotion zone 216. The support columns can define, at least in part, the sides and width of the pass-through channel 272. In one example, the walk-about base 218 can comprise one or more structural spanning members (e.g., one or more braces, the support bridge 222, etc.) that span(s) the gap or distance between the first and second lateral members 220a, 220b of the walk-about base 218 along the lateral axis of the walk-about base 218. In this example, the operator may be required and permitted to walk on these spanning member(s) when passing through either the front or rear openings 274, 276, respectively, of the walk-about platform 214 and the pass-through channel 272 to enter/exit the bi-pedal locomotion zone 216. In this example, the spanning member(s) can comprise the lower part of the pass-through channel 272. In another example, the walk-about base 218 can comprise first and second structural portions (e.g., the lateral members 220a, 220b, the spanning members, or both of these) that are sized and configured to define an open channel between them, and therefore to permit an operator to walk on the ground surface through the open channel, which open channel can be part of the pass-through channel 272. In this example, the ground surface can define the lower part of the pass-through channel 272. The framework 262 of the walk-about platform 214 can further comprise one or more bridging members that extend between and connect a portion of the support columns that are positioned on opposing sides of the walk-about platform 214. In one example, as shown, the framework 262 can comprise an upper bridging member 268 that spans between and interfaces with (joins, connects, integrally forms with) upper portions of the support columns on opposing sides of the walk-about base 218. The upper bridging member 268 (or any other bridging member types located in different locations) can provide a stabilizing function to the framework 262 and the walk-about platform 214 as a whole, by interconnecting the one or more support columns on each of the opposing sides of the walk-about base 218. In addition, the upper bridging member 268 can further define an upper part of the pass-through channel 272. In essence, the framework 262 (with its structural support columns, and any bridging members) and the walk-about base 218 can define the front and rear openings 274, 276 of the walk-about platform 214, the size, and an envelope boundary 278 of the pass-through channel 272, with the envelope boundary 278 defining the planar edges or boundaries of the pass-through channel 272. Of course, those skilled in the art will recognize that the walk-about platform 214, with its walk-about base 218 and its carrier support assembly 260 can comprise a variety of different configurations, and thus a variety of different pass-through channel and resulting envelope boundary configurations.

It is noted that the pass-through channel 272 and the front and rear openings 274, 276 of the walk-about platform 214 can be defined by the structural components of the carrier support assembly 260 and the walk-about base 218 of the walk-about platform 214. As such, it should be recognized that the pass-through channel 272, with its envelope boundary 278, can be considered to extend beyond the carrier support assembly 260, and particularly beyond the framework 262, towards and beyond the one or more robotic arms of the upper-body robotic human augmentation system 480. For instance, in the example shown, the pass-through channel 272 can be considered to terminate at the front ends of the first and second lateral members 220a, 220b of the walk-about base 218, with the envelope boundary 278 extending upward and rearward from there. As such, the front opening 274, of the walk-about platform 214 can be considered to be at the front edges of the first and second lateral members 220a, 220b. In this example, the pass-through channel 272 can extend from the front or forward ends of the first and second lateral members 220a, 220b to the rearmost portions of the carrier support assembly 260 (e.g., the rearmost portions of the framework 262) and the walk-about base 218.

The pass-through channel 272 facilitates the operator to pass through the front and/or rear openings 274, 276 in the walk-about platform 214 that are defined by the walk-about base 218 and the framework 262, to enter into and/or to exit from the bi-pedal locomotion zone 216. Depending upon how the pass-through channel 272 is defined and where its envelope boundary 278 is considered to extend, in one aspect with the front opening 274 of the walk-about platform 214 being at the forwardmost portions of the framework 262 of the carrier support assembly 260 behind the upper-body robotic human augmentation system 480, the operator can enter into the bi-pedal locomotion zone 216 from the front of the walk-about system 210 without passing through the pass-through channel 272. From here, the operator can exit the bi-pedal locomotion zone 216 from the direction entered, or the operator can exit the bi-pedal locomotion zone 216 through the front opening 274, pass through the pass-through channel 272, and then exit the walk-about system 210 through the rear opening 276 of the walk-about platform 214. In another aspect, with the front opening 274 considered to be at the front ends of the first and second lateral members 220a, 220b, the operator can enter the pass-through channel 272 and the bi-pedal locomotion zone 216 upon passing through the front opening 274. In this example, the pass-through channel 272 and the bi-pedal locomotion zone 216 can overlap. In either scenario, the pass-through channel 272 can be in communication with the bi-pedal locomotion zone 216, meaning that the bi-pedal locomotion zone 216 is directly accessible by the operator from the pass-through channel 272, and in some examples, can be part of or an extension of the pass-through channel 272. Depending upon the configuration of the walk-about base 218, the operator may need to walk on one or more structural elements (e.g., an upper surface) of the walk-about base 218 while passing through the pass-through channel 272. Of course, the example configuration of the walk-about platform 214 shown is just one example, which is not intended to be limiting in any way.

The carrier support assembly 260 can further comprise a structural robotic arm interface that moveably couples the one or more robotic arms to a respective support column, and more particularly to a respective actuator supported by the respective support column, and operable with the one or more robotic arms. The robotic arm interface can comprise a number of different types and/or configurations. In one example, as shown, the robotic arm interface can comprise an arm mount bracket 280a operable with the first support column 264a, and operable to provide, at least in part, a structural interface that facilitates support of the upper-body robotic human augmentation system 480 by and about the first support column 264a. As will be discussed in more detail below, the arm mount bracket 280a can comprise an actuator interface that facilitates the slidable interface of the arm mount bracket 280a with the actuator assembly supported on the first support column 264a, such that the arm mount bracket 280a is slidable relative to the first support column 264a. The arm mount bracket 280a functions as the mounting hardware for the first robotic arm 484 of the upper-body robotic human augmentation system 480, such that the first robotic arm 484 is also moveable (e.g., slidable) relative to the first support column 264a. The first robotic arm 484 can be coupled to the arm mount bracket 280a in any manner, such as via fasteners, a quick connect/disconnect system, or others as will be apparent to those skilled in the art.

The carrier support assembly 260 can further comprise an arm mount bracket 280b operable with the second support column 264b, and operable to provide, at least in part, a structural interface that facilitates support of the upper-body robotic human augmentation system 480 by and about the second support column 264b. The arm mount bracket 280b can also comprise an actuator interface that facilitates the slidable interface of the arm mount bracket 280b with the actuator assembly supported on the second support column 264b, such that the arm mount bracket 280b is slidable relative to the second support column 264b. The arm mount bracket 280b functions as the mounting hardware for the second robotic arm 488 of the upper-body robotic human augmentation system 480, such that the second robotic arm 488 is also moveable relative to the second support column 264b.

The carrier support assembly 260 can further comprise an actuator assembly 284a (a first actuator assembly in the event there are two or more of such assemblies) supported on or by or about the first support column 264a, and particularly the working surface 266a of the first support column 264a. In this example, the working surface 266a of the first support column 264a is oriented on an incline relative to an axis normal to the ground surface, and as such the actuator assembly 284a is supported on the same incline. The actuator assembly 284a can be configured and operable to interface with the arm mount bracket 280a, and to effectuate the bi-directional movement or displacement (in this case sloped or inclined sliding displacement) of the arm mount bracket 280a, and the first robotic arm 484 coupled thereto, within a range of motion along the first support column 264a and relative to the first support column 264a. The actuator assembly 284a can comprise an actuator 286a that drives the movement of the arm mount bracket 280a (e.g., via a motor, a fluid (e.g., hydraulic or pneumatic actuator), as well as the mounting hardware associated with mounting the actuator 286a, and the actuator assembly 284a as a whole, to the first support column 264a. The actuator assembly 284a can further comprise interfacing hardware operable to interface with and support the arm mount bracket 280a, such that the arm mount bracket 280a is moveably supported by the actuator assembly 284a on, and moves relative to, the first support column 264a. The actuator assembly 284a can further comprise a guide member 288a, such as a guide rail or guide rod, that interfaces with the arm mount bracket 280a to guide the arm mount bracket 280a (and the first robotic arm 484 coupled thereto) to travel in a path (e.g., a linear path, a curved path, or a combination of these) within its range of motion. This can be part of the overall actuator design (e.g., a ball screw actuator), or a separate structure. The actuator 286a of the actuator assembly 284a can be operated to cause the arm mount bracket 280a, and thus the first robotic arm 484, to move in a bi-directional manner along and relative to the first support column 264a in a sloped or inclined manner. In one example, as shown, the actuator assembly 284 can be configured to facilitate linear inclined displacement of the arm mount bracket 280a (and the first robotic arm 484), and the actuator 286a can comprise a linear actuator, wherein the inclined displacement of the arm mount bracket 280a and the first robotic arm 484 is along a constant angle of descent and ascent. Of course, a specific type of linear actuator is not meant to be limiting in any way. Indeed, there are a variety of different types of actuators that produce linear motion that can be used to effectuate linear movement of the arm mount bracket 280a and the first robotic arm 484. For example, actuators that can be used include, but are not limited to, hydraulic actuators, pneumatic actuators, rack and pinion actuators, ball screw actuators, lead screw actuators, rotary to linear actuators, belt driven actuators, electric linear actuators, and others. In the example shown, the actuator assembly 284a comprises a type of actuator in the form of a ball screw actuator driven by a motor 290a, but this is not intended to be limiting in any way. In another example, the actuator assembly 284 can be configured to facilitate curved displacement of the arm mount bracket 280a (and the first robotic arm 484), wherein the curved displacement is such that the arm mount bracket 280a (and the first robotic arm 484) are considered to still traverse along a sloped or inclined path, such that the inclined displacement of these is along a constant angle of descent and ascent. For example, the curve and degree of curvature provided by the actuator assembly 284a (i.e., the curvature of the guide member 288a (e.g., the guide rail)) can be slight (e.g., one having a radius of 5-20 feet or more, basically any radius of curvature). In this example, the actuator 286a can comprise any type of actuator capable of driving the arm mount bracket 280a along a curved path. In this example, the first support column 264a, and particularly its working surface 266a, can also be formed to comprise a curve.

The carrier support assembly 260 can further comprise a second actuator assembly 284b (in the even there are two or more of such assemblies) supported on or by or about the second support column 264b, and particularly the working surface 266b of the second support column 264b. In this example, the working surface 266b of the second support column 264b is oriented on an incline relative to an axis normal to the ground surface, and as such the second actuator assembly 284b is supported on the same incline. The second actuator assembly 284b can be configured and operable to interface with the second arm mount bracket 280b, and to effectuate the bi-directional movement or displacement (in this case sloped or inclined sliding displacement) of the second arm mount bracket 280b, and the second robotic arm 488 coupled thereto, within a range of motion along the second support column 264b and relative to the second support column 264b. The actuator assembly 284b can comprise an actuator 286b that drives the movement of the second arm mount bracket 280b, as well as the mounting hardware associated with mounting the actuator 286b, and the second actuator assembly 284b as a whole, to the second support column 264b. The second actuator assembly 284b can further comprise interfacing hardware operable to interface with and support the second arm mount bracket 280b, such that the second arm mount bracket 280b is moveably supported by the second actuator assembly 284b on, and moves relative to, the second support column 264b. The second actuator assembly 284b can further comprise a guide member 288b, such as a guide rail or guide rod, that interfaces with the second arm mount bracket 280b to guide the second arm mount bracket 280b (and the second robotic arm 488 coupled thereto) to travel in a path (e.g., a linear path, a curved path, or a combination of these) within its range of motion. The actuator 286b of the second actuator assembly 284b can be operated to cause the second arm mount bracket 280b, and thus the second robotic arm 488, to move in a bi-directional manner along and relative to the second support column 264b in a sloped or inclined manner. In one example, as shown, the second actuator assembly 284b can be configured to facilitate linear displacement of the second arm mount bracket 280b (and the second first robotic arm 488), and the actuator 286b can comprise a linear actuator. Of course, a specific type of linear actuator is not meant to be limiting in any way. Indeed, there are a variety of different types of actuators that produce linear motion that can be used to effectuate linear movement of the second arm mount bracket 280b and the second robotic arm 488. In another example, the second actuator assembly 284b can be configured to facilitate curved displacement of the second arm mount bracket 280b (and the second robotic arm 488), wherein the curved displacement is such that the second arm mount bracket 280b (and the second robotic arm 488) are considered to still traverse along a sloped or inclined path. For example, the curve and degree of curvature provided by the second actuator assembly 284b (i.e., the curvature of the second guide member 288b (e.g., the guide rail)) can be slight (e.g., one having a radius of 5-20 feet or more, basically any radius of curvature). In this example, the second actuator 286b can comprise any type of actuator capable of driving the second arm mount bracket 280b along a curved path. In this example, the second support column 264b, and particularly its working surface 266b, can also be formed to comprise a curve. Essentially, the second actuator assembly 284b can be configured the same as, and thus can function the same as, the first actuator assembly 284a. Alternatively, the second actuator assembly 284b can comprise a different configuration, depending upon the intended usage of the walk-about system 210.

The arm mount bracket 280a (first arm mount bracket) and the first robotic arm 484 coupled thereto can be movable in a bi-directional manner about the first support column 264a in a single, actuated linear degree of freedom via the actuator assembly 284a, meaning that these can be actuated to linearly displace along a linear axis (see inclined or sloped vertical axis A in FIG. 26). However, due to the first actuator assembly 284a being supported about the first support column 264a on an incline (e.g., see the incline angle α in FIG. 26, as measured from the axis N normal to the ground surface), linear displacement of the arm mount bracket 280a and the first robotic arm 484 in the single actuated degree of freedom along the inclined or sloped vertical axis A results in movement of the first robotic arm 484 in a sloped vertical degree of freedom, and specifically in two spatial degrees of freedom, namely along the X and Z axes (see X and Z axes in FIG. 26). More specifically, as the first actuator assembly 284a is actuated to displace the arm mount bracket 280a and the first robotic arm 484, these move along the sloped vertical axis A in the sloped vertical degree of freedom. In doing so, due to the inclination of the actuator assembly as supported on the inclined working surface 266a of the first support column 264a, the arm mount bracket 280a and the first robotic arm 484 as coupled thereto move along an incline or slope (a sloped vertical axis), namely simultaneously along the vertical Z axis and the horizontal X axis. In operation (referring to the walk-about system 210 as shown in FIG. 26 for reference), with the first actuator assembly 284a being actuated to cause the arm mount bracket 280a and the first robotic arm 484 to move upward along the sloped vertical axis A, this advantageously allows the arm mount bracket 280a and the first robotic arm 484 to move vertically up along the Z axis (movement in a first spatial degree of freedom) and horizontally to the left or rearward towards the reference plane RP along the X axis (movement in a second spatial degree of freedom). Likewise, with the first actuator assembly 284a being actuated to cause the arm mount bracket 280a and the first robotic arm 484 to move in the opposite direction downward along the sloped vertical axis A, this advantageously allows the arm mount bracket 280a and the first robotic arm 484 to move vertically down along the Z axis (movement in a first spatial degree of freedom) and horizontally to the right or forward, away from the reference plane RP, along the X axis (movement in a second spatial degree of freedom).

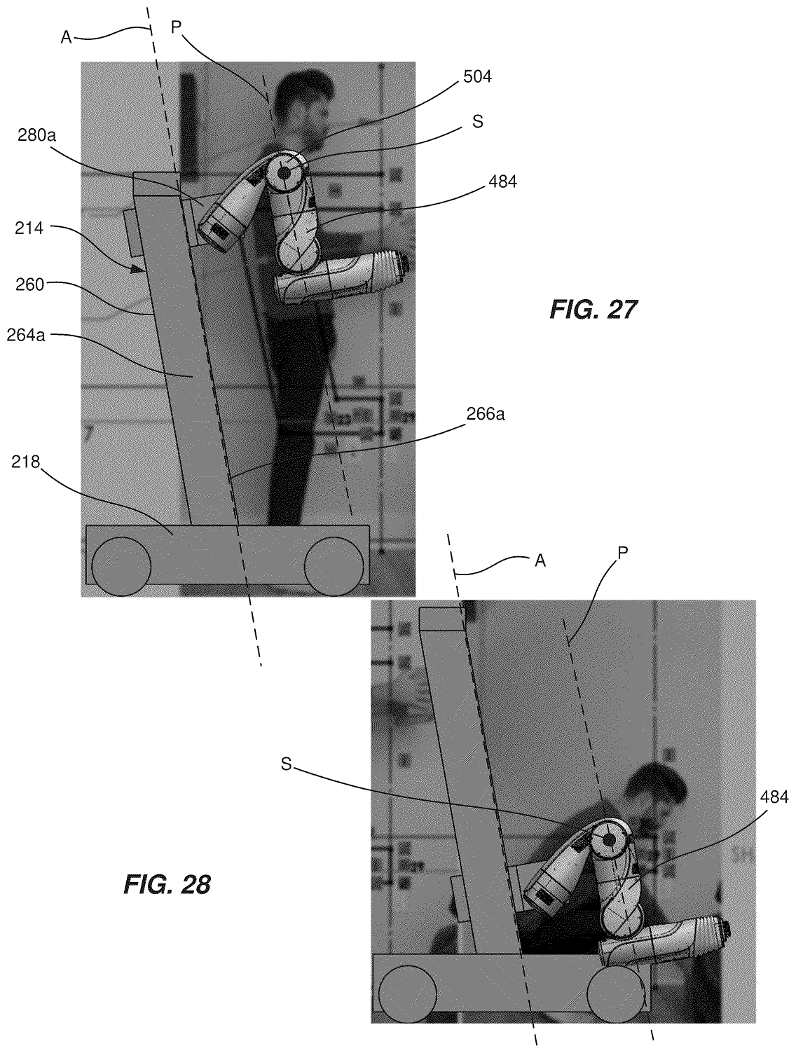

Depending upon the configuration of the walk-about platform 214, the first actuator assembly 284a can be supported at different angles of inclination (represented by the incline angle α of the sloped vertical axis A shown in FIG. 26). Thus, it can also be said that the working surface 266a of the first support column 264a can also comprise different angles of inclination. Thus, the sloped vertical axis A (the sloped vertical degree of freedom provided) can be formed on different angles or inclines. As such, the inclined path that the arm mount bracket 280a and the first robotic arm 484 travel in the sloped vertical degree of freedom (along the sloped vertical axis A) as coupled thereto, can be different depending upon the configuration of the walk-about platform 214. In the example shown, the angle of inclination of the first actuator assembly 284a (and the working surface 266a of the first support column 264a), and thus the inclined path of travel of the arm mount bracket 280a and the first robotic arm 484, and thus the sloped vertical axis A, is 10 degrees. However, this is not intended to be limiting in any way. Indeed, the sloped vertical axis A, and thus the angle of inclination of the first actuator assembly 284a, and the associated inclined path of travel of the arm mount bracket 280a and the first robotic arm 484, can be one of between 5 and 35 degrees in some examples, between 5 and 30 degrees in some examples, between 5 and 25 degrees in some examples, between 5 and 20 degrees in some examples, between 5 and 15 degrees in some examples, between 6 and 14 degrees in some examples, between 7 and 13 degrees in some examples, between 8 and 12 degrees in some examples, between 9 and 11 degrees in some examples as measured from an axis normal to the ground surface. In this configuration, the walk-about platform 214, namely the working surface 266a of the first support column 264a, can be configured to position and orient the first actuator assembly 284a on an angle of inclination, such that the arm mount bracket 280a and the first robotic arm 484 travel along an inclined path (i.e., undergo inclined displacement along axis A), and such that a point S on the first robotic arm 484 travels along a corresponding inclined path (i.e., undergoes inclined displacement along axis P), wherein the point S on the first robotic arm 484 approximates the inclined path of movement or travel of a shoulder or shoulder joint of the operator when in the bi-pedal locomotion zone 216 and operating the walk-about system 210, and particularly when the operator moves between a standing position and a squatting position while operating the first robotic arm 484 of the upper-body robotic human augmentation system 480 (see FIGS. 27 and 28). As discussed above, the first robotic arm 484 can comprise a plurality of structural segments rotatably coupled together by a plurality of joints. Moreover, in some examples, the first robotic arm 484 can be at least partially kinematically equivalent to the arm of a human operator. As such, one of these joints, namely the rotatable shoulder joint (rotatable joint 504 that couples together the second and third segments 492, 494 in the example shown herein) can be located at a position and can be configured so as to approximate the position and rotation of the shoulder of the operator (see point/axis S in FIGS. 27 and 28, with the axis extending into the page at the point S) when operating the walk-about system 210. When the operator moves from a standing position to a squatting position, the operator's shoulders naturally move along a path having an incline, which is represented by the axis P (see FIGS. 27 and 28). Advantageously, the working surface 266a of the first support column 264a and the first actuator assembly 284a (or the first actuator assembly 284a itself) can be configured to comprise an incline (represented by the sloped vertical axis A in FIGS. 26-28), such that the path of travel or movement of arm mount bracket 280a and the first robotic arm 484, as actuated by the first actuator assembly 284a, move on an incline, wherein the first robotic arm 484, and particularly the point/axis S of the first robotic arm 484, matches or at least approximates the incline of the path of the operator's shoulders (as represented by the sloped vertical axis P in FIGS. 27 and 28) throughout the range of motion of the first robotic arm 484 as facilitated by the walk-about system 210. Stated differently, the first robotic arm 484, by way of its coupling to the carrier support assembly 260 via the arm mount bracket 280a, can move along an angle of incline (along a sloped vertical axis as represented by the sloped vertical axis A), that is parallel to the incline P of the path of travel of the operator's shoulders, such that the path of travel of the shoulder joint of the first robotic arm 484 approximates the path of travel of the shoulder of the operator. The angle of inclination a of the actuator assembly 284a (and in this example the working surface 266a) of the first support column 264a can be selected or tuned so that the path of travel of the first robotic arm 484, and particularly the shoulder joint of the first robotic arm 484, approximates the path of movement or travel of the shoulders of different sized operators. As such, the angle of inclination a of the actuator assembly 284a and the resulting inclination of the path of travel of the first robotic arm 484 can be formed to comprise any one of a number of different angles or inclines as stated above.

It is noted that the first robotic arm can comprise a number of different configurations. Indeed, the first robotic arm can comprise a configuration that is not necessarily kinematically equivalent to the arm of the operator. Moreover, the first robotic arm can comprise more or less structural segments and joints than the first robotic arm 484 as shown in the example herein. Nonetheless, in any configuration, a point and associated axis similar to point/axis S in FIGS. 27 and 28 that is to correspond to a designated part of the operator (e.g., typically the shoulder of the operator) can be identified within the structural makeup of the first robotic arm, wherein the first robotic arm and the walk-about platform, and particularly the actuator assembly, are configured such that the inclined path of travel of the arm mount bracket and the first robotic arm facilitates the shoulder point/axis being able to approximate the inclination of the path of movement of a shoulder of the operator when in the bi-pedal locomotion zone 216 and operating the walk-about system 210.

It will be apparent to those skilled in the art that the working surface 266b of the second support column 264b, the second actuator assembly 284b, the arm mount bracket 280b, and the second robotic arm 488 coupled thereto, can be configured in the same or a similar manner as the like elements discussed above, namely the working surface 266a of the first support column 264a, the first actuator assembly 284a, the arm mount bracket 280a, and the first robotic arm 484 coupled thereto, such that the inclined path of travel of the arm mount bracket 280b and the second robotic arm 488 are such that a shoulder point/axis on the second robotic arm 488 approximates the inclined path of movement or travel of a shoulder (the opposing shoulder) of the operator in the same or similar manner. As such, the details of this with respect to the second robotic arm 488 are not discussed herein.

The one or more actuator assemblies (e.g., the first and second actuator assemblies 284a, 284b) can be operated and controlled to effectuate the inclined displacement of the first and second robotic arms 484, 488, respectively, by the main control unit and respective local controllers (inclined displacement controllers) based on the input received from one or more user input devices (e.g., one or more operator end effectors) and any associated sensors operable therewith (e.g., see FIG. 40).

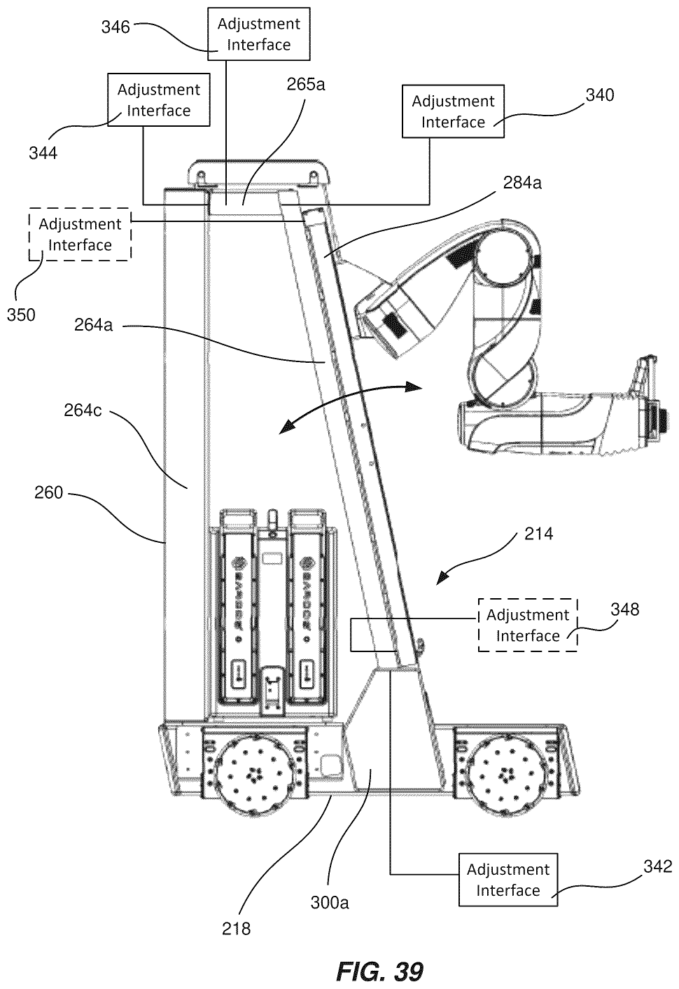

In some examples, the angle of inclination a provided by the actuator assembly 284a (and/or the second actuator assembly 284b) and the resulting inclination of the path of travel (i.e., the inclined displacement) of the upper-body robotic human augmentation system 480, and particularly the first robotic arm 484 (and/or the second robotic arm 488), can be adjustable or variable, which can help to accommodate operators of different size, or which can be useful in different operating scenarios or conditions. The walk-about platform 214 can comprise any number of different mechanisms or systems that facilitate the adjustment of the angle of inclination a. Indeed, the walk-about platform 214 can comprise a number of adjustment interfaces that comprise certain structural components of the carrier support assembly walk-about platform 214, as well as one or more mechanisms or systems that facilitate movement and adjustability of the interface between these. In one example, as shown (see FIG. 39), the first support column 264a can be moveably coupled to the first upper brace 265a via a first adjustment interface 340, such as a rotatable coupling between these. Likewise, the first support column 264a can be moveably coupled to the walk-about base 218 (or to the fish plates 300a, 300b coupling the first support column 264a to the walk-about base 218) via a second adjustment interface 342, such as a rotatable coupling between these. The third support column 264d can be moveably coupled to the first upper brace 265a via a third adjustment interface 344, such as a rotatable coupling between these. The first upper brace 265a can further comprise a fourth adjustment interface 346, such as one that comprises the first upper brace 265a having first and second telescoping sections and a locking mechanism to lock these into any number of positions so as to provide the first upper brace 265a with an adjustable length. In this example, the length of the first upper brace 265a can be selectively adjusted to adjust the angle of inclination of the first support column 264a, and thus the angle of inclination of the actuator assembly 284a supported thereon, relative to the walk-about base 218 and the ground surface. In another alternative example, the actuator assembly 284a can be moveably coupled to the first support column 264a via a lower adjustment interface 348 (shown in dotted lines), such as a rotatable coupling between these. The actuator assembly 284a can further be moveably coupled to the first support column 264a via an upper adjustment interface 350 (shown in dotted lines), such as one that comprises an adjustment mechanism that facilitates the upper end of the actuator assembly 284a to pivot relative to (i.e., toward and away from) the first support column 264a about the rotatably coupling of the actuator assembly 284a to the first support column 264 at its lower end. For instance, the adjustment mechanism can comprise a telescoping member that is rotatably coupled to both the first support column 264a and the actuator assembly 284a. In one aspect, the telescoping member can comprise a telescoping rod having two moveable segments and a mechanical or non-actuated locking mechanism operable to lock these into any number of positions so as to provide the telescoping rod with an adjustable length. In another aspect, the telescoping member can comprise an actuatable member, such as an actuatable fluid (e.g., hydraulic or pneumatic) actuator that can be selectively actuated to control the length of the telescoping member, and thus adjust the angle of inclination of the actuator assembly 284a relative to the first support column 264a, and relative to the walk-about base 218 and the ground surface. Although not discussed specifically herein, or shown in the drawings, the angle of inclination a provided by the actuator assembly 284b as supported on the second support column 264b, and the resulting inclination of the path of travel (i.e., the inclined displacement) of the second robotic arm 488 of the upper-body robotic human augmentation system 480, can be adjustable or variable in the same or similar manner as will be recognized by those skilled in the art.

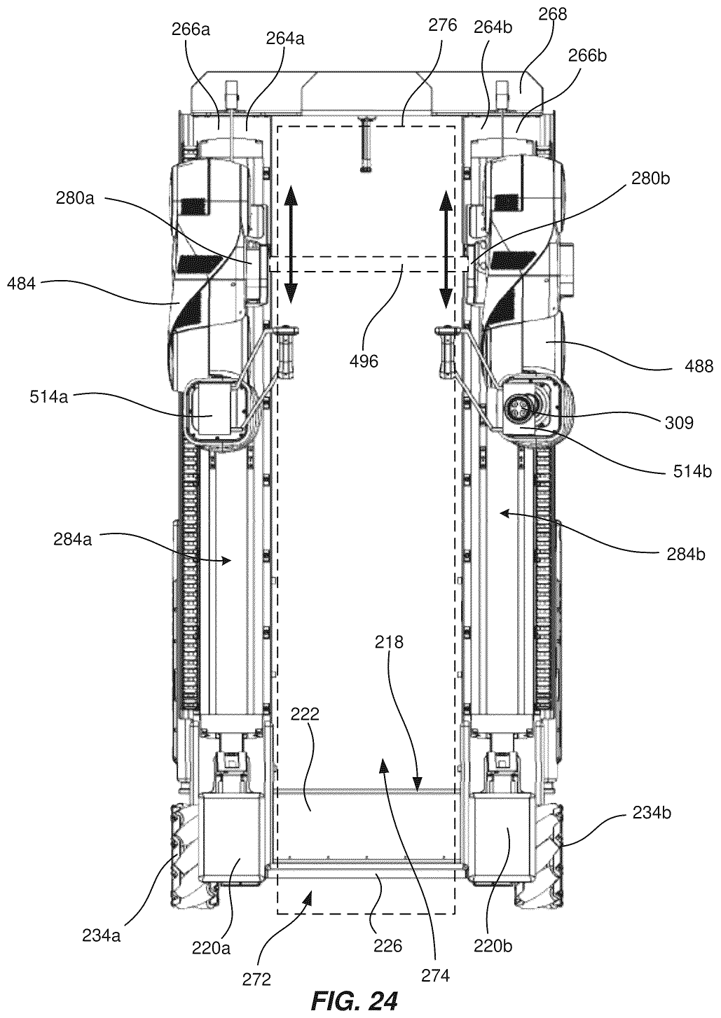

The walk-about platform 214, and particularly the carrier support assembly 260, can further comprise a mechanical arm link 496 (shown in dotted lines in FIG. 24) that interconnects the first and second arm mount brackets 280a, 280b in support of the first and second robotic arms 484, 488, respectively, of the upper-body robotic human augmentation system 480. The arm link 496 can be a rigid interconnecting structure that facilitates synchronized movement of one of the first or second robotic arms 484, 488 in response to actuation of the other of the first or second robotic arms 484, 488. In other words, the arm link 496 allows an operator to control the movement or displacement of both of the first and second robotic arms 484, 488 along their inclined axis (see axis A in FIG. 26) by only interacting with and actuating one of the first or second robotic arms 484, 488. This is made possible as the arm link 496 operates to transfer forces between the first and second arm mount brackets 280a, 280b in support of first and second robotic arms 484, 488, such that when one is moved or displaced, the other undergoes synchronized movement or displacement. The arm link 496 can comprise any type and configuration of a rigid structure that extends between and that couples or mounts to each of the first and second arm mount brackets 280a, 280b in support of first and second robotic arms 484, 488. While it is possible that the walk-about system 210 can be programmed and placed in a mode of operation such that the first and second robotic arms 484, 488 move in a coordinated manner with one another when only a single robotic arm is actually interacted with and actuated by the operator via a user interface device (the computer programming enabling a synchronized mode of operation that facilitates and provides synchronized, coordinated control the displacement of the both robotic arms), the arm link 496 facilitates a mechanical connection or coupling between these that performs a similar function without the need for relying solely on such programming. The arm link 496 can be removably coupled to the first and second arm mount brackets 280a, 280b (e.g., via fasteners, a quick connect/disconnect system, or other such means), or it can be more permanently fixed to these (e.g., via welding or other such means).

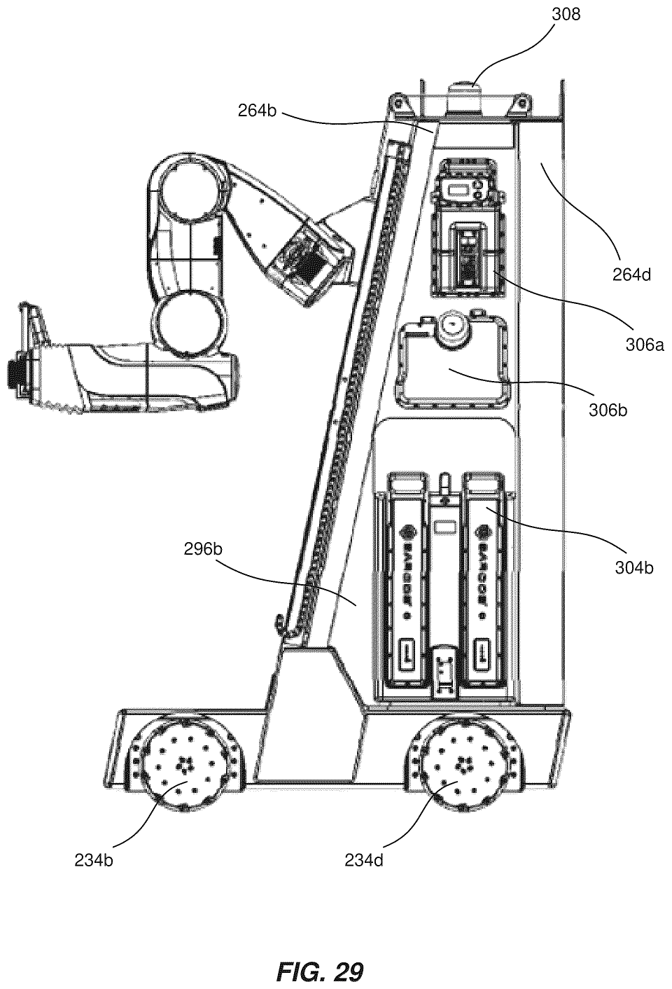

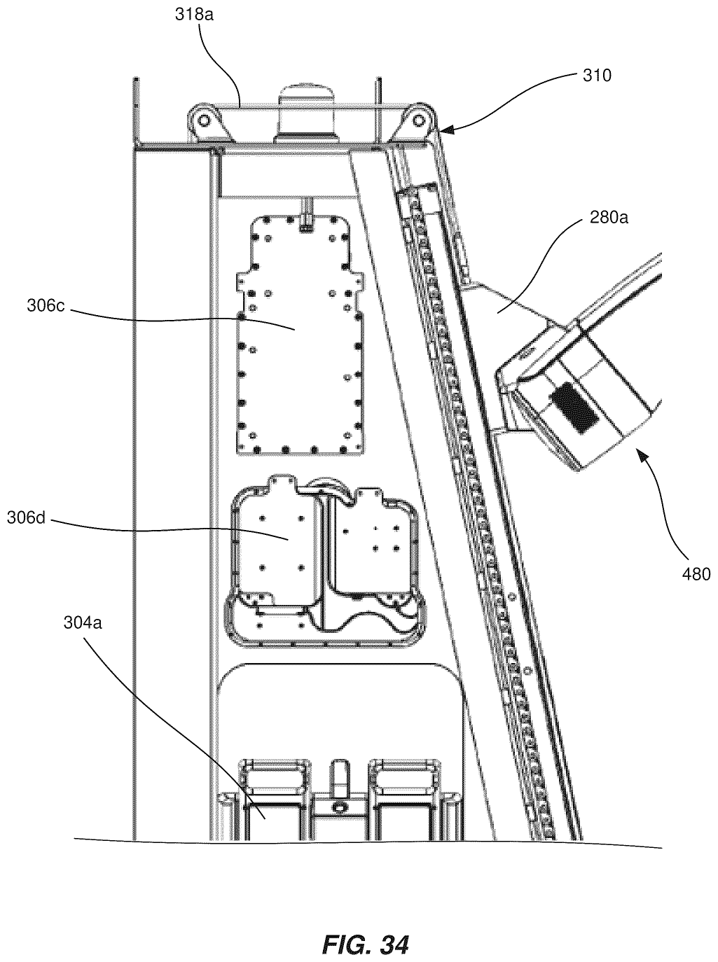

The walk-about platform214, and particularly the carrier support assembly 260, can further comprise one or more shear plates (e.g., see first and second shear plates 296a and 296b coupled to first and third support columns 264a and 264c, respectively, of the framework 262; and third and fourth shear plates 296c and 296d coupled to the second and fourth support columns 264b and 264d, respectively, of the framework 262). The shear plates 296a-d can be sized and configured to provide structural support to the framework 262, as well as to function as mounting structures for various components that are supported by the walk-about platform 214, such as electrical components, electronics enclosures (see electronics/computer enclosures 306a, 306b in FIG. 29 that are mounted to the inner surface of the shear plate 296b) (the shear plates 296c, 296d hidden from view to show the shear plate 296b) (see also computer/electronics enclosures 306c, 306d in FIG. 34), computer and processing components, wiring, and other components. The shear plates 296a-d can be comprised of different types of materials, such as metal, carbon fiber, polymers, and others.

The walk-about platform 214 can further comprise one or more fish plates, otherwise known as joint bars, that operate to couple or join the support columns of the carrier support assembly 260 to the lateral members of the walk-about base. These can further strengthen and ensure alignment at the joint or interface between these. As in the example shown, a first fish plate 300a and a second fish plate 300b can each be coupled to the first support column 264a and the first lateral member 220a, at opposing sides of these, in order to secure these together. Likewise, a third fish plate 300c and a fourth fish plate 300d can each coupled to the second support column 264b and the second lateral member 220b, at opposing sides of these, in order to secure these together and to strengthen and align the joint between these. The fish plates 300a-d can comprise any size and configuration as needed.

The walk-about system 210 can further comprise any number of different operating and/or communication components. For example, the walk-about platform 214 can further comprise an antenna 308 supported on the upper bridging member 268. Operating and communication components that can be supported at various locations can include, but are not limited to, antennas, cameras, lighting, speakers, graphical user interfaces, a wireless network interface, and others (see FIG. 40). In one specific example, the upper-body robotic human augmentation system 480 can comprise a camera mounted to one or more of the operator end effectors (e.g., see camera 309 mounted to the operator end effector 514b in FIGS. 20-26). Other cameras or other operating and/or communications components can be mounted in other locations on the upper-body robotic human augmentation system 480, the walk-about platform 214, or a combination of these.

The walk-about platform 214 can further comprise one or more power sources that function to provide power to one or more systems or subsystems of the walk-about platform 214, the upper-body robotic human augmentation system 480, or a combination of these. In one example, the walk-about platform 214 can be electrically coupled to a power grid, such as via a tether or cable. In another example, the walk-about platform 214 can comprise one or more power sources supported on-board the walk-about platform 214, such as one or more batteries, fuel cells, an internal combustion engine, or a combination of these. In one specific example, as shown, the walk-about platform 214 can comprise several power sources in the form of a plurality of batteries, with one or more of the plurality of batteries being supported on each side of the walk-about platform 214.

The one or more power sources of the walk-about platform 214 can be positioned or located anywhere. For instance, the location and structures supporting the plurality of batteries can vary depending upon the configuration of the walk-about platform 214, the type of batteries used, and other factors. In the example shown, a first battery array 304a can be supported about a first side of the walk-about platform 214, such as supported by one or more components of the walk-about base 218 (e.g., the first lateral member 220a) and/or one or more components of the carrier support assembly 260 (e.g., the first and third support columns 264a, 264c), and a second battery array 304b can be supported about a second side of the walk-about platform 214, such as supported by one or more components of the walk-about base 218 (e.g., the second lateral member 220b) and/or one or more components of the carrier support assembly 260 (e.g., the second and fourth support columns 264b, 264d). In one example, the one or more power sources can be located rearward of the upper-body robotic human augmentation system 480 and the bi-pedal locomotion zone 216. This places the power source(s) (e.g., battery or batteries, fuel cells, etc.) rearward of both the bi-pedal locomotion zone 216 and the operator, when the system 210 is in use. Typically, a power source such as a battery can comprise a relatively large amount of weight. Thus, with the one or more power sources being supported in a location rearward of the upper-body robotic human augmentation system 480, the one or more power sources can operate as a counterweight within the walk-about augmentation system 210. In other words, the one or more power sources can help to stabilize the walk-about augmentation system 210 to prevent the walk-about augmentation system 210 from tipping during use of the upper-body robotic human augmentation system 480, and while carrying or otherwise manipulating a payload or an object. This is because the walk-about augmentation system 210 with its upper-body robotic human augmentation system 480 can be designed to function and to pick up, carry, or otherwise interact with a payload or object that is in front of the one or more power sources and the operator. Indeed, with the weight of at least a portion of the walk-about base 218, at least a portion of the carrier support assembly 260, and the one or more power sources being behind the operator, these can operate collectively to provide a torque that counters, at least to some extent, the torque caused by the weight and operation of the upper-body robotic human augmentation system 480 and a payload carried by the upper-body robotic human augmentation system 480 (or an object being manipulated) to keep the walk-about augmentation system 210 from tipping. Of course, the one or more power sources could be disposed at any position behind the operator during use. The walk-about platform 214 can further comprise, if needed, any number of additional masses or objects that operate as counterweights within the walk-about augmentation system 210 in addition to the one or more power sources.

With the one or more power sources operating as a counterweight, the walk-about augmentation system 210 can maintain a center of gravity in a location that provides the walk-about augmentation system 210 with a more stable stance about a ground surface when the walk-about augmentation system 210 is subject to forces that would otherwise potentially tip the walk-about augmentation system 210. Because the one or more power sources can operate as a counterweight rearward of the bi-pedal locomotion zone 216, the walk-about augmentation system 210 can be operable to prevent tipping during operation by maintaining a center of gravity within an area of the bi-pedal locomotion zone 106. For example, an operator can operate the upper-body robotic human augmentation system 480 to carry a payload in front of the operator. In this situation, the walk-about augmentation system 210 can maintain a center of gravity to avoid tipping due at least in part to the one or more power sources (e.g. batteries), being located at the rear of the bi-pedal locomotion zone 216, acting as a counterweight to the payload being carried. This is because the weight of the portion of the walk-about platform 214, including the one or more power sources, rearward of the upper-body robotic human augmentation system 480 creates a torque acting within the walk-about augmentation system 210 that acts in an opposite direction as the torque created by the payload carried by the upper-body robotic human augmentation system 480. Thus, the center of gravity can be located at and maintained at a select location to prevent tipping.

In some examples, the one or more power sources can be removable from the walk-about platform 214. Thus, the one or more power sources can be easily swapped for a new power source, for example, to quickly change from a depleted battery to a fully charged battery. In some examples, if even more counterweight is desired for a particular application, one or more additional counterweights can be provided that can be operable within the walk-about platform 214. For example, additional power sources could be included. In some examples, a counterweight that is not a power source could also be used, as described below. Further, the specific shape and configuration of the walk-about base 218 and the carrier support assembly 260 are not limited to the specific features and configuration of these as shown. It should be understood that modifications to each of these can be made while still facilitating a bi-pedal locomotion zone accommodating an operator, with supporting structure behind the operator providing a counterweight within the walk-about augmentation system 210 to avoid tipping.

As indicated above, the walk-about platform 214 can further comprise other systems, objects, or mechanisms that operate to stabilize the walk-about platform 214 and the upper-body robotic human augmentation system 480 about the ground surface, particularly when the walk-about system 210 is being operated to carry a payload and/or manipulate an object. In one example, the walk-about platform 214 can comprise a moveable counterweight system that is the same as or similar to the moveable counterweight system 161 discussed above with reference to FIGS. 6A-6B, and that is operable to move and vary the location of the center of gravity of the walk-about augmentation system 210. As such, the above discussion is incorporated here and is intended to be applicable to the walk-about platform 214. Moreover, one skilled in the art will recognize how the walk-about platform 214 can be configured to comprise a similar moveable counterweight.

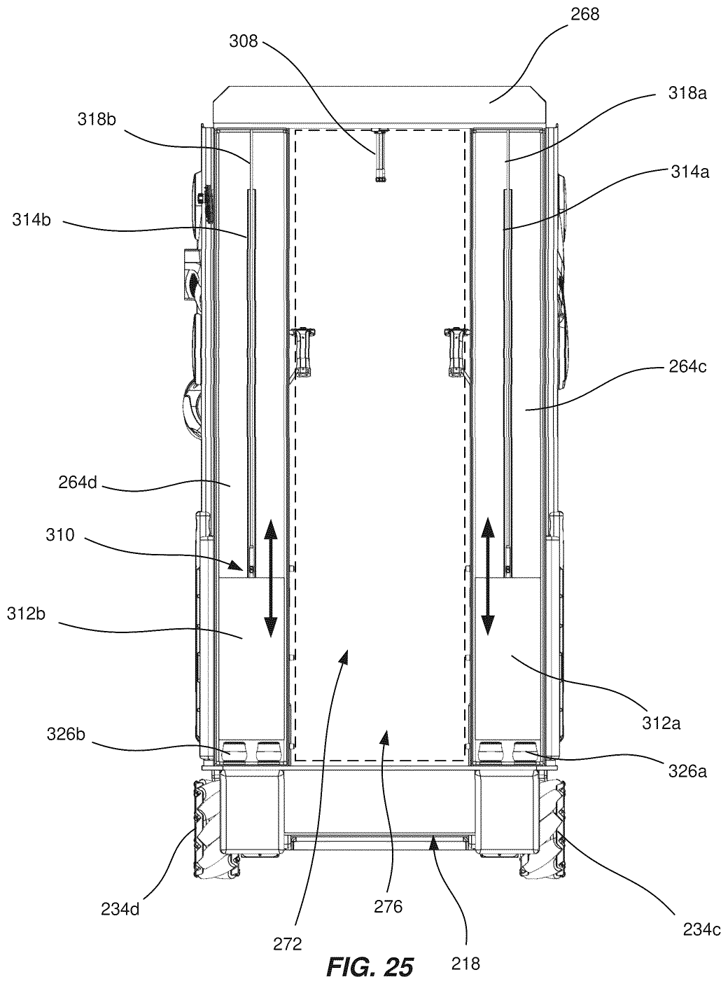

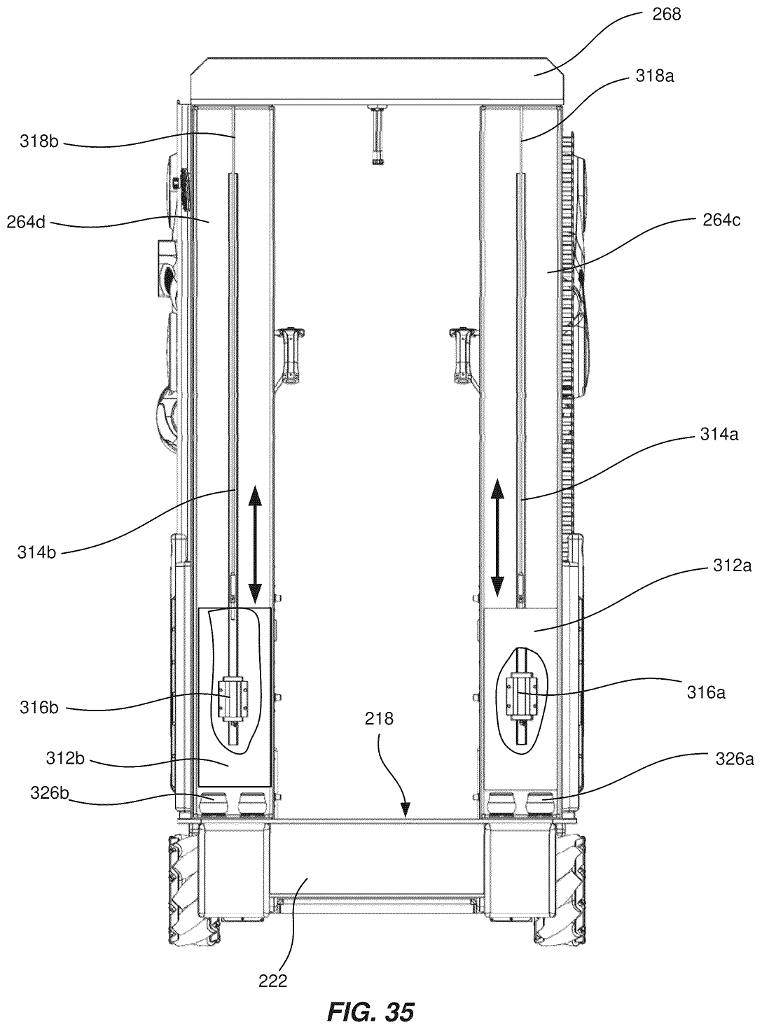

In another example, the walk-about platform 214, and particularly the carrier support assembly 260, can further comprise a gravity compensation system operable to gravity compensate the upper-body robotic human augmentation system 480, as well as optionally, and at least int part, a payload carried by the upper-body robotic human augmentation system 480 in at least one degree of freedom. The gravity compensation system can comprise any number of different systems or mechanisms to achieve this. In one specific example, a gravity compensation system 310, as shown in FIGS. 25, 31-35, and 40), can comprise one or more moveable counterweights that are coupled to the upper-body robotic human augmentation system 480, or to the interface mounting hardware that couples this system to the carrier support assembly 260, or a combination of these. In one example, as shown, the gravity compensation system 310 can be operable with (e.g., coupled to) at least one of the first and second arm mount brackets 280a, 280b, and/or to the first and second robotic arms 484, 488 coupled thereto, that undergo inclined displacement along the sloped or inclined actuated degree of freedom discussed above. Specifically, the gravity compensation system 310 can comprise first and second counterweights 312a and 312b, respectively, moveable relative to the framework 262, such as about the rear third and fourth support columns 264c and 264d, respectively, of the framework 262. The gravity compensation system 310 can further comprise a first guide rod 314a mounted to the third support column 264c, and a second guide rod 314b mounted to the fourth support column 264d. The first and second counterweights 312a and 312b can be configured to interface (directly or indirectly) with the first and second guide rods 314a and 314b, respectively, such that the first and second counterweights 312a and 312b follow a controlled path of displacement along and about the third and fourth support columns 264c and 264d. In one example, the first and second counterweights 312a and 312b can interface with the first and second guide rods 314a, 314b, respectively, via first and second respective sliders (e.g., see the cutout of the first counterweight 312b revealing the first slider 316a, and the cutout of the second counterweight 312b revealing slider 316b, in FIG. 35) to which the first and second counterweights 312a and 312b are coupled. The first and second sliders 316a, 316b can slidingly interface with the first and second guide rods 314a, 314b to facilitate the movement of the first and second counterweights 312a and 312b along the first and second guide rods 314a, 314b, respectively. A first flexible cable 318a can be coupled at one end to the first counterweight 312a, and at an opposite end to the first arm mount bracket 280a, such that the first flexible cable 318a extends between the first counterweight 312a and the first arm mount bracket 280a. A second flexible cable 318b can be coupled at one end to the second counterweight 312b, and at an opposite end to the second arm mount bracket 280b, such that the second flexible cable 318b extends between the second counterweight 312b and the second arm mount bracket 280b. The first and second cables 318a, 318b can each be routed, such that movement of the first and second robotic arms 484, 488 (e.g., downward along the sloped vertical axis A) in one direction results in movement of the first and second counterweights 312a and 312b in an opposing direction (upward), thus these operating to counter, at least to some extent, the gravitational forces acting on the first and second robotic arms 484, 488 during operation. In the example shown, the first cable 318a is routed upward from its first end coupled to the first counterweight 312a through a first aperture 270a in the upper bridging member 268. The first cable 318a is then routed around first and second pulleys 322a, 322b mounted to an upper surface of the upper bridging member 268, and then the first cable 318a is routed downward where it's opposing or second end is coupled to the first arm mount bracket 280a. Likewise, the second cable 318b is routed upward from its first end coupled to the second counterweight 312b through a second aperture 270b in the upper bridging member 268. The second cable 318b is then routed around third and fourth pulleys 322c, 322d mounted to an upper surface of the upper bridging member 268, with the opposing or second end of the second cable 318b then being coupled to the second arm mount bracket 280b.

As in the example shown, the first and second arm mount brackets 280a, 280b and the first and second robotic arms 484, 488 can be supported by and driven by the first and second actuator assemblies 284a, 284b comprising the first and second actuators 286a, 286b, respectively, and the respective first and second support columns 264a, 264b of the framework 262 (alternatively, as indicated above, the first and second arm mount brackets 280a, 280b and the first and second robotic arms 484, 488 can be supported by and held up by a single actuator assembly). In operation, as the first and second actuators 286a, 286b (or a single actuator in other examples) are supported, and as they are actuated to drive the first and second arm mount brackets 280a, 280b and the first and second robotic arms 484, 488, respectively, as well as any payload carried by one or more of the first and second robotic arms 484, 488, those weights or loads (those of the robotic arms 484, 488 and any payloads) are counterbalanced/gravity compensated, at least in part, by the first and second counterweights 312a and 312b, which operate to apply a counter force on the first and second robotic arms 484, 488 equal to their weight (i.e., equal to the weight of the first and second counterweights 312a and 312b).

The first and second counterweights 312a and 312b can comprise any weight suitable to provide at least some gravity compensation of the first and second robotic arms 484, 488, an optionally any payload carried by the first and second robotic arms 484, 488. In one example, the first and second counterweights 312a and 312b can be configured to comprise a weight equal to a weight of the first and second robotic arms 484, 488, respectively (and optionally a payload). In this example, no (zero) torque is required from the first and second actuators 286a, 286b to hold the first and second robotic arms 484, 488 stationary in the event that no payload is being carried. In another example, the first and second counterweights 312a and 312b can be configured to comprise a weight greater than a weight of the first and second robotic arms 484, 488, respectively (and optionally a payload). In this example, the gravity compensation system 310 is configured to apply an upward biasing force, wherein the first and second robotic arms 484, 484 are pulled upwards by the first and second counterweights 312a and 312b in the absence of a payload. The first and second actuators 286a, 286b are actuated to apply a torque to lower the first and second robotic arms 484, 488, or to hold them stationary. In still another example, the first and second counterweights 312a and 312b can be configured to comprise a weight that is less than a weight of the first and second robotic arms 484, 488, respectively (and optionally a payload). In this example, the gravity compensation system 310 is configured to apply a downward biasing force, wherein the first and second robotic arms 484, 484 are pulled downwards by the first and second counterweights 312a and 312b in the absence of a payload. The first and second actuators 286a, 286b are actuated to apply a torque to raise the first and second robotic arms 484, 488, or to hold them stationary. It is noted that although the first and second robotic arms 484, 484 have been discussed as being operable with the first and second counterweights 312a and 312b, respectively, these can be independent systems each part of the gravity compensation system 310 of the walk-about platform 214.

The gravity compensation system 310 can further comprise one or more stoppers supported on the walk-about base 218 that are sized and configured to interface with the first and second counterweights 312a and 312b, respectively. In the example shown, a first stopper or stopper array 326a can be supported on the support bridge 222 of the walk-about base 218 in a position so as to interface with (i.e., receive and engage) the first counterweight 312a. Likewise, a second stopper or stopper array 326b can be supported on the support bridge 222 of the walk-about base 218 in a position so as to interface with (i.e., receive and engage) the second counterweight 312b. The stoppers 326a, 326b can be formed of any material capable of providing a stop to the descent of the first and second counterweights 312a, 312b, as well supporting the first and second counterweights 312a, 312b in a resting position. In one example, as shown, the first and second stoppers 326a, 326b can comprise shock absorption or impact resistant properties, or they can be configured to elastically deform under a load. For instance, the stoppers 325a, 326b can be formed of an elastomeric material (e.g., rubber or other material). Alternatively, they can comprise a spring or spring-like configuration. In either case, the first and second stoppers 326a, 326b can be configured, such that they compress under a load as applied by the first and second counterweights 312a, 312b.

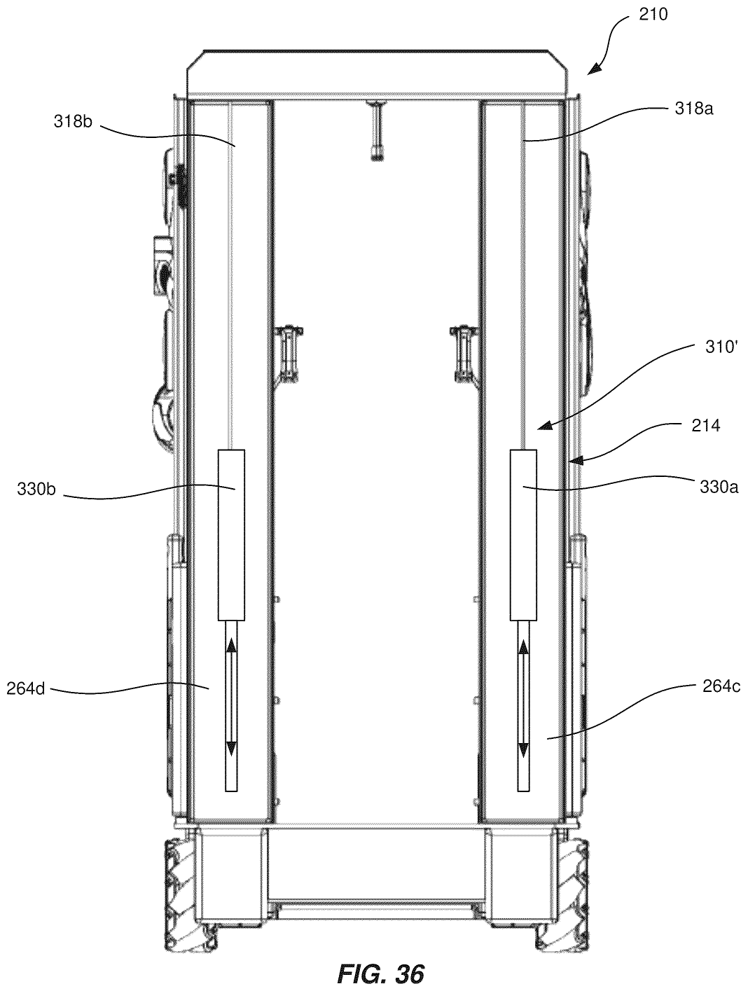

In another specific example (see FIG. 36), an alternative gravity compensation system 310′ can be implemented within the walk-about platform 214 of the walk-about system 210. In this example, the gravity compensation system 310′ can comprise first and second gas springs 330a and 330b rather than the moveable counterweights discussed above. In this example, the first and second cables 318a, 318b can be coupled to the first and second gas springs 330a, 330b, respectively. More specifically, the first and second cables 318a, 318b can be coupled to the first and second gas springs 330a, 330b, such that the forces acting on the upper-body robotic human augmentation system 480 due to gravity are compensated. This is achieved by mounting the first and second gas springs 330a, 330b in a certain orientation to the framework 262 (and specifically to the third and fourth support columns 264c, 264d), as well as coupling the first and second cables 318a, 318b to the first and second gas springs 330a, 330b at a location (e.g., a distal or lower end), such that the gas springs are compressed in the direction of the gravitational forces acting on the upper-body robotic human augmentation system 480, wherein the first and second gas springs 330a, 330 operate to counter such gravitational forces. The first and second gas springs 330a, 330 can be mounted away from the upper-body robotic human augmentation system 480 and connected to this (and specifically the first and second robotic arms 484, 488 and/or the arm mounts coupling these to the carrier support assembly 260) via the first and second cables 318a, 318b. Alternatively, the gas springs can be coupled directly to the upper-body robotic human augmentation system 480. Similar to the first and second counterweights 312a and 312b discussed above, the first and second gas springs 330a and 330b can be tuned or selected to provide at least some gravity compensation of the first and second robotic arms 484, 488, as well as a payload carried by the first and second robotic arms 484, 488. The magnitude of the counterforce applied by the first and second gas springs 330a and 330b can be greater, equal to, or less than a magnitude of gravitational force from the weight of the first and second robotic arms 484, 488, respectively (and optionally any payload).

Integration of a gravity compensation system (e.g., 310 or 310′) within the walk-about platform 214 enables movement and positioning of the upper-body robotic human augmentation system 480 to remain at least partially gravity balanced and efficient, especially when managing variable payloads or dynamic operator interactions when performing certain tasks. The gravity compensation system not only offsets and reduces the physical loads experienced by the components of the upper-body robotic human augmentation system 480, but also enhances the overall stability and responsiveness of the walk-about platform 214. As a result, operators benefit from a more intuitive and manageable interface, allowing for precise control of the first and second robotic arms 484, 488 and seamless adaptation to different operational scenarios.

The walk-about system 210 can further comprise one or more control units (e.g., see main control unit in FIG. 40). The one or more control units can comprise one or more processors and one or more non-transitory storage media or memory devices that can store control instructions which are executable by the one or more processors. The one or more control units can send control instructions to the various components, systems, subsystems of the walk-about system 210 (namely the walk-about platform 214, the upper-body robotic human augmentation system 480, any communications devices/systems, or a combination of these.

The following examples are further illustrative of several embodiments of the present technology:
1. A walk-about platform, comprising:
a walk-about base moveable about a ground surface, the walk-about base defining, at least in part, a bi-pedal zone of operation for an operator;
a mast extending upward from the walk-about base, the mast being in support of at least one robotic arm; and
an actuator assembly supported by the mast, and comprising an actuator operable with a supported first robotic arm,
wherein the first robotic arm undergoes inclined displacement in a sloped vertical degree of freedom within a given range of motion, and relative to the ground surface.
2. The walk-about platform of example 1, wherein an inclined path of the first robotic arm when undergoing the inclined displacement is configured to approximate an inclined path of travel of a shoulder of the operator when moving between a standing position and a squatting position.
3. The walk-about platform of any preceding example, wherein the mast comprises a carrier support assembly.
4. The walk-about platform of any preceding example, wherein the carrier support assembly comprises:
a framework comprising a structural support column having a working surface in support of the actuator assembly; and
a guide member supported on the structural support column,
wherein the structural support column is configured to facilitate the inclined displacement of the first robotic arm within a range of motion along the guide member.
5. The walk-about platform of any preceding example, further comprising a second actuator assembly supported by the mast, and comprising a second actuator operable with a supported second robotic arm, wherein the second robotic arm undergoes inclined displacement in a sloped vertical degree of freedom within a given range of motion, and relative to the ground surface.
6. The walk-about platform of any preceding example, wherein the carrier support assembly further comprises:
a second structural support column that is part of the framework, the second structural support column having a working surface in support of the second actuator assembly; and
a guide member supported on the second structural support column,
wherein the second structural support column is configured to facilitate the inclined displacement of the second robotic arm within a range of motion along the guide member of the second structural support column.
7. The walk-about platform of any preceding example, wherein the carrier support assembly comprises an operator pass-through channel defined, at least in part, by the first and second structural support columns, wherein the operator pass-through channel extends through the carrier support assembly, and facilitates ingress of the operator into, and egress of the operator out of, a bi-pedal locomotion zone from multiple directions.
8. A walk-about human augmentation system, comprising:
an upper-body robotic human augmentation system comprising:
a first robotic arm having at least one joint facilitating movement in at least one degree of freedom;
a user input device associated with the first robotic arm;
a walk-about platform in support of the upper-body robotic human augmentation system, and operable about a ground surface, the walk-about platform comprising:
a walk-about base; and
a mast in the form of a carrier support assembly supported by the walk-about base, the carrier support assembly comprising a framework and an actuator assembly having an actuator and a guide member,
wherein the first robotic arm is moveably supported by the carrier support assembly, and
wherein the first robotic arm undergoes inclined displacement in a sloped vertical degree of freedom within a given range of motion along the guide member, and relative to the ground surface.
9. The system of any preceding example, wherein an inclined path of the first robotic arm, when undergoing the inclined displacement, is configured to approximate an inclined path of travel of a shoulder of the operator when moving between a standing position and a squatting position while operating the walk-about system.
10. The system of any preceding example, wherein the sloped vertical degree of freedom comprises a single actuated degree of freedom, such that the inclined displacement of the first robotic arm in the sloped vertical degree of freedom results in movement of the first robotic arm in two spatial degrees of freedom.
11 The system of any preceding example, wherein the framework comprises a first structural support column, and wherein the first robotic arm is moveably supported by the first structural support column.
12. The system of any preceding example, wherein the first robotic arm comprises a configuration kinematically equivalent to an arm of the operator.
13. The system of any preceding example, wherein the upper-body robotic human augmentation system comprises a wearable upper-body exoskeleton, wherein the first robotic arm is configured as a first robotic arm of the upper-body exoskeleton.
14. The system of any preceding example, wherein the inclined displacement of the first robotic arm follows a linear path, such that the first robotic arm moves along a constant angle of descent and ascent.
15. The system of any preceding example, wherein the inclined displacement of the first robotic arm follows a non-linear, curved incline, such that the first robotic arm moves along a changing angle of descent and ascent.
16. The system of any preceding example, wherein an inclined path of travel of the first robotic arm when undergoing the inclined displacement can be at least one of: between 5 and 35 degrees, between 5 and 30 degrees, between 5 and 25 degrees, between 5 and 20 degrees, between 5 and 15 degrees, between 6 and 14 degrees, between 7 and 13 degrees, between 8 and 12 degrees, or between 9 and 11 degrees as measured from an axis normal to the ground surface.
17. The system of any preceding example, wherein an inclined path of travel of the first robotic arm when undergoing the inclined displacement 5 and 15 degrees as measured from an axis normal to the ground surface.
18. The system of any preceding example, wherein the actuator comprises a linear actuator.
19. The system of any preceding example, wherein the actuator comprises a ball screw-type actuator.
20. The system of any preceding example, wherein the upper-body robotic human augmentation system comprises a second robotic arm having at least one joint facilitating movement in at least one degree of freedom.
21. The system of any preceding example, wherein the framework of the carrier support assembly further comprises:
a second structural support column, the second robotic arm being moveably supported by the second support column; and
a second actuator assembly having an actuator and a guide member,
wherein the second robotic arm undergoes inclined displacement in a sloped vertical degree of freedom within a given range of motion along the guide member of the second actuator assembly, and relative to the ground surface.
22 The system of any preceding example, wherein an inclined path of the second robotic arm, when undergoing the inclined displacement, is configured to approximate an inclined path of travel of a shoulder of the operator when moving between a standing position and a squatting position while operating the walk-about system.
23. The system of any preceding example, wherein the user input device comprises an operator end effector supported about the first robotic arm, the operator end effector being operable with at least one sensor to detect movements of the operator, wherein control of the first robotic arm is based on corresponding forces as detected by the at least one sensor.
24. The system of any preceding example, wherein the first and second robotic arms are independent of one another, and are independently controlled by respective user input devices operable with the first and second robotic arms.
25. The system of any preceding example, wherein the first and second robotic arms are each controlled in a coordinated manner with the user input device operable with at least one of the first or second robotic arms.
26. The system of any preceding example, wherein the first and second robotic arms are coupled together via a mechanical arm link, such that the first and second robotic arms undergo synchronized inclined displacement.
27. The system of any preceding example, wherein the framework of the carrier support assembly defines an operator pass-through channel that facilitates ingress of the operator into, and egress of the operator out of, a bi-pedal locomotion zone from multiple directions.
28. The system of any preceding example, wherein the walk-about platform comprises a conveyance system that facilitates powered locomotion of the walk-about platform about the ground surface.
29. The system of any preceding example, wherein the walk-about base comprises first and second lateral members.
30. The system of any preceding example, wherein the walk-about platform further comprises a riding platform operable to support the operator above the ground surface within a bi-pedal locomotion zone, and to facilitate riding of the operator on the walk-about platform.
31. The system of any preceding example, wherein an upper body and a lower body of the operator are decoupled from the walk-about system.
32. The system of any preceding example, further comprising a gravity compensation system supported on the carrier support assembly, and operable to gravity compensate the first robotic arm.
33. The system of any preceding example, wherein the gravity compensation system comprises:
a counterweight; and
a pulley system coupling the counterweight to a robotic arm interface coupling the first robotic arm to the carrier support assembly,
wherein the counterweight applies a counterforce to the first robotic arm in opposition to a gravitational force.
34. The system of any preceding example, wherein the gravity compensation system comprises:
a gas spring; and
a pulley system coupling the gas spring to a robotic arm interface coupling the first robotic arm to the carrier support assembly,
wherein the gas spring applies a counterforce to the first robotic arm in opposition to a gravitational force.
35. The system of any preceding example, wherein the carrier support assembly further comprises a robotic arm interface that moveably couples the first robotic arm to the carrier support assembly.
36. A walk-about robotic human augmentation system, comprising:
a first robotic arm comprising at least one joint facilitating movement of a jointed member in at least one degree of freedom;
a second robotic arm comprising at least one joint facilitating movement of a jointed member in at least one degree of freedom;
a walk-about platform operable about a ground surface, and comprising:
a walk-about base;
a mast in the form of a carrier support assembly supported by the walk-about base, and comprising:
a first support column in support of the first robotic arm;
a second support column in support of the second robotic arm;
a first actuator assembly operable with the first robotic arm;
a second actuator assembly operable with the second robotic arm; and
a control unit comprising one or more processors, and one or more memory devices comprising instructions that, when executed by the one or more processors, cause the system to:
control inclined displacement of the first robotic arm in a sloped vertical degree of freedom within a given range of motion relative to the ground surface; and
control inclined displacement of the second robotic arm in a sloped vertical degree of freedom within a given range of motion relative to the ground surface.
37. The system of any preceding example, wherein the one or more memory devices further comprises instructions that, when executed by the one or more processors, cause the system to coordinate the movement of the first robotic arm with the movement of the second robotic arm via a common user interface device.
38. The system of any preceding example, wherein the one or more memory devices further comprises instructions that, when executed by the one or more processors, cause the system to control operation of at least one of the first or second robotic arms.
39. The system of any preceding example, wherein the one or more memory devices further comprises instructions that, when executed by the one or more processors, cause the system to operate the one or more robotic arms in a teleoperation mode.
40. The system of any preceding example, wherein the one or more memory devices further comprises instructions that, when executed by the one or more processors, cause the system to operate the one or more robotic arms in an autonomous mode.
41. A method for facilitating operation of a walk-about robotic human augmentation system, comprising:
configuring an upper-body robotic human augmentation system to comprise a first robotic arm having at least one joint facilitating movement in at least one degree of freedom;
configuring a walk-about platform to be in support of the upper-body robotic human augmentation system; and
facilitating inclined displacement of the first robotic arm in a sloped vertical degree of freedom within a given range of motion along the guide member, and relative to the ground surface
42. The method of any preceding example, further comprising configuring an inclined path of the first robotic arm, when undergoing the inclined displacement, to approximate an inclined path of travel of a shoulder of the operator when moving between a standing position and a squatting position while operating the walk-about system.
43. The method of any preceding example, further comprising configuring the sloped vertical degree of freedom to comprise a single actuated degree of freedom, such that the inclined displacement of the first robotic arm in the sloped vertical degree of freedom results in movement of the first robotic arm in two spatial degrees of freedom.
44. The method of any preceding example, configuring the walk-about platform to define an operator pass-through channel that facilitates ingress of the operator into, and egress of the operator out of, a bi-pedal locomotion zone from multiple directions.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features or examples described herein may be combined with other embodiments or features or examples described herein, this disclosure should be read to describe any such combinations that would be practicable by one of ordinary skill in the art. Indeed, the above detailed description of embodiments of the present technology are not intended to be exhaustive or to limit the present technology to the precise form disclosed above. Although specific embodiments of, and examples for, the present technology are described above for illustrative purposes, various equivalent modifications are possible within the scope of the present technology as those skilled in the relevant art will recognize. For example, although steps are presented in a given order, alternative embodiments can perform steps in a different order. The various embodiments described herein can also be combined to provide further embodiments.

Furthermore, the described features, structures, characteristics or examples of the present technology may be combined in any suitable manner in one or more examples. In the preceding description, numerous specific details were provided, such as examples of various configurations to provide a thorough understanding of examples of the described technology. It will be recognized, however, that the present technology may be practiced without one or more of the specific details, or with other methods, components, devices, etc. In other instances, well-known structures or operations are not shown or described in detail to avoid obscuring aspects of the technology.

Moreover, unless the word “or” is expressly limited to mean only a single item exclusive from other items in reference to a list of two or more items, then the use of “or” in such a list is to be interpreted as including (a) any single item in the list, (b) all of the items in the list, or (c) any combination of the items in the list. In other words, the use of “or” in this disclosure should be understood to mean non-exclusive “or” (i.e., “and/or”) unless otherwise indicated herein.

Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the present technology have been described in the context of those embodiments, other embodiments can also exhibit such advantages, and not all embodiments need necessarily exhibit such advantages to fall within the scope of the technology. Accordingly, the disclosure and associated present technology can encompass other embodiments not expressly shown or described herein.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described present technology.

What is claimed is:

1. A walk-about platform, comprising:
a walk-about base moveable about a ground surface, the walk-about base defining, at least in part, a bi-pedal zone of operation for an operator;
a mast extending upward from the walk-about base, the mast being in support of at least one robotic arm; and
an actuator assembly supported by the mast, and comprising an actuator operable with a supported first robotic arm,
wherein the first robotic arm undergoes inclined displacement in a sloped vertical degree of freedom within a given range of motion, and relative to the ground surface.

2. The walk-about platform of claim 1, wherein an inclined path of the first robotic arm when undergoing the inclined displacement is configured to approximate an inclined path of travel of a shoulder of the operator when moving between a standing position and a squatting position.

3. The walk-about platform of claim 1, wherein the mast comprises a carrier support assembly.

4. The walk-about platform of claim 3, wherein the carrier support assembly comprises:
a framework comprising a structural support column having a working surface in support of the actuator assembly; and
a guide member supported on the structural support column,
wherein the structural support column is configured to facilitate the inclined displacement of the first robotic arm within a range of motion along the guide member.

5. The walk-about platform of claim 4, further comprising a second actuator assembly supported by the mast, and comprising a second actuator operable with a supported second robotic arm, wherein the second robotic arm undergoes inclined displacement in a sloped vertical degree of freedom within a given range of motion, and relative to the ground surface.

6. The walk-about platform of claim 5, wherein the carrier support assembly further comprises:
a second structural support column that is part of the framework, the second structural support column having a working surface in support of the second actuator assembly; and
a guide member supported on the second structural support column,
wherein the second structural support column is configured to facilitate the inclined displacement of the second robotic arm within a range of motion along the guide member of the second structural support column.

7. The walk-about platform of claim 6, wherein the carrier support assembly comprises an operator pass-through channel defined, at least in part, by the first and second structural support columns, wherein the operator pass-through channel extends through the carrier support assembly, and facilitates ingress of the operator into, and egress of the operator out of, a bi-pedal locomotion zone from multiple directions.

8. A walk-about human augmentation system, comprising:
an upper-body robotic human augmentation system comprising:
a first robotic arm having at least one joint facilitating movement in at least one degree of freedom;
a user input device associated with the first robotic arm;
a walk-about platform in support of the upper-body robotic human augmentation system, and operable about a ground surface, the walk-about platform comprising:
a walk-about base; and
a mast in the form of a carrier support assembly supported by the walk-about base, the carrier support assembly comprising a framework and an actuator assembly having an actuator and a guide member,
wherein the first robotic arm is moveably supported by the carrier support assembly, and
wherein the first robotic arm undergoes inclined displacement in a sloped vertical degree of freedom within a given range of motion along the guide member, and relative to the ground surface.

9. The system of claim 8, wherein an inclined path of the first robotic arm, when undergoing the inclined displacement, is configured to approximate an inclined path of travel of a shoulder of the operator when moving between a standing position and a squatting position while operating the walk-about system.

10. The system of claim 8, wherein the sloped vertical degree of freedom comprises a single actuated degree of freedom, such that the inclined displacement of the first robotic arm in the sloped vertical degree of freedom results in movement of the first robotic arm in two spatial degrees of freedom.

11. The system of claim 8, wherein the framework comprises a first structural support column, and wherein the first robotic arm is moveably supported by the first structural support column.

12. The system of claim 8, wherein the first robotic arm comprises a configuration kinematically equivalent to an arm of the operator.

13. The system of claim 8, wherein the upper-body robotic human augmentation system comprises a wearable upper-body exoskeleton, wherein the first robotic arm is configured as a first robotic arm of the upper-body exoskeleton.

14. The system of claim 8, wherein the inclined displacement of the first robotic arm follows a linear path, such that the first robotic arm moves along a constant angle of descent and ascent.

15. The system of claim 8, wherein the inclined displacement of the first robotic arm follows a non-linear, curved incline, such that the first robotic arm moves along a changing angle of descent and ascent.

16. The system of claim 8, wherein an inclined path of travel of the first robotic arm when undergoing the inclined displacement can be at least one of: between 5 and 35 degrees, between 5 and 30 degrees, between 5 and 25 degrees, between 5 and 20 degrees, between 5 and 15 degrees, between 6 and 14 degrees, between 7 and 13 degrees, between 8 and 12 degrees, or between 9 and 11 degrees as measured from an axis normal to the ground surface.

17. The system of claim 8, wherein an inclined path of travel of the first robotic arm when undergoing the inclined displacement 5 and 15 degrees as measured from an axis normal to the ground surface.

18. The system of claim 8, wherein the actuator comprises a linear actuator.

19. The system of claim 8, wherein the actuator comprises a ball screw-type actuator.

20. The system of claim 11, wherein the upper-body robotic human augmentation system comprises a second robotic arm having at least one joint facilitating movement in at least one degree of freedom.

21. The system of claim 20, wherein the framework of the carrier support assembly further comprises:
a second structural support column, the second robotic arm being moveably supported by the second support column; and
a second actuator assembly having an actuator and a guide member,
wherein the second robotic arm undergoes inclined displacement in a sloped vertical degree of freedom within a given range of motion along the guide member of the second actuator assembly, and relative to the ground surface.

22. The system of claim 21, wherein an inclined path of the second robotic arm, when undergoing the inclined displacement, is configured to approximate an inclined path of travel of a shoulder of the operator when moving between a standing position and a squatting position while operating the walk-about system.

23. The system of claim 8, wherein the user input device comprises an operator end effector supported about the first robotic arm, the operator end effector being operable with at least one sensor to detect movements of the operator, wherein control of the first robotic arm is based on corresponding forces as detected by the at least one sensor.

24. The system of claim 20, wherein the first and second robotic arms are independent of one another, and are independently controlled by respective user input devices operable with the first and second robotic arms.

25. The system of claim 20, wherein the first and second robotic arms are each controlled in a coordinated manner with the user input device operable with at least one of the first or second robotic arms.

26. The system of claim 20, wherein the first and second robotic arms are coupled together via a mechanical arm link, such that the first and second robotic arms undergo synchronized inclined displacement.

27. The system of claim 8, wherein the framework of the carrier support assembly defines an operator pass-through channel that facilitates ingress of the operator into, and egress of the operator out of, a bi-pedal locomotion zone from multiple directions.

28. The system of claim 8, wherein the walk-about platform comprises a conveyance system that facilitates powered locomotion of the walk-about platform about the ground surface.

29. The system of claim 8, wherein the walk-about base comprises first and second lateral members.

30. The system of claim 8, wherein the walk-about platform further comprises a riding platform operable to support the operator above the ground surface within a bi-pedal locomotion zone, and to facilitate riding of the operator on the walk-about platform.

31. The system of claim 8, wherein an upper body and a lower body of the operator are decoupled from the walk-about system.

32. The system of claim 8, further comprising a gravity compensation system supported on the carrier support assembly, and operable to gravity compensate the first robotic arm.

33. The system of claim 32, wherein the gravity compensation system comprises:
a counterweight; and
a pulley system coupling the counterweight to a robotic arm interface coupling the first robotic arm to the carrier support assembly,
wherein the counterweight applies a counterforce to the first robotic arm in opposition to a gravitational force.

34. The system of claim 32, wherein the gravity compensation system comprises:
a gas spring; and
a pulley system coupling the gas spring to a robotic arm interface coupling the first robotic arm to the carrier support assembly,
wherein the gas spring applies a counterforce to the first robotic arm in opposition to a gravitational force.

35. The system of claim 8, wherein the carrier support assembly further comprises a robotic arm interface that moveably couples the first robotic arm to the carrier support assembly.

36. A walk-about robotic human augmentation system, comprising:
a first robotic arm comprising at least one joint facilitating movement of a jointed member in at least one degree of freedom;
a second robotic arm comprising at least one joint facilitating movement of a jointed member in at least one degree of freedom;
a walk-about platform operable about a ground surface, and comprising:
a walk-about base;
a mast in the form of a carrier support assembly supported by the walk-about base, and comprising:
a first support column in support of the first robotic arm;
a second support column in support of the second robotic arm;
a first actuator assembly operable with the first robotic arm;
a second actuator assembly operable with the second robotic arm; and
a control unit comprising one or more processors, and one or more memory devices comprising instructions that, when executed by the one or more processors, cause the system to:
control inclined displacement of the first robotic arm in a sloped vertical degree of freedom within a given range of motion relative to the ground surface; and
control inclined displacement of the second robotic arm in a sloped vertical degree of freedom within a given range of motion relative to the ground surface.

37. The system of claim 36, wherein the one or more memory devices further comprises instructions that, when executed by the one or more processors, cause the system to coordinate the movement of the first robotic arm with the movement of the second robotic arm via a common user interface device.

38. The system of claim 36, wherein the one or more memory devices further comprises instructions that, when executed by the one or more processors, cause the system to control operation of at least one of the first or second robotic arms.

39. The system of claim 26, wherein the one or more memory devices further comprises instructions that, when executed by the one or more processors, cause the system to operate the one or more robotic arms in a teleoperation mode.

40. The system of claim 26, wherein the one or more memory devices further comprises instructions that, when executed by the one or more processors, cause the system to operate the one or more robotic arms in an autonomous mode.

41. A method for facilitating operation of a walk-about robotic human augmentation system, comprising:
configuring an upper-body robotic human augmentation system to comprise a first robotic arm having at least one joint facilitating movement in at least one degree of freedom;
configuring a walk-about platform to be in support of the upper-body robotic human augmentation system; and
facilitating inclined displacement of the first robotic arm in a sloped vertical degree of freedom within a given range of motion along the guide member, and relative to the ground surface

42. The method of claim 41, further comprising configuring an inclined path of the first robotic arm, when undergoing the inclined displacement, to approximate an inclined path of travel of a shoulder of the operator when moving between a standing position and a squatting position while operating the walk-about system.

43. The method of claim 41, further comprising configuring the sloped vertical degree of freedom to comprise a single actuated degree of freedom, such that the inclined displacement of the first robotic arm in the sloped vertical degree of freedom results in movement of the first robotic arm in two spatial degrees of freedom.

44. The method of claim 41, configuring the walk-about platform to define an operator pass-through channel that facilitates ingress of the operator into, and egress of the operator out of, a bi-pedal locomotion zone from multiple directions.
